(19) United States
(12) Patent Application Publication
(10) Pub. No.: US 2025/0190297 A1
(43) Pub. Date: Jun. 12, 2025

(54) ANOMALY FACTOR ESTIMATING DEVICE, LEARNING DEVICE, PRECISE DIAGNOSTIC SYSTEM, AND ANOMALY FACTOR ESTIMATING METHOD

(71) Applicant: Mitsubishi Electric Corporation, Tokyo (JP)

(72) Inventor: Takeru MORIYAMA, Tokyo (JP)

(73) Assignee: Mitsubishi Electric Corporation, Tokyo (JP)

(21) Appl. No.: 19/057,521

(22) Filed: Feb. 19, 2025

Related U.S. Application Data
(63) Continuation of application No. PCT/JP2022/033628, filed on Sep. 8, 2022.

(51) Int. Cl. G06F 11/07

(52) U.S. Cl. CPC G06F 11/079; G06F 11/0709

(57) ABSTRACT

There are included a sensor data acquiring unit to acquire a plurality of pieces of time-series sensor data collected by a plurality of sensors provided in a plurality of facility components an anomaly detecting unit to detect a plurality of anomaly detection sensors in which an anomaly has occurred on the basis of a plurality of the pieces of sensor data, an anomaly detection order estimating unit to estimate an anomaly detection order in which occurrence of the anomaly is detected, an anomaly propagation path tracking unit to estimate an anomaly propagation order in which the anomaly has propagated on the basis of anomaly detection sensor information and an estimated structure indicating a dependence relationship between the facility components, and an anomaly factor estimating unit to estimate a factor of the anomaly on the basis of the anomaly detection order and the anomaly propagation order.

### CROSS REFERENCE TO RELATED APPLICATIONS

This application is a Continuation of PCT International Application No. PCT/JP2022/033628 filed on Sep. 8, 2022, all of which is hereby expressly incorporated by reference into the present application.

### TECHNICAL FIELD

The present disclosure relates to an anomaly factor estimating device, a learning device, a precise diagnostic system, and an anomaly factor estimating method.

### BACKGROUND ART

In a facility such as a plant or a factory, a plurality of elements (hereinafter referred to as “facility components”) constituting the facility such as a plurality of devices operate in conjunction with each other, and sensor data (variables) collected by sensors provided in the facility component and attached to the facility component also has some relevance. Therefore, when an anomaly occurs in a certain facility component among a plurality of facility components constituting the facility and the anomaly is detected, the influence of the anomaly propagates and an anomaly is detected in a plurality of pieces of sensor data. In such a case, it is not easy to specify (precisely diagnose) a facility component that is a generation source of an anomaly.

Thus, conventionally, there is known a technique by which, when a plurality of facility components in a facility is in an abnormal operation state, a facility component that has caused the abnormal operation state can be estimated using sensor data collected by sensors provided in the plurality of facility components in the facility.

For example, Patent Literature 1 discloses an anomaly diagnostic system that estimates a part that causes a change in the state of a facility on the basis of a state change based on a change in a relationship among a plurality of pieces of operation data regarding a target part detected by a plurality of detecting units set for each part (device) of the facility and inter-detecting unit relationship information in which a propagation relationship of an influence between parts of the facility corresponding to the detecting units is stored.

### CITATION LIST

### Patent Literatures

Patent Literature 1: WO 2017/159016 A1

### SUMMARY OF INVENTION

### Technical Problem

In a related art as disclosed in Patent Literature 1, it is necessary that an operator or the like grasps a propagation relationship of an influence among a plurality of facility components in advance, and is able to prepare information corresponding to inter-detecting unit relationship information in which the propagation relationship is defined on the basis of the grasped propagation relationship.

On the other hand, for example, in a complicated facility or a large-scale facility in which feedback control is performed, it is difficult for an operator or the like to grasp a propagation relationship of an influence between devices constituting the facility.

Therefore, in the related art, there is a problem that a propagation relationship of an influence among a plurality of facility components cannot be grasped, or even if the propagation relationship can be grasped, it is possible that estimation of a factor of the anomaly that has occurred in the facility is not possible due to low accuracy.

The present disclosure has been made to solve the above problems, and an object thereof is to provide an anomaly factor estimating device capable of estimating a factor of an anomaly that has occurred in a facility regardless of complexity of the facility or scale of the facility.

### Solution to Problem

An anomaly factor estimating device according to the present disclosure includes a processor; and a memory storing a program, upon executed by the processor, to perform a process: to acquire a plurality of pieces of time-series sensor data collected by a plurality of sensors provided in a plurality of facility components constituting a target facility; to detect a plurality of anomaly detection sensors in which an anomaly has occurred among the plurality of the sensors on a basis of a plurality of the pieces of sensor data acquired; to estimate an anomaly detection order in which occurrence of the anomaly is detected for the plurality of the anomaly detection sensors on a basis of a detection time at which the process has detected the plurality of the anomaly detection sensors; to estimate an anomaly propagation order in which the anomaly has propagated on a basis of anomaly detection sensor information regarding the plurality of the anomaly detection sensors detected and an estimated structure indicating a dependence relationship between the facility components; and to estimate a factor of the anomaly on a basis of the anomaly detection order estimated and the anomaly propagation order estimated.

### Advantageous Effects of Invention

According to the present disclosure, with the above configuration, the anomaly factor estimating device can estimate the factor of the anomaly that has occurred in the facility regardless of the complexity of the facility or the scale of the facility.

### BRIEF DESCRIPTION OF DRAWINGS

FIG. 1 is a diagram illustrating a configuration example of a precise diagnostic system including an anomaly factor estimating device according to a first embodiment.

FIG. 2 is a diagram illustrating a configuration example of the anomaly factor estimating device according to the first embodiment.

FIG. 3 is a diagram for describing a configuration of sensor data in the first embodiment.

FIG. 4 is a diagram for describing a specific example of anomaly propagation order estimation processing performed by an anomaly propagation path tracking unit in the first embodiment.

FIG. 5 is another diagram for describing a specific example of anomaly propagation order estimation processing performed by the anomaly propagation path tracking unit in the first embodiment.

FIG. 6 is another diagram for describing a specific example of anomaly propagation order estimation processing performed by the anomaly propagation path tracking unit in the first embodiment.

FIG. 7 is a diagram for describing a specific example of anomaly factor estimation processing performed by an anomaly factor estimating unit in the first embodiment.

FIG. 8 is a diagram for describing a screen example of an anomaly factor estimation result screen displayed on a display device by an anomaly factor estimation result output unit in the first embodiment.

FIG. 9 is a diagram for describing another screen example of the anomaly factor estimation result screen displayed on the display device by the anomaly factor estimation result output unit in the first embodiment.

FIG. 10A is a diagram illustrating an example of content of an anomaly detection order estimation result, FIG. 10B is a diagram illustrating an example of content of an anomaly propagation order estimation result, and FIG. 10C is a diagram illustrating an example of content of an anomaly factor order estimation result.

FIG. 11 is a diagram illustrating a configuration example of a learning device according to the first embodiment.

FIG. 12 is a diagram illustrating a concept of an example of learning processing in which a related structure learning unit learns a related structure in the first embodiment.

FIG. 13 is a flowchart for describing an operation of the anomaly factor estimating device according to the first embodiment.

FIG. 14 is a flowchart for describing an operation of the learning device according to the first embodiment.

FIG. 15 is a flowchart for describing details of processing in step ST23 in FIG. 14.

FIGS. 16A and 16B are diagrams illustrating an example of a hardware configuration of the anomaly factor estimating device 100 according to the first embodiment.

FIG. 17 is a diagram illustrating a configuration example of a precise diagnostic system in which the anomaly factor estimating device and the learning device include a sensor data acquiring unit and a data storage unit that are common in the first embodiment.

FIG. 18 is a diagram illustrating a configuration example of the precise diagnostic system in which, in the first embodiment, the learning device learns the related structure for each operation state of a target facility, and the anomaly factor estimating device estimates an anomaly factor on the basis of the related structure corresponding to an operation state of the target facility learned by the learning device.

FIG. 19 is a diagram illustrating a configuration example of the anomaly factor estimating device including a related structure correcting unit in the first embodiment.

FIG. 20 is a diagram for describing a concept of an example of processing in which a related structure correcting unit corrects the related structure in the anomaly factor estimating device including the related structure correcting unit in the first embodiment.

FIG. 21 is a diagram illustrating a configuration example of the anomaly factor estimating device including a relationship change estimating unit in the first embodiment.

FIG. 22 is a diagram for describing a concept of an example of a relationship change order estimation processing performed by the relationship change estimating unit on the basis of a learned related structure and a related structure at the time of an anomaly in a case where the anomaly factor estimating device according to the first embodiment includes the relationship change estimating unit.

FIG. 23 is a diagram illustrating a configuration example of the anomaly factor estimating device including an anomaly factor device estimating unit and having a configuration for estimating an anomaly factor in units of the device in the first embodiment.

FIG. 24 is a diagram for describing a concept of an example of device unit anomaly factor estimation processing of estimating a factor of an anomaly in units of the device, the processing being performed by the anomaly factor device estimating unit on the basis of device-attached sensor information, the anomaly detection order estimation result, and the anomaly propagation order estimation result in a case where the anomaly factor estimating device according to the first embodiment includes the anomaly factor device estimating unit.

FIG. 25 is a diagram illustrating a screen example of an anomaly factor device estimation result screen displayed on a display device by an anomaly factor estimation result output unit in the first embodiment.

FIG. 26 is a diagram illustrating a configuration example of an anomaly factor estimating device including a related structure graph output unit and configured to output related structure graph display information to a display device in the first embodiment.

FIG. 27 is a diagram for describing an example of a graph screen displayed on the display device by the related structure graph output unit outputting related structure graph display information in a case where the anomaly factor estimating device includes the related structure graph output unit in the first embodiment.

FIG. 28 is a diagram illustrating an example of content of the related structure.

FIG. 29 is a diagram illustrating an example of content of anomaly detection sensor information.

FIG. 30 is a diagram illustrating an example of content of an anomaly factor order estimation result.

FIG. 31 is a flowchart for describing an example of an operation of the anomaly factor estimating device in a case where the anomaly factor estimating device includes a related structure graph output unit in the first embodiment.

FIG. 32 is a diagram illustrating a configuration example of the learning device including a learning sensor pair generating unit in the first embodiment.

FIG. 33 is a diagram for describing a concept of an example of a method in which the learning sensor pair generating unit generates sensor pair information on the basis of facility design information in a case where the learning device includes the learning sensor pair generating unit in the first embodiment.

### DESCRIPTION OF EMBODIMENTS

Hereinafter, in order to describe the present disclosure in more detail, an embodiment for carrying out the present disclosure will be described with reference to the accompanying drawings.

### First Embodiment

The anomaly factor estimating device according to a first embodiment is used for all facilities in which some kind of anomaly appears in sensor data collected in the facilities, such as a power plant or a factory automation (FA) system. Further, the sensor data is collected by sensors provided in a plurality of elements (hereinafter referred to as “facility components”) constituting the facility. In the first embodiment, the facility components are assumed to be, for example, devices. One device is provided with one or more sensors 300. In the following first embodiment, for convenience, as an example, it is assumed that one sensor is provided in one device.

For example, the anomaly factor estimating device monitors sensor data collected in a facility (hereinafter referred to as a “target facility”) that is a monitoring target, that is, a target for detecting occurrence of an anomaly, and detects a plurality of sensors (hereinafter referred to as an “anomaly detection sensor”) in which occurrence of the anomaly has been detected on the basis of the sensor data. In addition, as described above, in the facility, facility components constituting the facility, here, devices, operate in conjunction with each other, and sensor data collected by sensors provided in the devices and attached to the devices also has some relevance. When an anomaly occurs in a certain facility component among the plurality of facility components and the anomaly is detected, the influence of the anomaly propagates and an anomaly is detected in a plurality of pieces of sensor data, in other words, a plurality of sensors.

Then, when detecting a plurality of anomaly detection sensors, the anomaly factor estimating device estimates a factor of the anomaly on the basis of sensor data collected by the plurality of anomaly detection sensors, and presents information regarding an estimation result to an operator such as a site maintenance worker of the target facility. For example, the anomaly factor estimating device presents information regarding the estimation result of the factor of the anomaly to the operator by causing a display device to display the information. The anomaly factor estimating device presents the information regarding the estimation result of the factor of the anomaly to the operator in a form in which, for example, a sensor provided in a device that has caused the anomaly or an order in which the operator should perform inspection can be grasped. Thus, the anomaly factor estimating device can reduce unnecessary inspection work by the operator and reduce the load on the operator. In addition, the anomaly factor estimating device can estimate the factor of the anomaly with a quantitative index that does not depend on human subjectivity, and present grounds of estimation.

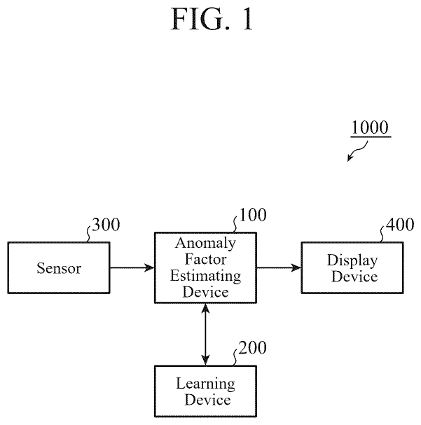

FIG. 1 is a diagram illustrating a configuration example of a precise diagnostic system 1000 including an anomaly factor estimating device 100 according to the first embodiment.

The precise diagnostic system 1000 includes an anomaly factor estimating device 100, a learning device 200, a sensor 300, and a display device 400. Note that, in the first embodiment, the sensor 300 and the display device 400 are provided in the precise diagnostic system 1000, but this is merely an example. The precise diagnostic system 1000 does not necessarily include the sensor 300 and the display device 400, and the sensor 300 and the display device 400 may be included in a system connected to the precise diagnostic system 1000 outside the precise diagnostic system 1000.

In addition, in FIG. 1, only one sensor 300 is illustrated for simplicity of description, but there may be a plurality of sensors 300. The anomaly factor estimating device 100 is connected to the plurality of sensors 300. Furthermore, there may be a plurality of display devices 400.

The anomaly factor estimating device 100 is connected to the learning device 200, the sensor 300, and the display device 400.

The anomaly factor estimating device 100 estimates a factor of an anomaly that has occurred in the target facility (not illustrated).

Specifically, the anomaly factor estimating device 100 detects the sensor 300 in which an anomaly has occurred (hereinafter referred to as an “anomaly detection sensor”) on the basis of sensor data acquired from the sensor 300 and a learned related structure generated by the learning device 200, and tracks a propagation path of the anomaly between anomaly detection sensors, thereby estimating the factor of the anomaly that has occurred in the target facility.

In the first embodiment, the anomaly factor estimating device 100 “estimates a factor of an anomaly” means that an anomaly factor score indicating the degree of likelihood of the generation source of the anomaly and an anomaly factor order based on the anomaly factor score are estimated in units of sensors 300, and information regarding the anomaly factor score and the anomaly factor order is generated.

Then, the anomaly factor estimating device 100 causes the display device 400 to display information regarding the estimated factor of the anomaly.

Details of the anomaly factor estimating device 100 and the related structure will be described later.

The learning device 200 estimates the related structure using sensor data collected by the sensor 300 provided in the target facility during a time of normal operation of the target facility. In the first embodiment, the estimation of the related structure performed by the learning device 200 is also referred to as “learning”. That is, a “learned related structure” used when the anomaly factor estimating device 100 estimates the factor of the anomaly that has occurred in the target facility can be said to be an “estimated structure” that is a related structure estimated by the learning device 200 in other words. The related structure is information indicating a dependence relationship of a plurality of facility components constituting the target facility. The related structure indicates the dependence relationship of the facility components by indicating a dependence relationship of the sensors provided in the facility components. The related structure is, for example, information in which the dependence relationship of the plurality of facility components constituting the target facility is indicated by a matrix. The related structure may be, for example, information in which the dependence relationship of the plurality of facility components constituting the target facility is indicated in a JavaScript (registered trademark) Object Notification (JSON) format which is a dictionary type description method. In the first embodiment, as an example, the related structure constituting the target facility is information in which dependence relationships of a plurality of facility components are indicated by a matrix.

Further, the time of normal operation of the target facility is specifically a time or normal operation of the plurality of facility components constituting the target facility, here, devices. Thus, the sensor data collected by the sensor 300 during the time of normal operation of the target facility is specifically sensor data collected by the sensor 300 provided in each device during a time of normal operation of a plurality of devices constituting the target facility.

Details of the learning device 200 will be described later.

The sensor 300 is provided in the plurality of facility components constituting the target facility, here, devices.

The sensor 300 outputs the sensor data to the anomaly factor estimating device 100.

The sensor data is, for example, time-series data of sensor measurement values for a predetermined time obtained at predetermined intervals by the sensor 300 provided in each device that is a facility component constituting the target facility. The sensor data indicates, for example, a sensor measurement value of at least one of an opening degree, a deviation, a rotational speed, a conductivity, a flow rate, a pressure, a temperature, a concentration, or a water level. In addition, this is merely an example, and the sensor data may include a control value such as a command value or a reference value for a predetermined time obtained at predetermined intervals by the plurality of sensors 300.

In the following first embodiment, it is assumed that the sensor data is time-series data of at least one of sensor measurement values such as an opening degree, a deviation, a rotational speed, a conductivity, a flow rate, a pressure, a temperature, a concentration, and a water level for a predetermined time obtained at predetermined intervals by the plurality of sensors 300.

The display device 400 is, for example, a display included in a personal computer (PC) installed in a management room or the like where the operator performs work. The display device 400 may be, for example, a touch panel display of a tablet terminal carried by the operator.

First, an anomaly factor estimating device 100 according to the first embodiment will be described.

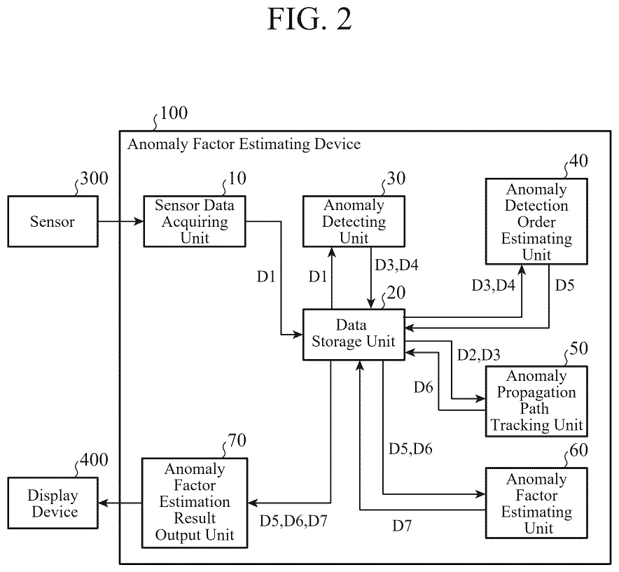

FIG. 2 is a diagram illustrating a configuration example of the anomaly factor estimating device 100 according to the first embodiment.

Note that, in FIG. 2, the learning device 200 is not illustrated.

Similarly to FIG. 1, only one sensor 300 is illustrated in FIG. 2 for simplicity of description, but this is merely an example. A plurality of sensors 300 can be connected to the anomaly factor estimating device 100. In the first embodiment, it is assumed that a plurality of sensors 300 is connected to the anomaly factor estimating device 100. In the following first embodiment, the plurality of sensors 300 is also simply referred to as the sensor 300.

The anomaly factor estimating device 100 includes a sensor data acquiring unit 10, a data storage unit 20, an anomaly detecting unit 30, an anomaly detection order estimating unit 40, an anomaly propagation path tracking unit 50, an anomaly factor estimating unit 60, and an anomaly factor estimation result output unit 70.

The sensor data acquiring unit 10 acquires sensor data from the sensor 300.

As described above, in the first embodiment, the sensor data is time-series data of sensor measurement values (for example, sensor measurement values of at least one of an opening degree, a deviation, a rotational speed, a conductivity, a flow rate, a pressure, a temperature, a concentration, or a water level) for a predetermined time obtained at predetermined intervals from the sensors 300 provided in the plurality of devices as facility components.

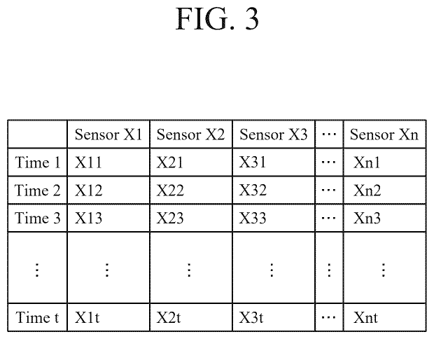

For example, when the quantity of sensors 300 is represented by n, the sensors 300 are represented by X1, X2, X3, X4, . . . , Xn. Further, assuming that sensor data is collected at each of time 1, time 2, . . . , time t, the sensor data is represented by a two-dimensional data frame in which a row is the number t of times and a column is the quantity n of sensors. The sensor data at time 1 of the first sensor X1 is represented by X11, the sensor data at time 1 of the second sensor X2 is represented by X21, and the sensor data at time 2 of the first sensor X1 is represented by X12 (see FIG. 3). Note that, in the following first embodiment, the sensor data acquired by the sensor data acquiring unit 10 is referred to as “sensor data D1”.

The sensor data acquiring unit 10 causes the acquired sensor data D1 to be stored in the data storage unit 20.

The anomaly detecting unit 30 performs anomaly detection processing on the sensor data D1 caused to be stored in the data storage unit 20 by the sensor data acquiring unit 10.

Specifically, the anomaly detecting unit 30 performs the anomaly detection processing using a known univariate type anomaly detecting method on the sensor data D1 that is time-series data caused to be stored in the data storage unit 20 by the sensor data acquiring unit 10, and detects a plurality of anomaly detection sensors among the sensors 300. In the first embodiment, occurrence of an anomaly in the sensor 300 means that a value of sensor data collected by the sensor 300 is abnormal. That is, the anomaly detection sensor is the sensor 300 in which a value of sensor data collected by the sensor 300 is abnormal. Note that, in the first embodiment, the occurrence of an anomaly in the sensor 300 means that an anomaly has occurred in a device in which the sensor 300 is provided.

Examples of known univariate type anomaly detecting methods include Discord (Non Patent Literature: KEOGH, Eamonn; LIN, Jessica; FU, Ada. Hot sax: Efficiently finding the most unusual time series subsequence. In: Data mining, fifth IEEE international conference on. IEEE, 2005) and the Hotelling's T\hat{ }2 theory.

In addition, in the following first embodiment, the plurality of anomaly detection sensors detected by the anomaly detecting unit 30 are also simply referred to as “anomaly detection sensors”.

The anomaly detecting unit 30 causes information regarding the anomaly detection sensor (hereinafter referred to as “anomaly detection sensor information”) and information regarding the detection time at which the anomaly detection sensor has been detected (hereinafter referred to as “anomaly detection time information”) to be stored in the data storage unit 20.

In the following first embodiment, the anomaly detection sensor information is referred to as “anomaly detection sensor information D3”, and the anomaly detection time information is referred to as “anomaly detection time information D4”. The anomaly detection sensor information D3 is information indicating the anomaly detection sensor. The information indicating the anomaly detection sensor is, for example, information that can specify the anomaly detection sensor, such as an ID assigned to each sensor 300. The anomaly detection time information D4 is information in which information that can specify the anomaly detection sensor is associated with the time when the anomaly detection sensor is detected.

In addition, the anomaly detecting unit 30 may combine the anomaly detection sensor information D3 and the anomaly detection time information D4 into information (hereinafter referred to as an “anomaly detection result”) in which the information indicating the anomaly detection sensor is associated with the time when the anomaly detection sensor is detected. In this case, the anomaly detecting unit 30 causes the anomaly detection result to be stored in the data storage unit 20.

Here, it is assumed that the anomaly detecting unit 30 acquires the sensor data D1 from the sensor data acquiring unit 10 via the data storage unit 20, but this is merely an example. The anomaly detecting unit 30 may directly acquire the sensor data D1 from the sensor data acquiring unit 10.

The anomaly detection order estimating unit 40 acquires the anomaly detection sensor information D3 and the anomaly detection time information D4 caused to be stored in the data storage unit 20 by the anomaly detecting unit 30, and performs anomaly detection order estimation processing of estimating an order in which occurrence of an anomaly has been detected in the anomaly detection sensor, more specifically, an order in which occurrence of an anomaly has been detected in the sensor data D1 collected by the anomaly detection sensor (hereinafter referred to as “anomaly detection order”).

Specifically, on the basis of the anomaly detection sensor information D3 and the anomaly detection time information D4, the anomaly detection order estimating unit 40 assigns the anomaly detection order to the anomaly detection sensors in the order of the earliest anomaly detection time.

Specifically, the anomaly detection order estimating unit 40 assigns an anomaly detection order on to the sensor Xn detected as an anomaly detection sensor. Here, the anomaly detection order on is a real number. For example, the anomaly detection order estimating unit 40 assigns the anomaly detection order on in such a manner that the assigned anomaly detection order on is in ascending order from the sensor Xn associated with the earliest anomaly detection time. For example, when there is a plurality of sensors Xn associated with the same anomaly detection time, the anomaly detection order estimating unit 40 assigns the same anomaly detection order on to the plurality of sensors Xn associated with the same anomaly detection time. For example, the anomaly detection order estimating unit 40 may assign the anomaly detection order “0” to the sensor Xn associated with the earliest anomaly detection time, and thereafter assign the elapsed time from the time corresponding to the anomaly detection order “0” to the other sensors Xn as the anomaly detection order on.

The anomaly detection order estimating unit 40 causes a result of assignment of the anomaly detection order (hereinafter referred to as an “anomaly detection order estimation result”) to be stored in the data storage unit 20. In the following first embodiment, the anomaly detection order estimation result is referred to as an “anomaly detection order estimation result D5”. The anomaly detection order estimation result D5 is information in which the information indicating the anomaly detection sensor, the anomaly detection time, and information indicating the anomaly detection order are associated with each other.

Note that, here, it is assumed that the anomaly detection order estimating unit 40 acquires the anomaly detection sensor information D3 and the anomaly detection time information D4 from the anomaly detecting unit 30 via the data storage unit 20, but this is merely an example. The anomaly detection order estimating unit 40 may directly acquire the anomaly detection sensor information D3 and the anomaly detection time information D4 from the anomaly detecting unit 30.

The anomaly propagation path tracking unit 50 acquires the anomaly detection sensor information D3 caused to be stored by the anomaly detecting unit 30 and the related structure from the data storage unit 20, and performs anomaly propagation order estimation processing of estimating the order of propagation of the anomaly (hereinafter referred to as “anomaly propagation order”) on the basis of the acquired anomaly detection sensor information D3 and related structure. In the anomaly propagation order estimation processing, the anomaly propagation path tracking unit 50 estimates the anomaly propagation order with respect to the sensor 300. Note that, for a certain sensor 300, the anomaly detection order assigned by the anomaly detection order estimating unit 40 and the anomaly propagation order estimated by the anomaly propagation path tracking unit 50 are not necessarily the same order. For example, due to a problem of time resolution, even when the same order is assigned to the anomaly detection order, the order relation of the anomaly propagation order may be back and forth. In addition, for example, due to a problem of accuracy of the anomaly detection time, an order opposite to the anomaly propagation order may be assigned to the anomaly detection order. Furthermore, for example, due to a problem of accuracy of the anomaly detection time, even in a case where the same order is assigned to the anomaly detection order, the order relation of the anomaly propagation order may be reversed. Even if it is relatively easy to detect the presence or absence of the occurrence of an anomaly, it is difficult to accurately detect the occurrence time, so that a problem of accuracy of the anomaly detection time may occur.

The related structure is generated on the basis of at least one statistic among the plurality of pieces of sensor data by learning in the learning device 200 and stored in the data storage unit 20. In the following first embodiment, the related structure is referred to as a “related structure D2”. As described above, in the first embodiment, the related structure D2 is information in which the dependence relationship among the plurality of devices which is a plurality of facility components constituting the target facility is indicated by a matrix.

Specifically, the anomaly propagation path tracking unit 50 determines the dependence relationship between the anomaly detection sensors on the basis of the anomaly detection sensor information D3 and the related structure D2, and tracks the propagation path of the anomaly by tracing the direction of the dependence relationship. Then, the anomaly propagation path tracking unit 50 sequentially assigns the anomaly propagation order such as “1”(st), “2”(nd), “3”(rd), . . . from the anomaly detection sensor located upstream of the anomaly propagation conceivable to be the generation source of the anomaly to the anomaly detection sensor located downstream. The anomaly propagation path tracking unit 50 generates an estimation result of the anomaly propagation order (hereinafter referred to as an “anomaly propagation order estimation result”) and causes the estimation result to be stored in the data storage unit 20. In the following first embodiment, the anomaly propagation order estimation result is referred to as an “anomaly propagation order estimation result D6”.

Here, the anomaly propagation order estimation processing performed by the anomaly propagation path tracking unit 50 will be described with a specific example using the drawings.

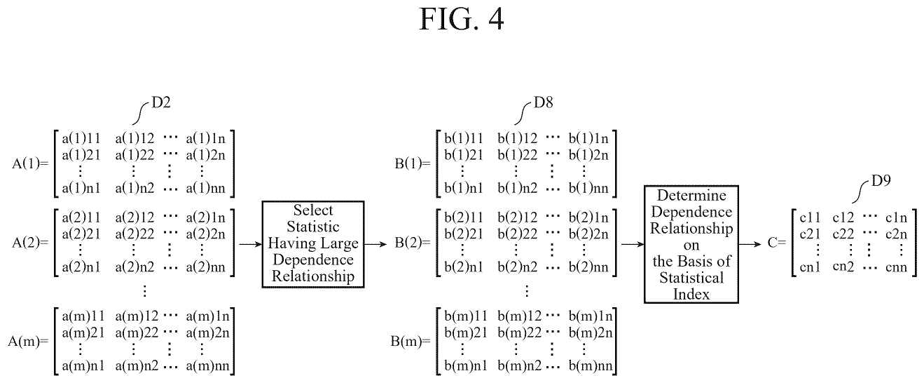

FIGS. 4, 5, and 6 are diagrams for describing a specific example of the anomaly propagation order estimation processing performed by the anomaly propagation path tracking unit 50 in the first embodiment.

### <Generation of Influence Propagation Relationship Matrix>

In the anomaly propagation order estimation processing, the anomaly propagation path tracking unit 50 first converts the related structure D2 into an influence propagation relationship matrix indicating presence or absence of a dependence relationship among pieces of sensor data by a matrix on the basis of the related structure D2 stored in the data storage unit 20. In the first embodiment, the influence propagation relationship matrix is referred to as an “influence propagation relationship matrix D9”.

FIG. 4 is a diagram for describing a concept of an example of processing in which the anomaly propagation path tracking unit 50 converts the related structure D2 into the influence propagation relationship matrix D9 in the first embodiment.

Here, it is assumed that the related structure D2 is a three-dimensional array in which the first dimension is the type m of the statistical index, the second dimension is the quantity n of sensors, and the third dimension is the quantity n of sensors. Further, the statistical index is an index that describes a dependence relationship among the pieces of sensor data. Details of the statistical index will be described later.

A two-dimensional matrix corresponding to the k-th statistical index is denoted by A(k), and a statistic describing a dependence relationship from the i-th sensor data to the j-th sensor data in the k-th statistical index is denoted by a(k)ij. Note that the i-th sensor data is sensor data collected by the i-th sensor Xi, and the j-th sensor data is sensor data collected by the j-th sensor Xj.

The anomaly propagation path tracking unit 50 performs preprocessing of selecting statistics (hereinafter referred to as a “tracking statistic”) to be used for tracking an anomaly propagation path for the related structure D2 as described above, and generates a related structure after the preprocessing. In the following first embodiment, the related structure after the preprocessing is referred to as a “preprocessing related structure D8 after preprocessing”. The preprocessing related structure D8 after preprocessing has the same data structure as the related structure D2.

For example, the anomaly propagation path tracking unit 50 only needs to select only a statistic having a large dependence relationship as a tracking statistic. In this case, the anomaly propagation path tracking unit 50 provides a threshold (hereinafter referred to as a “statistic selection threshold”) for each type of statistical index, and selects the statistic a(k)ij having an absolute value |a(k)ij| of a statistic larger than the statistic selection threshold as a tracking statistic. For example, when the absolute value of the statistic is larger than the statistic selection threshold, the anomaly propagation path tracking unit 50 substitutes the statistic a(k)ij, which is an element of the related structure D2, into an element b(k)ij of the preprocessing related structure D8 after preprocessing, and when the absolute value of the statistic is less than the statistic selection threshold, the anomaly propagation path tracking unit 50 substitutes “0”, which indicates that there is no dependence relationship, into the element b(k)ij of the preprocessing related structure D8 after preprocessing. In addition, the statistic selection threshold may be manually set in advance by the operator or the like operating an input device (not illustrated) such as a mouse or a keyboard, or may be automatically determined by the anomaly propagation path tracking unit 50 on the basis of sensor data. For example, the anomaly propagation path tracking unit 50 can determine a relative statistic selection threshold from the mean (median, quantile, or the like) of the statistics.

The anomaly propagation path tracking unit 50 performs conversion processing of converting the preprocessing related structure D8 after preprocessing into the influence propagation relationship matrix D9 to generate the influence propagation relationship matrix D9.

The anomaly propagation path tracking unit 50 determines the dependence relationship among the pieces of sensor data on the basis of one or more types of statistical indexes including at least one directed statistical index, for example, and converts the preprocessing related structure D8 after preprocessing into the influence propagation relationship matrix D9. In this case, as a method of determining the dependence relationship among the pieces of sensor data, for example, the anomaly propagation path tracking unit 50 may determine that the dependence relationship is present among the pieces of sensor data when at least one type of statistic among the statistics b(1)ij, b(2)ij, . . . , b(m)ij is non-“0”, or may determine that the dependence relationship is present among the pieces of sensor data when all the statistics b(1)ij, b(2)ij, . . . , b(m)ij are non-“O”. Specifically, for example, assuming that i=1 and j=2, it may be determined that the dependence relationship is present between the sensor data collected by the sensor X1 and the sensor data collected by the sensor X2 when at least one type of statistic among the statistics b(1)12, b(2)12, . . . , b(m)12 is not “0”, or it may be determined that the dependence relationship is present between the sensor data collected by the sensor X1 and the sensor data collected by the sensor X2 when all the statistics b(1)12, b(2)12, . . . , b(m)12 are not “0”.

The statistical index for the anomaly propagation path tracking unit 50 to determine the dependence relationship among the pieces of sensor data may be manually selected by the operator or the like from m types of statistical indexes, for example. As a specific example, for example, the anomaly propagation path tracking unit 50 causes the display device 400 to display a setting screen of the type of the statistical index on which a check box or the like for each type of the statistical index is displayed. The operator or the like operates the input device such as a mouse or a keyboard to select a statistical index from the setting screen. The anomaly propagation path tracking unit 50 receives the statistical index selected by the operator or the like as the statistical index for determining the dependence relationship among the pieces of sensor data.

In the first embodiment, as an example, as illustrated in FIG. 4, the influence propagation relationship matrix D9 is a two-dimensional matrix in which the first dimension is the quantity n of sensors 300 and the second dimension is the quantity n of sensors 300.

Here, elements of the related structure D2 and the preprocessing related structure D8 after preprocessing are real numbers, and elements of the influence propagation relationship matrix D9 are Boolean values. For example, in the related structure D2 and the preprocessing related structure D8 after preprocessing, the larger the absolute values |a(k)ij| and |b(k)ij| of the elements are, the larger the dependence relationship is, and when the element cij is “1” in the influence propagation relationship matrix D9, the existence of the dependence relationship is indicated.

For example, the anomaly propagation path tracking unit 50 substitutes “1” to cij, which is an element of the influence propagation relationship matrix D9, when there is a dependence relationship from the i-th sensor data to the j-th sensor data, and substitutes “0” to cij, which is an element of the influence propagation relationship matrix D9, when there is no dependence relationship from the i-th sensor data to the j-th sensor data.

### <Estimation of Anomaly Propagation Order>

In the anomaly propagation order estimation processing, when the influence propagation relationship matrix D9 is generated, the anomaly propagation path tracking unit 50 estimates the anomaly propagation order on the basis of the anomaly detection sensor information D3 acquired from the data storage unit 20 and the generated influence propagation relationship matrix D9.

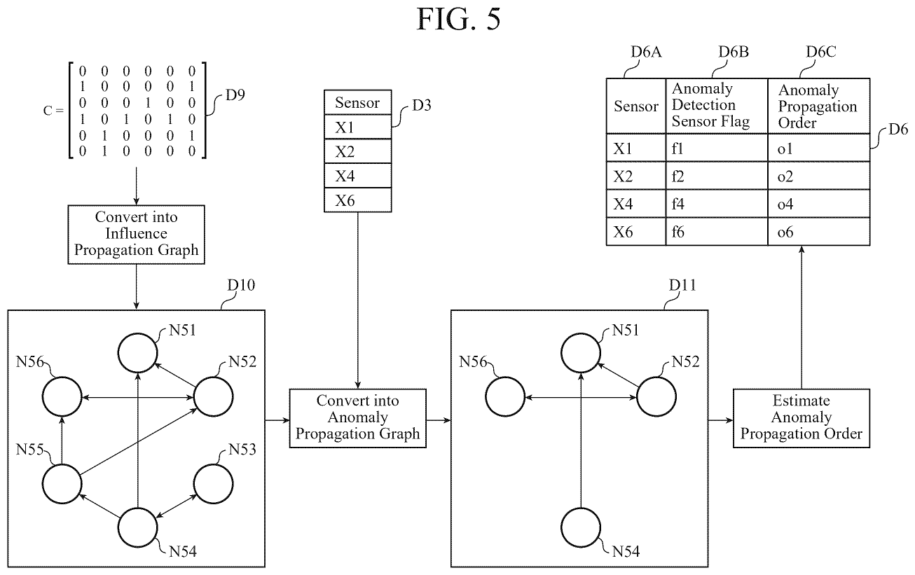

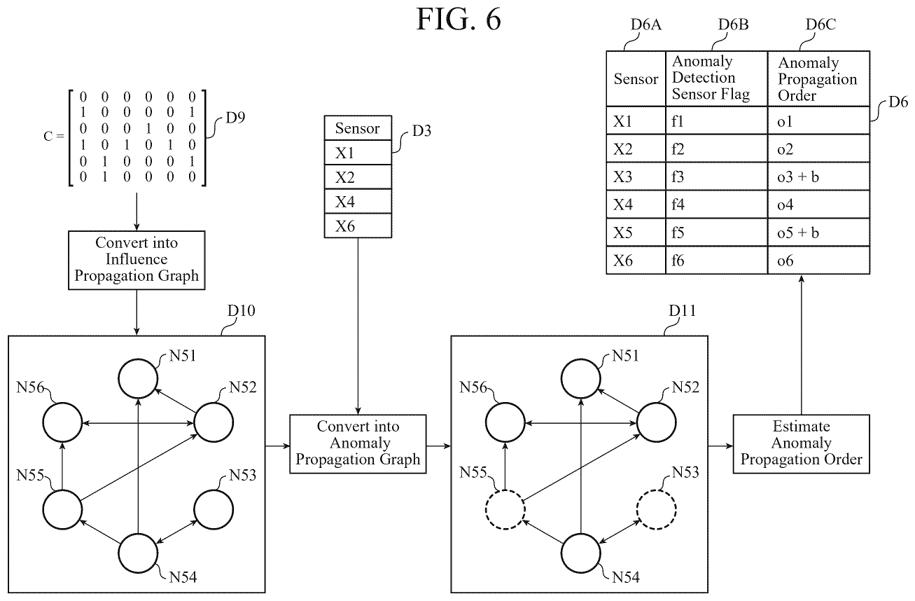

FIGS. 5 and 6 are diagrams for describing a concept of an example of processing in which the anomaly propagation path tracking unit 50 estimates the anomaly propagation order on the basis of the anomaly detection sensor information D3 and the influence propagation relationship matrix D9 in the first embodiment.

Here, as an example, the quantity of sensors 300 is set to six, and the sensor 300 is represented by a sensor Xn (n=1, . . . , 6). Further, as an example, it is assumed that the sensors X1, X2, X4, and X6 among the sensors X1, X2, X3, X4, X5, and X6 are anomaly detection sensors. Furthermore, as an example, the influence propagation relationship matrix D9 is a two-dimensional matrix of 6 rows×6 rows representing the dependence relationship among the pieces of sensor data related to the sensor Xn.

First, the anomaly propagation path tracking unit 50 converts the influence propagation relationship matrix D9 into an influence propagation graph D10. As illustrated in FIG. 5, the influence propagation graph D10 is a directed graph in which the sensors X1, X2, X3, X4, X5, and X6 are represented as nodes, and dependence relationships among the pieces of sensor data related to the sensors X1, X2, X3, X4, X5, and X6 are represented as edges. The sensors X1, X2, X3, X4, X5, and X6 correspond to nodes N51, N52, N53, N54, N55, and N56, respectively. For example, when there is a dependence relationship in one direction from the sensor X2 to the sensor X1, the dependence relationship is expressed by an edge of a one side arrow from the node N52 to the node N51 in the influence propagation graph D10.

After converting the influence propagation relationship matrix D9 into the influence propagation graph D10, the anomaly propagation path tracking unit 50 then converts the influence propagation graph D10 into an anomaly propagation graph D11 on the basis of the anomaly detection sensor information D3.

For example, as illustrated in FIG. 5, the anomaly propagation path tracking unit 50 selects only the dependence relationship related to the anomaly detection sensor Xn from the dependence relationship represented by the influence propagation graph D10, and converts the selected dependence relationship into the anomaly propagation graph D11. In this case, the anomaly propagation path tracking unit 50 selects only the nodes corresponding to the anomaly detection sensors X1, X2, X4, and X6 and edges among the nodes corresponding to the anomaly detection sensors X1, X2, X4, and X6 from the nodes corresponding to the sensors X1, X2, X3, X4, X5, and X6 represented by the influence propagation graph D10 and edges among the nodes corresponding to the sensors X1, X2, X3, X4, X5, and X6. For example, in the example illustrated in FIG. 5, the sensor X3 is not included in the anomaly detection sensors X1, X2, X4, and X6. Therefore, the anomaly propagation path tracking unit 50 does not select the node N53 corresponding to the sensor X3. As a result, in the anomaly propagation graph D11, the node N53 corresponding to the sensor X3 is deleted, and the edge between the node N53 and the node N54 associated with the node N53 is also deleted.

Then, the anomaly propagation path tracking unit 50 estimates the anomaly propagation order on the basis of the anomaly propagation graph D11.

For example, the anomaly propagation path tracking unit 50 assigns the anomaly propagation order on to the anomaly detection sensor Xn. Here, the anomaly propagation order on is a real number. For example, the anomaly propagation path tracking unit 50 assigns the anomaly propagation order on in such a manner that the anomaly propagation order on is in ascending order from the anomaly detection sensor Xn located upstream of the anomaly propagation conceivable to be the generation source of the anomaly.

In the example illustrated in FIG. 5, the anomaly propagation path tracking unit 50 first sets a node to which a one side arrow is not drawn from another node as a node located most upstream of anomaly propagation, and assigns the smallest anomaly propagation order on to the anomaly detection sensor Xn corresponding to the node. In FIG. 5, the nodes N52, N54, and N56 are nodes not drawn with a one side arrow from the other nodes. Thus, the anomaly propagation path tracking unit 50 assigns anomaly propagation orders o2, o4, and o6 to the anomaly detection sensors X2, X4, and X6 corresponding to the nodes N52, N54, and N56, respectively. At this time, o2=o4=o6. For example, the anomaly propagation path tracking unit 50 sets o2=o4=o6=1. That is, the anomaly propagation path tracking unit 50 sets the anomaly propagation order of the anomaly detection sensors X2, X4, and X6 to “1”(st).

Next, the anomaly propagation path tracking unit 50 assigns the anomaly propagation order on larger than the assigned anomaly propagation order on to the anomaly detection sensor Xn corresponding to the node at the end point of the one side arrow exiting from the node to which the smallest anomaly propagation order (here, “1”) is assigned. Further, the anomaly propagation path tracking unit 50 assigns the anomaly propagation order on to the anomaly detection sensor Xn corresponding to the node at the end point of a both side arrow exiting from the node to which the smallest anomaly propagation order on (here, “1”) is assigned. In FIG. 5, the node N51 is a node at the end point of the one side arrow exiting from the node N52. Thus, the anomaly propagation path tracking unit 50 assigns the anomaly propagation order o1, that is, the anomaly propagation order o1 larger than “1”(st) to the anomaly detection sensor X1 corresponding to the node N51. For example, the anomaly propagation path tracking unit 50 sets the anomaly propagation order o1=2. That is, the anomaly propagation path tracking unit 50 sets the anomaly propagation order of the anomaly detection sensor X1 to “2”(nd). Further, in FIG. 5, the node N56 is at the end point of the double-headed arrow exiting from the node N52, but the anomaly propagation order o6=1 has already been assigned to the node N56.

Thereafter, similarly, the anomaly propagation path tracking unit 50 repeats the assignment of the anomaly propagation order on as described above until the anomaly propagation order on is assigned to the anomaly detection sensors Xn corresponding to all the nodes on the anomaly propagation graph D11.

In addition, there may be a plurality of paths for tracking anomaly propagation, that is, a plurality of anomaly propagation orders on to be assigned, depending on how nodes to be tracked are selected. For example, in the example illustrated in FIG. 5, it is assumed that the both side arrow between the node N52 and the node N56 is a one side arrow from the node N56 to the node N52. In this case, there are two candidates for the anomaly propagation order o1 assigned to the anomaly detection sensor X1 corresponding to the node N51. Specifically, as a candidate of the anomaly propagation order o1 assigned to the anomaly detection sensor X1, the anomaly propagation order o1 assigned on the basis of the path from the node N54 directly to the node N51 and the anomaly propagation order o1 assigned on the basis of the path from the node N56 to the node N51 via the node N52 are listed as candidates of the anomaly propagation order o1 assigned to the anomaly detection sensor X1. In this case, for example, the anomaly propagation path tracking unit 50 assigns a candidate having a later order among the candidates of the anomaly propagation order o1 to the anomaly propagation order o1. In addition, this is merely an example, and the anomaly propagation path tracking unit 50 may assign one with an earlier order to the anomaly propagation order o1 of the node N51, for example.

The anomaly propagation path tracking unit 50 generates an estimation result (hereinafter referred to as an “anomaly propagation order estimation result”) of the anomaly propagation order on and causes the estimation result to be stored in the data storage unit 20. In the following first embodiment, the anomaly propagation order estimation result is referred to as an “anomaly propagation order estimation result D6”.

The anomaly propagation order estimation result D6 is, for example, information in which information indicating the anomaly detection sensor Xn (indicated by D6A in FIG. 5), an anomaly detection sensor flag fn (indicated by D6B in FIG. 5) indicating whether or not the anomaly detection sensor Xn is included in the anomaly detection sensor, and the anomaly propagation order on (indicated by D6C in FIG. 5) estimated by the anomaly propagation path tracking unit 50 are associated with each other. Note that, in the example illustrated in FIG. 5, as the sensor Xn included in the anomaly propagation order estimation result D6, only the anomaly detection sensor Xn is included. The anomaly detection sensor flag fn is a Boolean value. In the example illustrated in FIG. 5, since all the anomaly detection sensors Xn set in the anomaly propagation order estimation result D6, specifically, the anomaly detection sensors X1, X2, X4, and X6 are anomaly detection sensors, the anomaly propagation path tracking unit 50 assigns (True) to the anomaly detection sensor flag fn of the anomaly detection sensors X1, X2, X4, and X6, for example.

Note that, in the estimation of the anomaly propagation order based on the anomaly detection sensor information D3 and the influence propagation relationship matrix D9 by the anomaly propagation path tracking unit 50 described with reference to FIG. 5, the anomaly propagation path tracking unit 50 selects only the dependence relationship among the pieces of sensor data related to the anomaly detection sensor Xn when converting the influence propagation graph D10 into the anomaly propagation graph D11, but this is merely an example.

For example, as illustrated in FIG. 6, when converting the influence propagation graph D10 into the anomaly propagation graph D11, the anomaly propagation path tracking unit 50 may select a dependence relationship among the pieces of sensor data related to the sensor Xn in a case where at least one of two different sensors Xn is the anomaly detection sensor Xn.

In this case, the anomaly propagation path tracking unit 50 selects an edge in which at least one of connected nodes among the nodes N51, N52, N53, N54, N55, and N56 corresponding to the sensors X1, X2, X3, X4, X5, and X6 represented by the influence propagation graph D10 and the edges between the nodes N51, N52, N53, N54, N55, and N56 corresponding to the sensors X1, X2, X3, X4, X5, and X6 is a node corresponding to the anomaly detection sensors X1, X2, X4, and X6, and a node connected to the edge. For example, the node N53 corresponding to the sensor X3 and the node N54 corresponding to the sensor X4 are connected by the edge of the both side arrow. Here, the sensor X3 is not included in the anomaly detection sensor Xn, but the sensor X4 is included in the anomaly detection sensor Xn. Thus, in the anomaly propagation graph D11, the edge between the node N53 and the node N45 is not deleted.

Furthermore, in this case, for example, the anomaly propagation path tracking unit 50 may generate the anomaly propagation graph D11 in such a manner that the nodes N53 and N55 corresponding to the sensors X3 and X5 not included in the anomaly detection sensor Xn out of the nodes N51, N52, N53, N54, and N55 corresponding to the sensors X1, X2, X3, X4, X5, and X6 represented by the anomaly propagation graph D11 can understand that. In the anomaly propagation graph D11 illustrated in FIG. 6, the nodes N51, N52, N54, and N56 are represented by solid circles, and the nodes N53 and N55 are represented by dotted circles.

Further, in this case, the anomaly propagation path tracking unit 50 estimates the anomaly propagation order on on the basis of the anomaly propagation graph D11 including the nodes N53 and N55 corresponding to the sensors X3 and X5 of the sensors Xn that are not included in the anomaly detection sensor Xn.

For example, in FIG. 6, the nodes N53 and N54 are not drawn with a one side arrow from other nodes. Thus, the anomaly propagation path tracking unit 50 assigns the anomaly propagation orders o3 and o4 to the sensors X3 and X4, respectively. At this time, o3=o4. For example, the anomaly propagation path tracking unit 50 sets o3=o4=1. That is, the anomaly propagation path tracking unit 50 sets the anomaly propagation orders o3 and o4 of the sensors X3 and X4, respectively, to “1”(st).

Next, the anomaly propagation path tracking unit 50 assigns the anomaly propagation orders o1 and o5 larger than the anomaly propagation order o4 to the sensors X1 and X5, respectively, corresponding to the nodes N51 and N55 at the end points of the one side arrows exiting from the node N54 to which the smallest anomaly propagation order (here, “1”) is assigned. For example, the anomaly propagation path tracking unit 50 sets o1=o5=2. That is, the anomaly propagation path tracking unit 50 sets the anomaly propagation order of the sensors X1 and X5 to “2”(nd). Furthermore, the anomaly propagation path tracking unit 50 assigns the anomaly propagation orders o2 and o6 larger than the anomaly propagation order o5 to the sensors X2 and X6, respectively, corresponding to N52 and N56 at the end points of the one side arrows exiting from the node N55, respectively. For example, the anomaly propagation path tracking unit 50 sets o2=o6=3. That is, the anomaly propagation path tracking unit 50 sets the anomaly propagation order of the sensors X2 and X6 to “3”(rd).

In addition, although the anomaly propagation order o1, in other words, “2”(nd) has already been assigned to X1 corresponding to the node N51, since the node N51 is a node at the end point of the one side arrow exiting from the node N52, the anomaly propagation path tracking unit 50 may finally reassign the anomaly propagation order o2, in other words, the order larger than “3”(rd) to the sensor X1 corresponding to the node N51 as the anomaly propagation order o1. For example, the anomaly propagation path tracking unit 50 may reassign the anomaly propagation order o1 to “4”(th).

In addition, in the example illustrated in FIG. 6, the nodes N51, N52, N53, N54, N55, and N56 on the anomaly propagation graph D11 include the nodes N53 and N55 corresponding to the sensors X3 and X5 not included in the anomaly detection sensor Xn. Therefore, after assigning the anomaly propagation orders o1, o2, o3, o4, o5, and o6 to the sensors X1, X2, X3, X4, X5, and X6, respectively, the anomaly propagation path tracking unit 50 may weight the anomaly propagation orders o3 and o5 assigned to the sensors X3 and X5. For example, in the example illustrated in FIG. 6, the weight b is added to each of the anomaly propagation orders o3 and o5 corresponding to the sensors X3 and X5 included in the anomaly propagation order estimation result D6. Further, the weight b is a real number equal to or more than 0.

Then, the anomaly propagation path tracking unit 50 causes the anomaly propagation order estimation result D6 to be stored in the data storage unit 20. As described above, in the example illustrated in FIG. 6, the sensors Xn, specifically, the sensors X1, X2, X3, X4, X5, and X6 set in the anomaly propagation order estimation result D6 include the sensors X3 and X5 that are not included in the anomaly detection sensor Xn (specifically, the anomaly detection sensors X1, X2, X4, and X6). The anomaly propagation path tracking unit 50 assigns (False) to the anomaly detection sensor flag fn of the sensors X3 and X5.

Note that, here, it is assumed that the anomaly propagation path tracking unit 50 acquires the anomaly detection sensor information D3 from the anomaly detecting unit 30 via the data storage unit 20, but this is merely an example. The anomaly propagation path tracking unit 50 may directly acquire the anomaly detection sensor information D3 from the anomaly detecting unit 30.

The description returns to the configuration example of the anomaly factor estimating device 100 illustrated in FIG. 2.

The anomaly factor estimating unit 60 acquires the anomaly detection order estimation result D5 output by the anomaly detection order estimating unit 40 and the anomaly propagation order estimation result D6 output by the anomaly propagation path tracking unit 50 from the data storage unit 20, and performs anomaly factor estimation processing of estimating a factor of the anomaly on the basis of the anomaly detection order estimated by the anomaly detection order estimating unit 40 and the anomaly propagation order estimated by the anomaly propagation path tracking unit 50.

Specifically, the anomaly factor estimating unit 60 calculates the anomaly factor score indicating the degree of likelihood of the generation source of the anomaly on the basis of the anomaly detection order estimation result D5 and the anomaly propagation order estimation result D6, and assigns an order (hereinafter referred to as “anomaly factor order”) based on the calculated anomaly factor score. The higher the degree of anomaly source likelihood, the smaller the anomaly factor score.

First, the anomaly factor estimating unit 60 acquires the anomaly detection order estimation result D5 and the anomaly propagation order estimation result D6 from the data storage unit 20. The anomaly factor estimating unit 60 calculates, for each sensor 300, a corresponding anomaly factor score from the anomaly detection order included in the anomaly detection order estimation result D5 and the anomaly propagation order included in the anomaly propagation order estimation result D6. Here, the anomaly detection order, the anomaly propagation order, and the anomaly factor score are all real numbers. Further, the anomaly factor estimating unit 60 calculates the corresponding anomaly factor score for all the sensors 300 included in the anomaly detection order estimation result D5 or the anomaly propagation order estimation result D6.

For example, the anomaly factor estimating unit 60 calculates a representative value as the anomaly factor score using the weighted average of the anomaly detection order and the anomaly propagation order. The anomaly factor estimating unit 60 may calculate a representative value such as a minimum or a maximum as the anomaly factor score. That is, for example, the anomaly factor estimating unit 60 may calculate a smaller one or a larger one of the anomaly detection order and the anomaly propagation order as the anomaly factor score.

In addition, when only one of the anomaly detection order and the anomaly propagation order is set, the anomaly factor estimating unit 60 may weight the anomaly factor score in consideration of the fact that only the set order is set. For example, in a case where only one of the anomaly detection order and the anomaly propagation order is set, the anomaly factor estimating unit 60 adds the weight b to the anomaly factor score. Further, the weight b is a real number equal to or more than 0. For example, in a case where the anomaly propagation path tracking unit 50 assigns the anomaly propagation order assuming that the node corresponding to the sensor Xn not included in the anomaly detection sensor Xn is also included when converting the influence propagation graph D10 into the anomaly propagation graph D11, a situation in which the anomaly detection order is not set but the anomaly propagation order is set may occur.

After calculating the anomaly factor score for each sensor 300, the anomaly factor estimating unit 60 then assigns an anomaly factor order based on the anomaly factor score to the sensor 300 on the basis of the calculated anomaly factor score. Further, the anomaly factor order is a real number.

For example, the anomaly factor estimating unit 60 assigns the anomaly factor order in such a manner that the anomaly factor order corresponding to the sensor 300 is in ascending order from the sensor 300 having the smallest corresponding anomaly factor score. In a case where there is a plurality of sensors 300 having equal corresponding anomaly factor scores, the anomaly factor estimating unit 60 assigns the same anomaly factor order to the plurality of sensors 300, for example.

When the anomaly factor order is assigned to each sensor 300, the anomaly factor estimating unit 60 generates information regarding the anomaly factor order assigned to each sensor 300 (hereinafter referred to as “anomaly factor order estimation result”) and causes the information to be stored in the data storage unit 20. In the following first embodiment, the anomaly factor order estimation result is referred to as an “anomaly factor order estimation result D7”.

The anomaly factor order estimation result D7 is information in which information indicating the sensor 300, an anomaly detection sensor flag indicating whether or not the sensor 300 is an anomaly detection sensor included in the anomaly detection order estimation result D5, an anomaly factor score, and an anomaly factor order are associated with each other.

Further, the anomaly detection sensor flag is a Boolean value. For example, the anomaly factor estimating unit 60 assigns (True) to the anomaly detection sensor flag corresponding to the sensor 300 when the sensor 300 is the anomaly detection sensor, and assigns (False) to the anomaly detection sensor flag corresponding to the sensor 300 when the sensor 300 is not the anomaly detection sensor. For example, when the information regarding the sensor 300 is included in the anomaly detection order estimation result D5, the anomaly factor estimating unit 60 only needs to determine that the sensor 300 is the anomaly detection sensor Xi.

The anomaly factor estimation processing performed by the anomaly factor estimating unit 60 as described above will be described with specific examples with reference to the drawings.

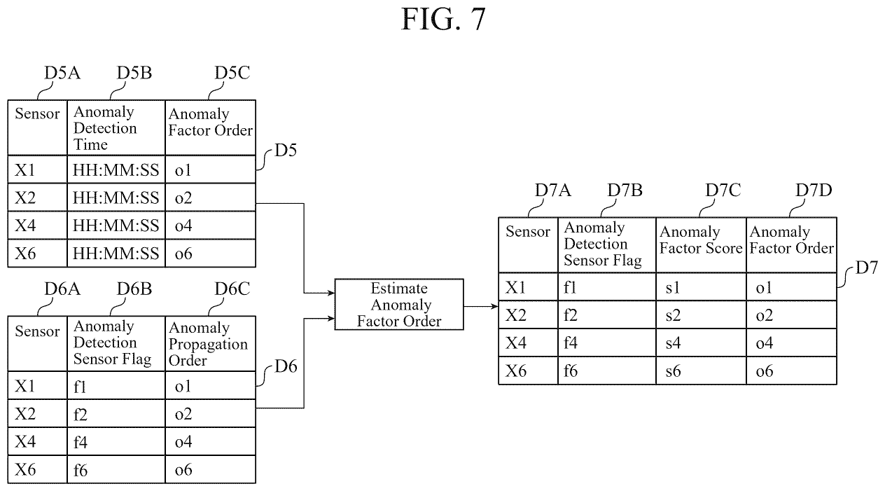

FIG. 7 is a diagram for describing a specific example of the anomaly factor estimation processing performed by the anomaly factor estimating unit 60 in the first embodiment.

In FIG. 7, as an example, the quantity of sensors 300 is represented as n (n=1 to 6), and the quantity n of sensors 300 is represented as a sensor Xn. Further, it is assumed that among the sensors Xn, the sensors X1, X2, X4, and X6 are anomaly detection sensors.

In addition, in the example illustrated in FIG. 7, the anomaly propagation order estimation result D6 used by the anomaly factor estimating unit 60 for the anomaly factor estimation processing is information in which only the anomaly propagation order corresponding to the anomaly detection sensor Xi is recorded as illustrated in FIG. 5.

In the example illustrated in FIG. 7, the anomaly factor estimating unit 60 acquires the anomaly detection order estimation result D5 and the anomaly propagation order estimation result D6 regarding the anomaly detection sensors X1, X2, X4, and X6 from the data storage unit 20.

Here, in the anomaly detection order estimation result D5, it is assumed that the anomaly detection orders o1, o2, o4, and o6 (indicated by D5C in FIG. 7) corresponding to the anomaly detection sensors X1, X2, X4, and X6 are “2”(nd), “3”(rd), “1”(st), and “4”(th), respectively. Further, in the anomaly propagation order estimation result D6, the anomaly propagation orders o1, o2, o4, and o6 (indicated by D6C in FIG. 7) corresponding to the anomaly detection sensors X1, X2, X4, and X6 are “2”(nd), “1”(st), “1”(st), and “1”(st), respectively.

Here, it is assumed that the anomaly factor estimating unit 60 calculates an anomaly factor score sn (n=1, 2, 4, 6) corresponding to the anomaly detection sensor Xn using the average. In this case, the anomaly factor estimating unit 60 calculates anomaly factor scores s1, s2, s4, and s6 corresponding to the anomaly detection sensors X1, X2, X4, and X6 as “2”, “2”, “1”, and “2.5”, respectively. On the basis of the calculated anomaly factor scores s1, s2, s4, and s6, the anomaly factor estimating unit 60 assigns the anomaly factor orders o1, o2, o4, and o6 corresponding to the anomaly detection sensors X1, X2, X4, and X6 as “2”(nd), “2”(nd), “1”(st), and “3”(rd), respectively.

Then, the anomaly factor estimating unit 60 generates the anomaly factor order estimation result D7.

Specifically, the anomaly factor estimating unit 60 generates the anomaly factor order estimation result D7 in which information indicating the anomaly detection sensors X1, X2, X4, and X6 (indicated by D7A in FIG. 7), anomaly detection sensor flags f1, f2, f4, and f6 (indicated by D7B in FIG. 7) indicating whether the anomaly detection sensors X1, X2, X4, and X6 are included in the anomaly detection order estimation result D5, anomaly factor scores s1, s2, s4, and s6 (indicated by D7C in FIG. 7), and anomaly factor orders o1, o2, o4, and o6 (indicated by D7D in FIG. 7) are associated with each other.

Here, the sensor Xn included in the anomaly detection order estimation result D5 is equal to the anomaly detection sensor Xn. Thus, all the anomaly detection sensor flags f1, f2, f4, and f6 corresponding to the anomaly detection sensors X1, X2, X4, and X6 are (True).

Then, the anomaly factor estimating unit 60 causes the generated anomaly factor order estimation result D7 to be stored in the data storage unit 20.

Note that, here, it is assumed that the anomaly factor estimating unit 60 acquires the anomaly detection order estimation result D5 from the anomaly detection order estimating unit 40 via the data storage unit 20, and acquires the anomaly propagation order estimation result D6 from the anomaly propagation path tracking unit 50 via the data storage unit 20, but this is merely an example. The anomaly factor estimating unit 60 may directly acquire the anomaly detection order estimation result D5 and the anomaly propagation order estimation result D6 from the anomaly detection order estimating unit 40 and the anomaly propagation path tracking unit 50, respectively.

The description returns to the configuration example of the anomaly factor estimating device 100 illustrated in FIG. 2.

The anomaly factor estimation result output unit 70 acquires the anomaly factor order estimation result D7 output from the data storage unit 20 by the anomaly factor estimating unit 60, the anomaly detection order estimation result D5 output from the anomaly detection order estimating unit 40, and the anomaly propagation order estimation result D6 output from the anomaly propagation path tracking unit 50, and outputs information regarding the estimation result of the factor of the anomaly by the anomaly factor estimating unit 60.

Specifically, on the basis of the anomaly factor order estimation result D7, the anomaly detection order estimation result D5, and the anomaly propagation order estimation result D6, the anomaly factor estimation result output unit 70 outputs information (hereinafter referred to as “anomaly factor estimation result display information”) for causing the display device 400 to display a screen (hereinafter referred to as an “anomaly factor estimation result screen”) indicating information regarding the estimation result of the factor of the anomaly by the anomaly factor estimating unit 60.

Note that, in the first embodiment, the anomaly factor estimation result output unit 70 is provided in the anomaly factor estimating device 100, but this is merely an example. The anomaly factor estimation result output unit 70 may be included in a device (not illustrated) such as a display connected to the anomaly factor estimating device 100 via a wired or wireless signal line.

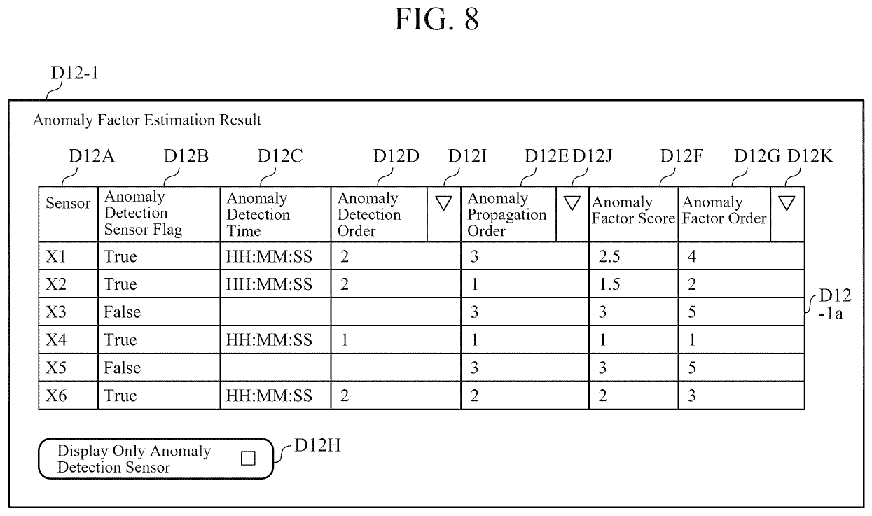

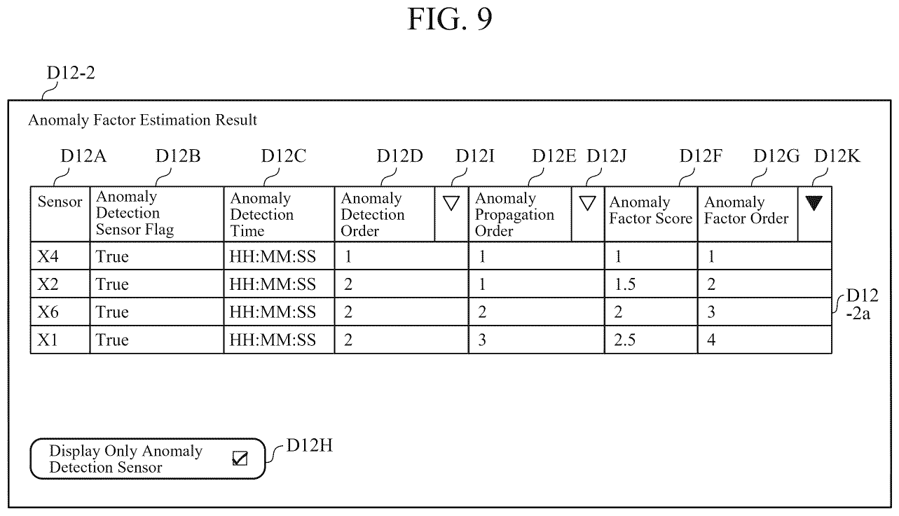

Here, FIGS. 8 and 9 are diagrams for describing screen examples of the anomaly factor estimation result screen displayed on the display device 400 by the anomaly factor estimation result output unit 70 in the first embodiment.

FIGS. 8 and 9 illustrate examples of the anomaly factor estimation result screen when the quantity of sensors 300 is six (sensor Xn. n=1 to 6) as an example.

In FIGS. 8 and 9, the anomaly factor estimation result screens are indicated by “D12-1” and “D12-2”.

For example, as illustrated in FIGS. 8 and 9, the anomaly factor estimation result screen includes eleven display frames of a display frame D12A, a display frame D12B, a display frame D12C, a display frame D12D, a display frame D12E, a display frame D12F, a display frame D12G, a display frame D12H, a display frame D12I, a display frame D12J, and a display frame D12K.

For example, the anomaly factor estimation result output unit 70 causes an anomaly factor estimation result list in which information regarding estimation results of anomaly factors is listed to be displayed on the anomaly factor estimation result screen. For example, the anomaly factor estimation result list is a list in which the information indicating the sensor Xn, the information indicating the anomaly detection sensor flag, the anomaly detection time, the anomaly detection order, the anomaly propagation order, the anomaly factor score, and the anomaly factor order are displayed in association with each other for each sensor Xn. In the anomaly factor estimation result screens illustrated in FIGS. 8 and 9, the anomaly factor estimation result lists are indicated by “D12-1a” and “D12-2a”.

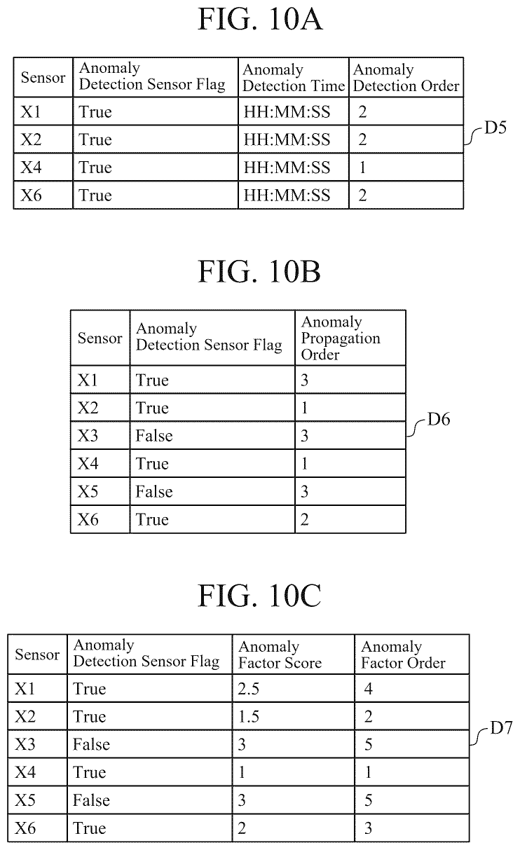

The screen example of the anomaly factor estimation result screen illustrated in FIG. 8 is, for example, a screen example in a case where the content of the anomaly detection order estimation result D5 is as illustrated in FIG. 10A, the content of the anomaly propagation order estimation result D6 is as illustrated in FIG. 10B, and the content of the anomaly factor order estimation result D7 is as illustrated in FIG. 10C.

The anomaly factor estimation result output unit 70 outputs, to the display device 400, the anomaly factor estimation result display information that causes the information indicating the sensor Xn of the anomaly factor order estimation result D7 to be displayed in the display frame D12A, causes information indicating the anomaly detection sensor flag of the anomaly factor order estimation result D7 to be displayed in the display frame D12B, causes information indicating the anomaly detection time of the anomaly detection order estimation result D5 to be displayed in the display frame D12C, causes the anomaly detection order of the anomaly detection order estimation result D5 to be displayed in the display frame D12D, causes the anomaly propagation order of the anomaly propagation order estimation result D6 to be displayed in the display frame D12E, causes the anomaly factor score of the anomaly factor order estimation result D7 to be displayed in the display frame D12F, causes the anomaly factor order of the anomaly factor order estimation result D7 to be displayed in the display frame D12G, causes sort buttons for rearranging, in ascending order, the arrangement order of the anomaly factor estimation result list based on the anomaly detection order of the anomaly detection order estimation result D5, the anomaly propagation order of the anomaly propagation order estimation result D6, and the anomaly factor order of the anomaly factor order estimation result D7 to be displayed in the display frames D12I, D12J, and D12K, respectively, and causes a check box for receiving an instruction to display only the anomaly detection sensor to be displayed in the display frame D12H. As a result, the display device 400 displays the anomaly factor estimation result screen as illustrated in FIG. 8.

For example, the anomaly factor estimation result output unit 70 causes “True” to be displayed in the display frame D12B when (True) is set to the anomaly detection sensor flag of the anomaly factor order estimation result D7, and causes “False” to be displayed in the display frame D12B when (False) is set to the anomaly detection sensor flag.

For example, when no value is set for the anomaly detection time or the anomaly detection order of the anomaly detection order estimation result D5, the anomaly factor estimation result output unit 70 causes a blank to be displayed.

Further, for example, the anomaly factor estimation result output unit 70 causes the information indicating the sensor Xn, the information indicating the anomaly detection sensor flag, the anomaly detection time, the anomaly detection order, the anomaly propagation order, the anomaly factor score, and the anomaly factor order associated with the sensor Xn according to the order of the ID assigned to the sensor Xn to be displayed in association with each other in the initial state of the anomaly factor estimation result list. Here, the initial state of the anomaly factor estimation result list refers to a state of the anomaly factor estimation result list when the anomaly factor estimation result output unit 70 causes the display device 400 to display the anomaly factor estimation result list for the first time after the power is turned on, for example.

An example of the anomaly factor estimation result list illustrated in FIG. 8 is an example of the anomaly factor estimation result list in an initial state.

In the initial state of the anomaly factor estimation result list, the anomaly factor estimation result output unit 70 sets the anomaly factor estimation result list to a state where an instruction to rearrange data and an instruction to display only the anomaly detection sensor are not made as illustrated in FIG. 8.

For example, the operator checks the anomaly factor estimation result screen as illustrated in FIG. 8. Thus, the operator grasps information regarding the estimation result of the factor of the anomaly. For example, the operator can specify the device that has caused the anomaly from the information of the sensor Xn that has caused the anomaly. In addition, the operator can grasp the order in which the devices in which the anomaly has occurred should be inspected. Therefore, the operator can reduce unnecessary inspection work, and the load on the operator is reduced.

Furthermore, when the anomaly factor estimation result list as illustrated in FIG. 8 is displayed, the operator can instruct to rearrange the information indicated in the anomaly factor estimation result list.

For example, by operating the input device (not illustrated) such as a mouse or a keyboard to press the sort buttons of the display frames D12I, D12J, and D12K, the operator can instruct sorting of information. For example, upon receiving an instruction to rearrange the information, the anomaly factor estimation result output unit 70 causes the sort button with which the instruction is input, in other words, the pressed sort button to be displayed in black. Then, for example, the anomaly factor estimation result output unit 70 outputs, to the display device 400, the anomaly factor estimation result display information for displaying an anomaly factor estimation result list in which information to be displayed is rearranged according to the input instruction. Thus, the anomaly factor estimation result list displayed on the display device 400 is updated to the anomaly factor estimation result list in which the displayed information is rearranged.

Furthermore, for example, the operator or the like can input an instruction to display only the information regarding the anomaly detection sensor in the anomaly factor estimation result list by operating the input device and pressing the check box displayed in the display frame D12H. For example, when the instruction to display only the information regarding the anomaly detection sensor in the anomaly factor estimation result list is input, the anomaly factor estimation result output unit 70 causes a check to be displayed in the check box. Then, for example, the anomaly factor estimation result output unit 70 outputs, to the display device 400, the anomaly factor estimation result display information that causes only the information regarding the anomaly detection sensor to be displayed in the anomaly factor estimation result list according to the input instruction. Thus, the anomaly factor estimation result list displayed on the display device 400 is updated to the anomaly factor estimation result list displaying only the information regarding the anomaly detection sensor.

FIG. 9 is a diagram illustrating an example of the anomaly factor estimation result screen in which, in a state where the anomaly factor estimation result screen as illustrated in FIG. 8 is displayed, the sort button in the display frame D12K of the anomaly factor estimation result list is pressed by the operator, the information of the anomaly factor estimation result list is rearranged in ascending order of the anomaly factor order by the anomaly factor estimation result output unit 70 that has received the pressing, the check box of the display frame D12H is pressed thereafter by the operator, and the anomaly factor estimation result list is displayed in which only the row corresponding to the anomaly detection sensor whose anomaly detection sensor flag is (True) is caused to be displayed by the anomaly factor estimation result output unit 70 that has received the pressing.

On the anomaly factor estimation result screen illustrated in FIG. 9, the anomaly factor estimation result list is displayed in which only the rows corresponding to the sensors X1, X2, X4, and X6 (that is, the anomaly detection sensors) with the anomaly detection sensor flag of (True) are displayed, and the rows corresponding to the sensors X1, X2, X4, and X6 are rearranged in ascending order of the anomaly factor order of the row corresponding to the sensor X4, the row corresponding to the sensor X2, the row corresponding to the sensor X6, and the row corresponding to the sensor X1 on the basis of the anomaly factor order.

In the anomaly factor estimation result screen illustrated in FIG. 9, a check is displayed in the check box of the display frame D12H. Thus, the operator can recognize that only the anomaly detection sensor is displayed on the anomaly factor estimation result screen. In addition, in the anomaly factor estimation result screen illustrated in FIG. 9, the sort button in the display frame D12K is filled. Thus, the operator can recognize that the rows of the anomaly factor estimation result list are rearranged in ascending order of the anomaly factor order on the anomaly factor estimation result screen.

Further, for example, when the operator presses the same sort button again in a state where any one sort button among the sort buttons displayed in the display frames D12H, D12J, and D12K is pressed, that is, in a state where the display of the anomaly factor estimation result list has been rearranged, it is possible to return the display of the anomaly factor estimation result list to a state before giving an instruction to rearrange the display of the anomaly factor estimation result list. Upon receiving that the same sort button has been pressed again, the anomaly factor estimation result output unit 70 causes the sort button that has been displayed in a filled state to be displayed without being filled. Then, the anomaly factor estimation result output unit 70 outputs, to the display device 400, the anomaly factor estimation result display information for displaying the anomaly factor estimation result list before sorting. Thus, the anomaly factor estimation result list displayed on the display device 400 is updated to the anomaly factor estimation result list before sorting (see FIG. 8).

Furthermore, for example, when the operator presses the check box again in a state where the check box in the display frame D12H is pressed, that is, in a state where the anomaly factor estimation result list displaying only the information regarding the anomaly detection sensor is displayed, the display of the anomaly factor estimation result list can be returned to the state before the instruction to display only the information regarding the anomaly detection sensor is given. Upon receiving that the check box is pressed again, the anomaly factor estimation result output unit 70 causes an unchecked check box to be displayed. Then, the anomaly factor estimation result output unit 70 outputs, to the display device 400, the anomaly factor estimation result display information for displaying the anomaly factor estimation result list before switching to the display of only the information regarding the anomaly detection sensor. Thus, the anomaly factor estimation result list displayed on the display device 400 is updated to the anomaly factor estimation result list (see FIG. 8) before switching to the display of only the information regarding the anomaly detection sensor.

Note that, here, the anomaly factor estimation result screen in the initial state is a screen as illustrated in FIG. 8, but this is merely an example. For example, on the anomaly factor estimation result screen in the initial state, the anomaly factor estimation result output unit 70 may rearrange, in ascending order, the information regarding the sensors 300 displayed in the anomaly factor estimation result list on the basis of any of the anomaly detection order, the anomaly propagation order, and the anomaly factor order in advance, or may display the anomaly factor estimation result list in which only the anomaly detection sensors are displayed.

The description returns to the configuration example of the anomaly factor estimating device 100 illustrated in FIG. 2.

The data storage unit 20 stores various types of information.

Specifically, the data storage unit 20 stores, for example, the related structure D2 generated by the learning device 200, the sensor data D1 acquired by the sensor data acquiring unit 10, the anomaly detection sensor information D3 and the anomaly detection time information D4 output by the anomaly detecting unit 30, the anomaly detection order estimation result D5 output by the anomaly detection order estimating unit 40, the anomaly propagation order estimation result D6 output by the anomaly propagation path tracking unit 50, and the anomaly factor order estimation result D7 output by the anomaly factor estimating unit 60.

Note that, in a second embodiment, as illustrated in FIG. 2, the data storage unit 20 is included in the anomaly factor estimating device 100, but this is merely an example. The data storage unit 20 may be provided outside the anomaly factor estimating device 100 in a place that can be referred to by the anomaly factor estimating device 100.

A configuration example of the learning device 200 according to the first embodiment will be described.

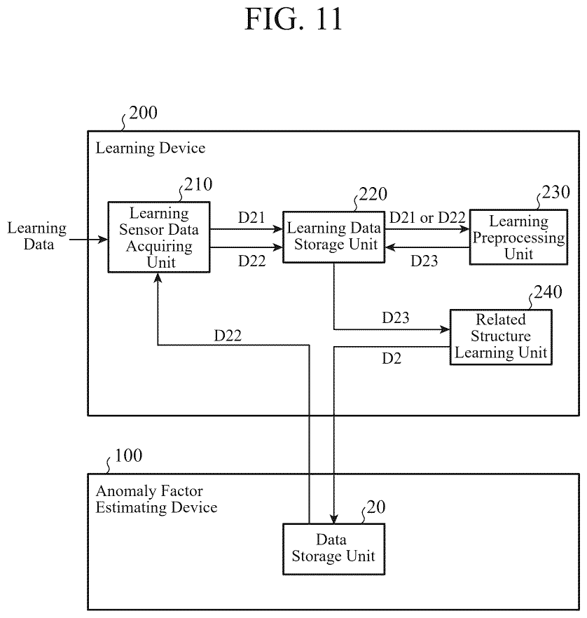

FIG. 11 is a diagram illustrating a configuration example of the learning device 200 according to the first embodiment.

The learning device 200 performs learning using sensor data collected by the sensor 300 provided in the target facility during the time of normal operation of the target facility. Specifically, the learning device 200 estimates the related structure D2 using the sensor data collected by the sensor 300 provided in the target facility during the time of normal operation of the target facility. Note that the time of normal operation of the target facility is specifically a time of normal operation of the plurality of devices constituting the target facility. Thus, the sensor data collected by the sensor 300 during the time of normal operation of the target facility is specifically sensor data collected by the sensor 300 provided in each device during a time of normal operation of the plurality of devices constituting the target facility.

The learning device 200 causes the learned related structure D2 to be stored in the data storage unit 20 of the anomaly factor estimating device 100.

Note that, in FIG. 11, only the data storage unit 20 is illustrated as a configuration unit of the anomaly factor estimating device 100 for the sake of simplicity of description.

The learning device 200 includes a learning sensor data acquiring unit 210, a learning data storage unit 220, a learning preprocessing unit 230, and a related structure learning unit 240.

The learning sensor data acquiring unit 210 acquires learning data used for learning of the related structure D2. The learning data includes sensor data acquired from the plurality of sensors 300.

Note that not all the learning data acquired by the learning sensor data acquiring unit 210 is used for learning of the related structure D2. The learning preprocessing unit 230 to be described later acquires learning data actually used for learning of the related structure D2 on the basis of the learning data acquired by the learning sensor data acquiring unit 210. Therefore, the learning data acquired by the learning sensor data acquiring unit 210 is more accurately a learning data candidate. Details of the learning preprocessing unit 230 will be described later.

The learning sensor data acquiring unit 210 causes the acquired learning data candidate to be stored in the learning data storage unit 220.

Here, the learning data candidate is information of the same type as the sensor data D1 acquired by the anomaly factor estimating device 100 from the sensor 300, specifically, information of the same content (a measurement value or a control value of at least one of an opening degree, a deviation, a rotational speed, a conductivity, a flow rate, a pressure, a temperature, a concentration, or a water level) as the sensor data D1, and is sensor data collected by the sensor 300 during the time of normal operation of the plurality of devices that is the plurality of facility components of the target facility. That is, the learning data candidate includes a sensor measurement value or a control value during the time of normal operation of the target facility. Note that the learning data candidate is the same type of information as the sensor data D1 acquired from the same sensor 300 as the sensor 300 that is the acquisition source of the sensor data D1 by the anomaly factor estimating device 100.

The learning data candidate is prepared in advance by, for example, an administrator or the like, and is stored in a place that can be referred to by the learning device 200. For example, the learning data candidate may be stored in the data storage unit 20 of the anomaly factor estimating device 100. In this case, the learning sensor data acquiring unit 210 only needs to acquire the learning data candidate from the data storage unit 20 of the anomaly factor estimating device 100.

In the first embodiment, the learning data candidate acquired by the learning sensor data acquiring unit 210 is set as a “learning data candidate D21”.

Note that, in FIG. 11, a learning data candidate acquired from a place other than the anomaly factor estimating device 100 by the learning sensor data acquiring unit 210 is illustrated as a “learning data candidate D21”, and a learning data candidate acquired from the anomaly factor estimating device 100 by the learning sensor data acquiring unit 210 is illustrated as a “learning data candidate D22” in a distinguished manner. This is for ease of understanding, and the contents of the “learning data candidate D21” and the “learning data candidate D22” are the same.

Thus, in the following description, both the “learning data candidate D21” and the “learning data candidate D22” will be described as the “learning data candidate D21”.

The learning preprocessing unit 230 acquires the learning data candidate D21 acquired by the learning sensor data acquiring unit 210 from the learning data storage unit 220 and performs preprocessing on the learning data candidate D21. Note that the learning preprocessing unit 230 acquires the learning data candidate D21 stored in the predetermined time from the learning data storage unit 220 every predetermined time.

Specifically, the learning preprocessing unit 230 performs data conversion, selection, or the like on the learning data candidate D21, and acquires learning data actually used in learning of the related structure D2.

For example, the learning preprocessing unit 230 converts the learning data candidate D21 into a first-order difference series, and sets the converted learning data candidate D21 as learning data. In this case, the sensor data included in the learning data candidate D21 is converted into data indicating a change amount.

In addition, for example, the learning preprocessing unit 230 may select only sensor data having a large variance from the sensor data included in the learning data candidate D21 and use the selected sensor data as the learning data. In this case, the learning preprocessing unit 230 provides a threshold of a variance, and selects sensor data having a variance larger than the threshold among the sensor data included in the learning data candidate D21 as the learning data. Note that the threshold of the variance is manually set by, for example, the operator or the like. The operator or the like operates the input device such as a mouse or a keyboard to input a threshold of a variance, and sets the threshold of the variance. Furthermore, for example, in a case where a measurement error of the sensor 300 is known, the learning preprocessing unit 230 may use the square of the measurement error as the threshold of the variance.

The learning preprocessing unit 230 causes the acquired learning data to be stored in the learning data storage unit 220. In the first embodiment, the learning data acquired by the learning preprocessing unit 230 is set as “learning data D23”.

In the following first embodiment, as an example, it is assumed that the preprocessing performed on the learning data candidate D21 by the learning preprocessing unit 230 is selection, and the learning preprocessing unit 230 acquires, as the learning data D23, sensor data having a variance larger than the threshold among the sensor data included in the learning data candidate D21.

Note that, here, it is assumed that the learning preprocessing unit 230 acquires the learning data candidate D21 from the learning sensor data acquiring unit 210 via the learning data storage unit 220, but this is merely an example. The learning preprocessing unit 230 may directly acquire the learning data candidate D21 from the learning sensor data acquiring unit 210.

The related structure learning unit 240 acquires the learning data D23 output by the learning preprocessing unit 230 from the learning data storage unit 220, and learns the related structure D2 on the basis of the learning data D23.

Specifically, the related structure learning unit 240 calculates at least one statistic indicating a relationship between two different pieces of sensor data for a plurality of pieces of sensor data included in the learning data D23, and learns the related structure D2 on the basis of the calculated statistic.

The related structure learning unit 240 uses correlation or cross-correlation, or a waveform based statistical index such as Granger Causality, Transfer entropy, Convergent cross mapping (CCM), or Dynamic Time Warping (DTW) as an index when calculating a statistic (hereinafter referred to as “statistical index”) indicating a relationship among the pieces of sensor data. Furthermore, the related structure learning unit 240 may use a distribution-based statistical index such as Kullback Leibler (KL) divergence or Histogram Intersection (HI) as a statistical index. The statistical index is classified into an undirected type and a directed type. The undirected statistical index refers to a statistical index such as a correlation in which the direction of the dependence relationship cannot be identified, and the directed statistical index refers to a statistical index such as Granger causality in which the direction of the dependence relationship can be identified.

In the first embodiment, as an example, the related structure learning unit 240 calculates one or more types of statistics including at least one directed statistical index indicating a relationship between two different pieces of sensor data for a plurality of pieces of sensor data included in the learning data D23, and learns the related structure D2 on the basis of the calculated statistics.

Learning processing in which the related structure learning unit 240 learns the related structure D2 will be described with a specific example using the drawings.

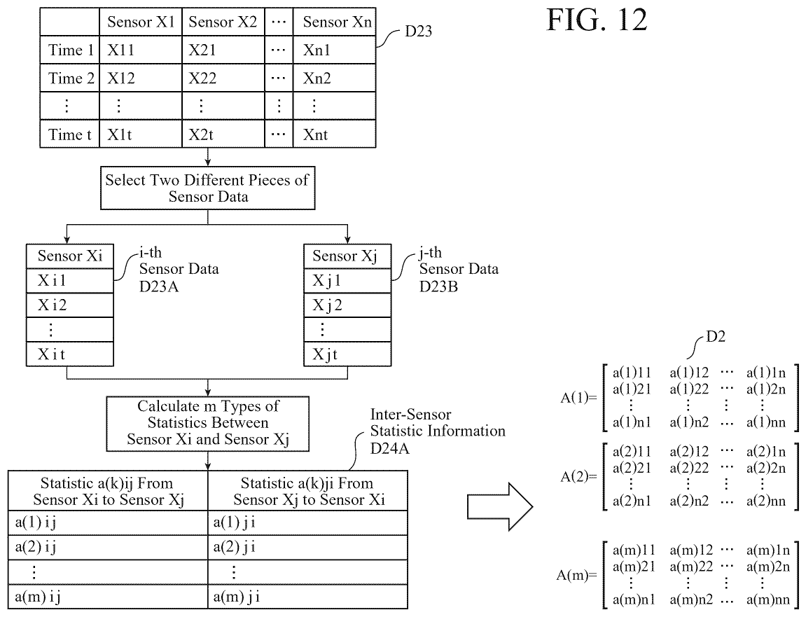

FIG. 12 is a diagram illustrating a concept of an example of learning processing in which the related structure learning unit 240 learns the related structure D2 in the first embodiment.

As illustrated in FIG. 12, the learning data D23 is a two-dimensional data frame in which a row is the number t of times and a column is the quantity n of sensors 300 (represented as a sensor Xn (n=1, 2, 3, 4, . . . , n)). In the related structure D2, all elements defined in the related structure D2 are initialized with “0”. Here, it is assumed that the related structure learning unit 240 uses m types of statistical indexes when learning the related structure D2.

### <Learning Data Selection>

The related structure learning unit 240 selects sensor data collected by two different sensors Xn among the sensor data collected by the sensors Xn included in the learning data D23. For example, the related structure learning unit 240 selects the i-th sensor data collected by the i-th sensor Xi and the j-th sensor data collected by the j-th sensor Xj. Hereinafter, the i-th sensor data collected by the i-th sensor Xi is also simply referred to as “i-th sensor data”, and the j-th sensor data collected by the j-th sensor Xj is also simply referred to as “j-th sensor data”.

### <Calculation of Statistic>

Next, for the i-th sensor data and the j-th sensor data, the related structure learning unit 240 calculates statistics a(1)ij, a(2)ij, . . . , a(m)ij from the i-th sensor data to the j-th sensor data as the statistics from the sensor Xi to the sensor Xj, and calculates statistics a(1)ij, a(2)ij, . . . , a(m)ij from the i-th sensor data to the j-th sensor data as the statistics from the sensor Xi to the sensor Xj by using m types of statistical indexes. Then, the related structure learning unit 240 acquires information (hereinafter referred to as “inter-sensor statistic information”) D24A regarding the statistic between the sensor Xi and the sensor Xj, including a statistic a(k)ij from the sensor Xi to the sensor Xj and a statistic a(k)ji from the sensor Xj to the sensor Xi. Here, the related structure learning unit 240 converts the inter-sensor statistic information D24A as necessary in such a manner that the dependence relationship among the pieces of sensor data increases as the absolute value |a(k)ij| of the statistic increases. For example, a p value corresponding to the statistic a(k)ij of Granger Causality takes a value between 0 and 1, and the smaller the p value, the less it can be said that there is no dependence relationship between the i-th sensor data and the j-th sensor data. In this case, the related structure learning unit 240 sets a statistic a(k)ij in the inter-sensor statistic information as a (1−p value) obtained by converting the p value in such a manner that the larger the statistic, the larger the dependence relationship. On the other hand, in a case where the related structure learning unit 240 calculates the statistic using the correlation that is the undirected statistical index, for example, a correlation coefficient ρ corresponding to the statistic a(k)ij of the correlation takes a value between −1 and 1, indicating that the larger the absolute value of ρ, the larger the dependence relationship between the i-th sensor data and the j-th sensor data. In this case, the related structure learning unit 240 does not convert the inter-sensor statistic information D24A.

Note that the related structure learning unit 240 creates pairs of two different pieces of sensor data of all combinations among the sensor data included in the learning data D23, calculates the statistic for all the two different pieces of sensor data, and acquires the inter-sensor statistic information D24A.

### <Related Structure Learning>

The related structure learning unit 240 learns the related structure D2 using the statistic corresponding to all the pairs of sensor data set in the inter-sensor statistic information D24A as an element. For example, the statistic |a(k)ij| from the i-th sensor Xi to the j-th sensor Xj calculated using the k-th statistical index among the m types of statistical indexes is substituted into the k-th element in the first dimension, the i-th element in the second dimension, and the j-th element in the third dimension of the related structure D2.

After learning the related structure D2 as described above, the related structure learning unit 240 causes the learned related structure D2 to be stored in the data storage unit 20 of the anomaly factor estimating device 100.

For example, the related structure learning unit 240 may store the related structure D2 in the learning data storage unit 220. In this case, in the anomaly factor estimating device 100, for example, the anomaly propagation path tracking unit 50 downloads the related structure D2 to be used from the learning data storage unit 220 to the data storage unit 20 every time the anomaly propagation order estimation processing is executed.

Note that, here, it is assumed that the related structure learning unit 240 acquires the learning data D23 from the learning preprocessing unit 230 via the learning data storage unit 220, but this is merely an example. The related structure learning unit 240 may directly acquire the learning data D23 from the learning preprocessing unit 230.

The description returns to the configuration example of the learning device 200 illustrated in FIG. 11.

The learning data storage unit 220 stores various types of information regarding learning performed by the learning device 200.

Specifically, the learning data storage unit 220 stores, for example, the learning data candidate D21 acquired by the learning sensor data acquiring unit 210 and the learning data D23 output by the learning preprocessing unit 230. The learning data storage unit 220 may store the related structure D2 learned by the related structure learning unit 240.

In addition, here, the learning data storage unit 220 is provided in the learning device 200, but this is merely an example, and the learning data storage unit 220 may be provided in a place that can be referred to by the learning device 200 outside the learning device 200.

Further, in the first embodiment, the learning device 200 includes the learning preprocessing unit 230, but this is merely an example, and the learning device 200 does not necessarily include the learning preprocessing unit 230. In a case where the learning device 200 does not include the learning preprocessing unit 230, for example, the related structure learning unit 240 sets all learning data candidates D21 acquired by the learning sensor data acquiring unit 210 as the learning data D23 actually used for learning of the related structure D2, and learns the related structure D2 using the learning data D23 acquired by the learning sensor data acquiring unit 210. That is, in the learning device 200, the related structure learning unit 240 sets a plurality of learning data candidates acquired by the learning sensor data acquiring unit 210 as a plurality of pieces of learning data, calculates at least one statistic between the plurality of pieces of learning data on the basis of the plurality of pieces of learning data, and learns the estimated structure (related structure D2) indicating the dependence relationship between the facility components on the basis of the calculated statistic.

Operations of the anomaly factor estimating device 100 and the learning device 200 according to the first embodiment will be described.

First, the operation of the anomaly factor estimating device 100 according to the first embodiment will be described.

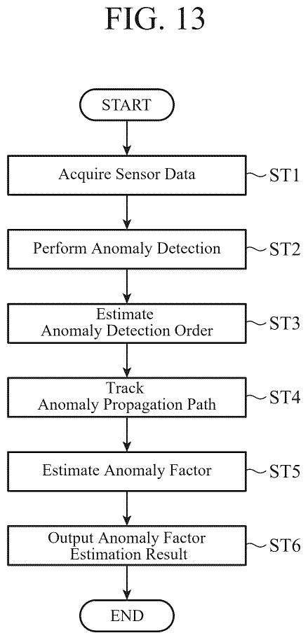

FIG. 13 is a flowchart for describing the operation of the anomaly factor estimating device 100 according to the first embodiment.

The sensor data acquiring unit 10 acquires the sensor data D1 from the sensor 300 (step ST1).

The sensor data acquiring unit 10 causes the acquired sensor data D1 to be stored in the data storage unit 20.

The anomaly detecting unit 30 performs anomaly detection processing on the sensor data D1 caused to be stored in the data storage unit 20 by the sensor data acquiring unit 10 in step ST1 (step ST2).

The anomaly detecting unit 30 causes the anomaly detection sensor information D3 and the anomaly detection time information D4 to be stored in the data storage unit 20.

If the anomaly detecting unit 30 detects an anomaly detection sensor in step ST2, the operation of the anomaly factor estimating device 100 proceeds to step ST3. If the anomaly detecting unit 30 has not detected the anomaly detection sensor in step ST2, the anomaly factor estimating device 100 ends the processing illustrated in the flowchart of FIG. 13.

For example, if the anomaly detecting unit 30 detects the anomaly detection sensor in step ST2, the anomaly detection order estimating unit 40 is notified of the detection, and the operation of the anomaly factor estimating device 100 only needs to proceed to step ST3. On the other hand, if the anomaly detecting unit 30 has not detected the anomaly detection sensor in step ST2, it is sufficient if a control unit (not illustrated) of the anomaly factor estimating device 100 is notified of the non-detection, and the control unit ends the processing of the anomaly factor estimating device 100.

In step ST3, the anomaly detection order estimating unit 40 acquires the anomaly detection sensor information D3 and the anomaly detection time information D4 caused to be stored in the data storage unit 20 by the anomaly detecting unit 30 in step ST2, and performs anomaly detection order estimation processing of estimating the anomaly detection order in which occurrence of an anomaly has been detected in the anomaly detection sensor, more specifically, occurrence of an anomaly has been detected in the sensor data D1 collected by the anomaly detection sensor (step ST3).

The anomaly detection order estimating unit 40 causes the anomaly detection order estimation result D5 to be stored in the data storage unit 20.

The anomaly propagation path tracking unit 50 acquires the anomaly detection sensor information D3 and the related structure D2 caused to be stored by the anomaly detecting unit 30 in step ST3 from the data storage unit 20, and performs the anomaly propagation order estimation processing of estimating the anomaly propagation order on the basis of the acquired anomaly detection sensor information D3 and related structure D2 (step ST4).

The anomaly propagation path tracking unit 50 outputs the anomaly propagation order estimation result D6 to the data storage unit 20.

The anomaly factor estimating unit 60 acquires the anomaly detection order estimation result D5 output by the anomaly detection order estimating unit 40 in step ST3 and the anomaly propagation order estimation result D6 output by the anomaly propagation path tracking unit 50 in step ST4 from the data storage unit 20, and performs the anomaly factor estimation processing of estimating a factor of the anomaly on the basis of the anomaly detection order estimated by the anomaly detection order estimating unit 40 and the anomaly propagation order estimated by the anomaly propagation path tracking unit 50 (step ST5).

The anomaly factor estimating unit 60 generates the anomaly factor order estimation result D7, and causes the generated anomaly factor order estimation result D7 to be stored in the data storage unit 20.

The anomaly factor estimation result output unit 70 acquires, from the data storage unit 20, the anomaly factor order estimation result D7 output by the anomaly factor estimating unit 60 in step ST5, the anomaly detection order estimation result D5 output by the anomaly detection order estimating unit 40 in step ST3, and the anomaly propagation order estimation result D6 output by the anomaly propagation path tracking unit 50 in step ST4, and outputs the information regarding the estimation result of the factor of the anomaly by the anomaly factor estimating unit 60 (step ST6).

Specifically, the anomaly factor estimation result output unit 70 outputs, to the display device 400, the anomaly factor estimation result display information for displaying the anomaly factor estimation result screen. Thus, the anomaly factor estimation result output unit 70 presents information regarding the estimation result of the factor of the anomaly to the operator.

Note that, in a case where the anomaly factor estimating device 100 does not include the anomaly factor estimation result output unit 70, the anomaly factor estimating device 100 can omit the processing of step ST6 in the operation of the anomaly factor estimating device 100 illustrated in the flowchart of FIG. 13. The processing in step ST6 is performed by, for example, a device outside the anomaly factor estimating device 100.

As described above, the anomaly factor estimating device 100 detects a plurality of anomaly detection sensors on the basis of a plurality of pieces of time-series sensor data collected by the plurality of sensors 300 provided in the target facility, and estimates the anomaly detection order in which occurrence of an anomaly has been detected for the plurality of anomaly detection sensors on the basis of the detection time at which the plurality of anomaly detection sensors is detected. The anomaly factor estimating device 100 estimates the anomaly propagation order in which the anomaly has propagated on the basis of the anomaly detection sensor information related to the plurality of anomaly detection sensors and the estimated structure (related structure) indicating the dependence relationship between the plurality of components constituting the target facility, and estimates the factor of the anomaly on the basis of the estimated anomaly detection order and the anomaly propagation order.

Since the anomaly factor estimating device 100 estimates the factor of the anomaly that has occurred in the target facility on the basis of the order in which the anomaly has occurred and the order in which the anomaly propagates, it is possible to more appropriately estimate the factor of the anomaly from a plurality of criteria.

In addition, since the anomaly factor estimating device 100 estimates the propagation order of the anomaly on the basis of the estimated structure (related structure), the estimation of the factor of the anomaly can be executed at an early stage without waiting until sensor data sufficient for constructing the related structure D2 at the time of diagnosis of the target facility is collected.

That is, the anomaly factor estimating device 100 can estimate the factor of the anomaly that has occurred in the target facility regardless of the complexity of the target facility or the scale of the target facility.

Further, the anomaly factor estimating device 100 also outputs an estimation result of the factor of the anomaly.

Therefore, the anomaly factor estimating device 100 improves interpretability and explainability of the estimation result of the factor of the anomaly for the operator. The anomaly factor estimating device 100 can reduce unnecessary inspection work by the operator and reduce the load on the operator. In addition, the anomaly factor estimating device 100 can estimate the factor of the anomaly with a quantitative index that does not depend on human subjectivity, and present grounds of estimation. The operator can determine an inspection order of the facility with less effort.

Further, the anomaly factor estimating device 100 detects the anomaly detection sensor using a univariate type anomaly detecting method such as the Hotelling's theory or Discord.

Therefore, the anomaly factor estimating device 100 can more appropriately detect an anomaly in which one piece of sensor data D1 changes alone. The anomaly in which one piece of sensor data D1 changes alone is, for example, an anomaly detected in the sensor data D1 collected alone by one sensor 300 that is not related to another sensor 300.

Further, the anomaly factor estimating device 100 detects the anomaly detection sensor using a multivariate type anomaly detecting method such as Graphical Lasso.

Therefore, the anomaly factor estimating device 100 can more appropriately detect an anomaly in which the relationship among the plurality of pieces of sensor data D1 changes. The anomaly in which the relationship between the plurality of pieces of sensor data D1 changes is, for example, an anomaly that has occurred in the sensor data D1 collected by the sensor 300 provided in the upstream device and an anomaly that also appears in the sensor data D1 collected by the sensor 300 provided in the downstream device when two facility components, here, devices, are in a control relationship. For example, when an anomaly occurs in a valve opening degree detected by a valve that controls a certain flow rate, an anomaly also occurs in a flow rate measured by a flow meter that measures the flow rate.

Next, an operation of the learning device 200 according to the first embodiment will be described.

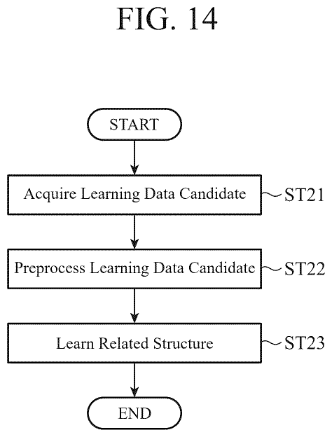

FIG. 14 is a flowchart for describing the operation of the learning device 200 according to the first embodiment.

The learning sensor data acquiring unit 210 acquires the learning data candidate D21 used for learning of the related structure D2 (step ST21). Specifically, the learning sensor data acquiring unit 210 acquires learning data candidates including a plurality of pieces of time-series sensor data collected by a plurality of sensors provided in the target facility during the time of normal operation of the target facility.

The learning sensor data acquiring unit 210 causes the acquired learning data candidate to be stored in the learning data storage unit 220.

The learning preprocessing unit 230 acquires the learning data candidate D21 acquired by the learning sensor data acquiring unit 210 in step ST21 from the learning data storage unit 220, performs preprocessing on the learning data candidate D21, and acquires the learning data D23 (step ST22).

The learning preprocessing unit 230 causes the acquired learning data D23 to be stored in the learning data storage unit 220.

The related structure learning unit 240 acquires the learning data D23 output by the learning preprocessing unit 230 from the learning data storage unit 220 and learns the related structure D2 on the basis of the learning data D23 (step ST23).

After learning the related structure D2, the related structure learning unit 240 causes the learned related structure D2 to be stored in the data storage unit 20 of the anomaly factor estimating device 100.

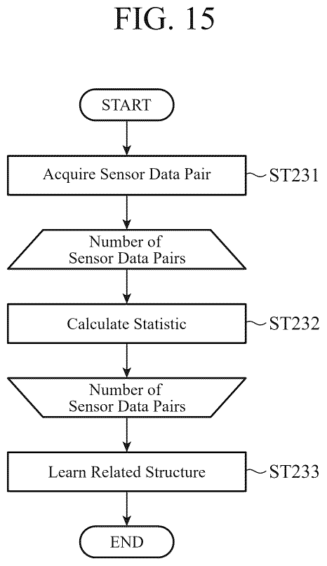

Here, FIG. 15 is a flowchart for describing details of the processing of step ST23 in FIG. 14.

The related structure learning unit 240 selects sensor data collected by two different sensors 300 from the sensor data included in the learning data D23 on the basis of the learning data D23 acquired by the learning preprocessing unit 230 in step ST22 in FIG. 14.

That is, the related structure learning unit 240 acquires a pair of two different pieces of sensor data on the basis of the learning data D23 (step ST231).

Note that the related structure learning unit 240 sets all combinations of a plurality of pieces of sensor data included in the learning data D23 as pairs of pieces of sensor data.

The related structure learning unit 240 extracts the pair of sensor data generated in step ST231 and calculates at least one statistic between two different pieces of sensor data (step ST232).

The related structure learning unit 240 calculates statistics for all two different pieces of sensor data and acquires the inter-sensor statistic information D24A.

Then, the related structure learning unit 240 learns the related structure D2 by using the statistic corresponding to all the pairs of sensor data set in the inter-sensor statistic information D24A as an element (step ST233).

Note that, in a case where the learning device 200 does not include the learning preprocessing unit 230, the learning device 200 can omit the processing of step ST22 in the operation of the learning device 200 illustrated in the flowchart of FIG. 14.

As described above, the learning device 200 acquires the plurality of pieces of time-series sensor data collected by the plurality of sensors 300 provided in the target facility during the time of normal operation of the target facility as the learning data candidates, and acquires the plurality of pieces of learning data used for learning on the basis of the plurality of learning data candidates. The learning device 200 calculates at least one statistic among the plurality of pieces of sensor data included in the learning data on the basis of the acquired learning data, and learns the estimated structure (related structure D2) on the basis of the calculated statistic.

For example, comprehensiveness of the related structure given manually depends on a connection relationship of facility components grasped by a person, in other words, the sensor 300. On the other hand, the learning device 200 can comprehensively extract relevance between the sensor data D1, and as a result, can provide the related structure D2 in which overlooking of the connection relationship of the sensor 300 is suppressed. The learning device 200 can cause the anomaly factor estimating device 100 to more appropriately track the sensor 300 that is the generation source of the anomaly and improve the estimation accuracy of the factor of the anomaly by providing the estimated structure (related structure) when tracking the sensor 300 that is the generation source of the anomaly to the anomaly factor estimating device 100.

Furthermore, even if a related structure including only qualitative information such as connection information is given manually, the learning device 200 can quantitatively obtain the magnitude of relevance or the direction of influence between pieces of the sensor data D1, and can generate and provide an estimated structure (related structure) capable of more appropriately estimating the factor of the anomaly.

Further, the learning device 200 calculates the statistic using a waveform based statistical index such as correlation, Granger Causality, or DTW.

Therefore, the learning device 200 can track the anomaly propagation based on the dependence relationship of being similar in waveform, and can provide the estimated structure (related structure D2) that can more appropriately estimate the factor of the anomaly.

Further, the learning device 200 calculates a statistic by using a distribution-based statistical index such as KL divergence or HI.

Therefore, the learning device 200 can track the anomaly propagation based on the dependence relationship of being similar in distribution, and can provide the estimated structure (related structure D2) that can more appropriately estimate the anomaly factor.

Further, the learning device 200 calculates the statistic using the waveform based statistical index and the distribution based statistical index.

Therefore, the learning device 200 can track the anomaly propagation based on the dependence relationship of being similar in waveform or distribution, and can provide the estimated structure (related structure D2) that can more appropriately estimate the anomaly factor.

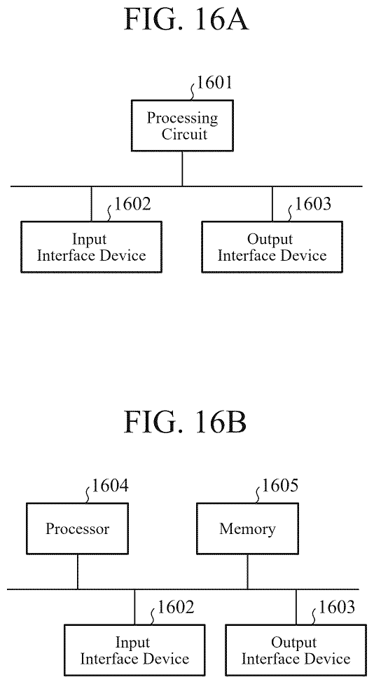

FIGS. 16A and 16B are diagrams illustrating an example of a hardware configuration of the anomaly factor estimating device 100 according to the first embodiment.

In the first embodiment, functions of the sensor data acquiring unit 10, the anomaly detecting unit 30, the anomaly detection order estimating unit 40, the anomaly propagation path tracking unit 50, the anomaly factor estimating unit 60, the anomaly factor estimation result output unit 70, and the control unit, not illustrated, are implemented by the processing circuit 1601. That is, the anomaly factor estimating device 100 includes the processing circuit 1601 for estimating a factor of the anomaly that has occurred in the target facility using the estimated structure (related structure D2) in which the dependence relationship between the plurality of facility components constituting the target facility is indicated.

The processing circuit 1601 may be dedicated hardware as illustrated in FIG. 16A or a processor 1604 that executes a program stored in a memory as illustrated in FIG. 16B.

In a case where the processing circuit 1601 is dedicated hardware, the processing circuit 1601 corresponds to, for example, a single circuit, a composite circuit, a programmed processor, a parallel programmed processor, an application specific integrated circuit (ASIC), a field-programmable gate array (FPGA), or a combination thereof.

When the processing circuit is the processor 1604, the functions of the sensor data acquiring unit 10, the anomaly detecting unit 30, the anomaly detection order estimating unit 40, the anomaly propagation path tracking unit 50, the anomaly factor estimating unit 60, the anomaly factor estimation result output unit 70, and the control unit, not illustrated, are implemented by software, firmware, or a combination of software and firmware. The software or firmware is described as a program and stored in a memory 1605. The processor 1604 reads and executes the program stored in the memory 1605, thereby executing the functions of the sensor data acquiring unit 10, the anomaly detecting unit 30, the anomaly detection order estimating unit 40, the anomaly propagation path tracking unit 50, the anomaly factor estimating unit 60, the anomaly factor estimation result output unit 70, and the control unit, not illustrated. That is, the anomaly factor estimating device 100 includes the memory 1605 for storing programs that, when executed by the processor 1604, result in execution of steps ST1 to ST6 of FIG. 13 described above. It can also be said that the program stored in the memory 1605 causes a computer to execute a processing procedures or methods performed by the sensor data acquiring unit 10, the anomaly detecting unit 30, the anomaly detection order estimating unit 40, the anomaly propagation path tracking unit 50, the anomaly factor estimating unit 60, the anomaly factor estimation result output unit 70, and the control unit, not illustrated. Here, the memory 1605 corresponds to, for example, a nonvolatile or volatile semiconductor memory such as a RAM, a read only memory (ROM), a flash memory, an erasable programmable read only memory (EPROM), an electrically erasable programmable read-only memory (EEPROM) (registered trademark, omitted below), or a magnetic disk, a flexible disk, an optical disk, a compact disk, a mini disk, a digital versatile disc (DVD), or the like.

In addition, the functions of the sensor data acquiring unit 10, the anomaly detecting unit 30, the anomaly detection order estimating unit 40, the anomaly propagation path tracking unit 50, the anomaly factor estimating unit 60, the anomaly factor estimation result output unit 70, and the control unit, not illustrated, may be partially implemented by dedicated hardware, and partially implemented by software or firmware. For example, the functions of the sensor data acquiring unit 10 and the anomaly factor estimation result output unit 70 can be implemented by the processing circuit 1601 as dedicated hardware, and the functions of the anomaly detection order estimating unit 40, the anomaly propagation path tracking unit 50, the anomaly factor estimating unit 60, and the control unit, not illustrated, can be implemented by the processor 1604 reading and executing a program stored in the memory 1605.

The data storage unit 20 includes an auxiliary storage device (not illustrated).

In addition, the anomaly factor estimating device 100 includes an input interface device 1602 and an output interface device 1603 that perform wired communication or wireless communication with a device such as the sensor 300 or the display device 400.

A hardware configuration example of the learning device 200 according to the first embodiment is also as illustrated in FIGS. 16A and 16B.

In the first embodiment, the functions of the learning sensor data acquiring unit 210, the learning preprocessing unit 230, and the related structure learning unit 240 are implemented by the processing circuit 1601. That is, the learning device 200 includes the processing circuit 1601 for performing control to learn the estimated structure (related structure D2) indicating the dependence relationship among the plurality of facility components constituting the target facility on the basis of the plurality of pieces of time-series sensor data collected by the plurality of sensors 300 provided in the target facility during the time of normal operation of the target facility.

The processing circuit 1601 may be dedicated hardware as illustrated in FIG. 16A or a processor 1604 that executes a program stored in a memory as illustrated in FIG. 16B.

In a case where the processing circuit 1601 is dedicated hardware, the processing circuit 1601 corresponds to, for example, a single circuit, a composite circuit, a programmed processor, a parallel programmed processor, an application specific integrated circuit (ASIC), a field-programmable gate array (FPGA), or a combination thereof.

When the processing circuit is the processor 1604, the functions of the learning sensor data acquiring unit 210, the learning preprocessing unit 230, and the related structure learning unit 240 are implemented by software, firmware, or a combination of software and firmware. The software or firmware is described as a program and stored in a memory 1605. The processor 1604 executes the functions of the learning sensor data acquiring unit 210, the learning preprocessing unit 230, and the related structure learning unit 240 by reading and executing the program stored in the memory 1605. That is, the learning device 200 includes the memory 1605 for storing a program that results in execution of steps ST21 to ST23 of FIG. 14 described above when executed by the processor 1604. Further, it can also be said that the program stored in the memory 1605 causes a computer to execute a processing procedures or methods performed by the learning sensor data acquiring unit 210, the learning preprocessing unit 230, and the related structure learning unit 240. Here, the memory 1605 corresponds to a nonvolatile or volatile semiconductor memory such as a RAM, a read only memory (ROM), a flash memory, an erasable programmable read only memory (EPROM), or an electrically erasable programmable read-only memory (EEPROM), or a magnetic disk, a flexible disk, an optical disk, a compact disk, a mini disk, a digital versatile disc (DVD), or the like.

In addition, the functions of the learning sensor data acquiring unit 210, the learning preprocessing unit 230, and the related structure learning unit 240 may be partially implemented by dedicated hardware and partially implemented by software or firmware. For example, the functions of the learning sensor data acquiring unit 210 can be implemented by the processing circuit 1601 as dedicated hardware, and the functions of the learning preprocessing unit 230 and the related structure learning unit 240 can be implemented by the processor 1604 reading and executing programs stored in the memory 1605.

The learning data storage unit 220 includes an auxiliary storage device (not illustrated).

In addition, the learning device 200 includes an input interface device 1602 and an output interface device 1603 that perform wired communication or wireless communication with a device such as the anomaly factor estimating device 100.

In addition, in the first embodiment described above, for convenience, it is assumed that one sensor 300 is provided in one device, but this is merely an example, and a plurality of sensors 300 may be provided in one device. For example, in the first embodiment described above, the facility component is a plurality of components included in the device, and the sensor 300 may be provided in each component. In this case, the anomaly factor estimating device 100 presents information regarding the estimation result of the factor of the anomaly to the operator in a form in which, for example, a sensor provided in a component that is the factor of the anomaly or an order in which the operator needs to perform inspection can be grasped.

### <Modification>

In the first embodiment described above, the anomaly factor estimating device 100 and the learning device 200 each include the sensor data acquiring unit 10 and the learning sensor data acquiring unit 210, but this is merely an example. In the first embodiment described above, the anomaly factor estimating device 100 and the learning device 200 each include the data storage unit 20 and the learning data storage unit 220, but this is merely an example.

For example, the anomaly factor estimating device 100 and the learning device 200 may include a sensor data acquiring unit and a data storage unit that are common, and may be configured to access each other.

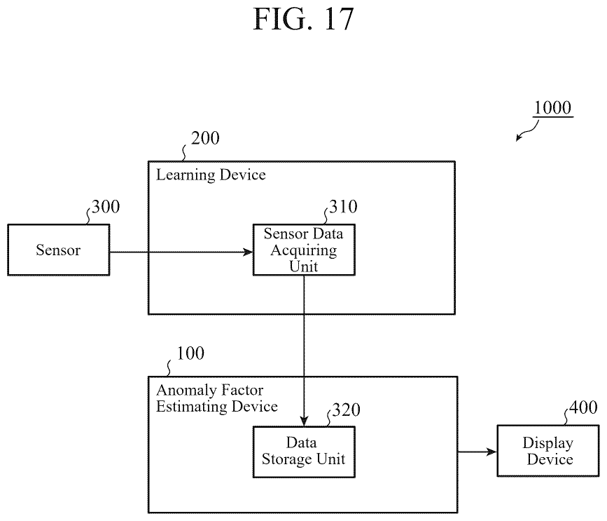

FIG. 17 is a diagram illustrating a configuration example of a precise diagnostic system 1000 in which the anomaly factor estimating device 100 and the learning device 200 include a sensor data acquiring unit 310 and a data storage unit 320 that are common in the first embodiment.

Further, although not illustrated in FIG. 17 for simplicity of description, the anomaly factor estimating device 100 includes the anomaly detecting unit 30, the anomaly detection order estimating unit 40, the anomaly propagation path tracking unit 50, the anomaly factor estimating unit 60, the anomaly factor estimation result output unit 70, and the control unit in addition to the data storage unit 320. In addition, the anomaly factor estimating device 100 does not necessarily include the anomaly factor estimation result output unit 70. Further, although not illustrated in FIG. 17 for simplicity of description, the learning device 200 includes the learning preprocessing unit 230 and the related structure learning unit 240 in addition to the sensor data acquiring unit 310.

In the configuration example of the precise diagnostic system 1000 illustrated in FIG. 17, although the anomaly factor estimating device 100 includes the data storage unit 320 and the learning device 200 includes the sensor data acquiring unit 310, this is merely an example, and in the precise diagnostic system 1000, the learning device 200 may include the data storage unit 320, and the anomaly factor estimating device 100 may include the sensor data acquiring unit 310.

In addition, the precise diagnostic system 1000 may include the sensor data acquiring unit 310 and the data storage unit 320 from either the anomaly factor estimating device 100 or the learning device 200.

### <Modification>

In the first embodiment described above, the anomaly factor estimating device 100 is configured to estimate a factor of the anomaly on the basis of one related structure D2, but this is merely an example.

For example, the anomaly factor estimating device 100 may be configured to estimate the factor of the anomaly on the basis of a related structure corresponding to the operation state of the target facility. In this case, the learning device 200 learns the related structure for each operation state of the target facility.

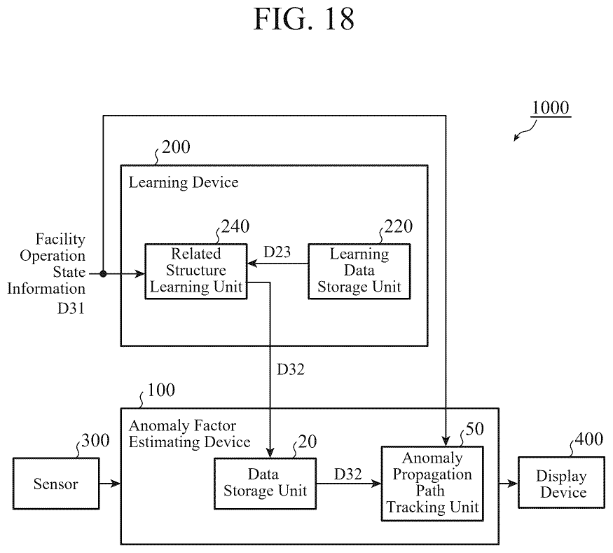

FIG. 18 is a diagram illustrating a configuration example of the precise diagnostic system 1000 in which, in the first embodiment, the learning device 200 learns the related structure for each operation state of the target facility, and the anomaly factor estimating device 100 estimates the factor of the anomaly on the basis of the related structure corresponding to the operation state of the target facility learned by the learning device 200.

Further, although not illustrated in FIG. 18 for simplicity of description, the anomaly factor estimating device 100 includes the sensor data acquiring unit 10, the anomaly detecting unit 30, the anomaly detection order estimating unit 40, the anomaly factor estimating unit 60, the anomaly factor estimation result output unit 70, and the control unit, in addition to the data storage unit 20 and the anomaly propagation path tracking unit 50. In addition, the anomaly factor estimating device 100 does not necessarily include the anomaly factor estimation result output unit 70. Further, although not illustrated in FIG. 18 for simplicity of description, the learning device 200 includes the learning sensor data acquiring unit 210 and the learning preprocessing unit 230 in addition to the learning data storage unit 220 and the related structure learning unit 240.

As illustrated in FIG. 18, in the learning device 200, the related structure learning unit 240 acquires the facility operation state information D31 indicating the operation state of the target facility corresponding to the learning data candidate D21. The operator or the like operates the input device such as a mouse or a keyboard to input the facility operation state information D31, and the related structure learning unit 240 acquires the facility operation state information D31 by receiving the input facility operation state information D31. For example, the related structure learning unit 240 may acquire the facility operation state information D31 by acquiring a control signal or the like in the target facility and estimating the operation state from the acquired control signal or the like.

Then, upon learning the related structure D2 on the basis of the learning data D23 output from the learning preprocessing unit 230, the related structure learning unit 240 assigns the acquired facility operation state information D31 to the learned related structure D2 to obtain the related structure D32. The related structure learning unit 240 causes the related structure D32 to which the facility operation state information D31 has been assigned to be stored in the data storage unit 20 of the anomaly factor estimating device 100. The related structure learning unit 240 may cause the related structure D32 to be stored in the learning data storage unit 220.

The learning device 200 performs learning as described above depending on various operation states of the target facility, and learns the related structure D32 corresponding to various operation states.

Further, in this case, in the operation of the learning device 200 described with reference to the flowchart of FIG. 14, the related structure learning unit 240 acquires the facility operation state information D31 before the processing of step ST23 is performed, and performs processing of generating and storing the related structure D32 in step ST23. The learning device 200 repeats the operation as illustrated in the flowchart of FIG. 14 depending on the operation state of the target facility.

In the anomaly factor estimating device 100, the anomaly propagation path tracking unit 50 acquires the facility operation state information D31. Then, when performing the anomaly propagation order estimation processing, the anomaly propagation path tracking unit 50 estimates the anomaly propagation order on the basis of the acquired anomaly detection sensor information D3, the facility operation state information D31, and the related structure D32 caused to be stored in the data storage unit 20 by the learning device 200. Specifically, the anomaly propagation path tracking unit 50 selects the related structure D32 corresponding to the operation state of the target facility, and estimates the anomaly propagation order using the selected related structure D32.

For example, in the learning device 200, the related structure learning unit 240 may cause the related structure D32 to be stored in the learning data storage unit 220, and in the anomaly factor estimating device 100, the anomaly propagation path tracking unit 50 may download the related structure D32 to be used from the learning data storage unit 220 to the data storage unit 20 every time the anomaly propagation order estimation processing is executed.

Further, in this case, in the operation of the anomaly factor estimating device 100 described with reference to the flowchart of FIG. 13, in step ST4, the anomaly propagation path tracking unit 50 estimates the anomaly propagation order on the basis of the anomaly detection sensor information D3, the facility operation state information D31, and the related structure D32 caused to be stored in the data storage unit 20 by the learning device 200.

As described above, in the anomaly factor estimating device 100, the anomaly propagation path tracking unit 50 can be configured to estimate the anomaly propagation order on the basis of the anomaly detection sensor information D3, the facility operation state information D31 indicating the operation state of the target facility, and the estimated structure (related structure D32) indicating the dependence relationship among a plurality of target components constituting the target facility depending on the operation state of the target facility.

With such a configuration, the anomaly factor estimating device 100 can cope with a change in the dependence relationship between the sensors 300 due to the operation state change in the target facility, and can precisely estimate the factor of the anomaly on the basis of the related structure D32 with improved reliability.

When the related structure learning unit 240 calculates at least one statistic among the plurality of sensor data on the basis of the learning data and learns the estimated structure (related structure D2) on the basis of the calculated statistic, the learning device 200 generates the related structure D32 in which the facility operation state information D31 is added to the related structure D2, so that the reliability of the related structure provided to the anomaly factor estimating device 100 is improved, and the related structure D32 capable of accurately estimating the factor of the anomaly can be provided to the anomaly factor estimating device 100.

### <Modification>

In the first embodiment described above, the anomaly factor estimating device 100 includes the data storage unit 20, but this is merely an example.

For example, a single or a plurality of network storage devices (not illustrated) arranged on a communication network may store various data, and in the anomaly factor estimating device 100, the anomaly detecting unit 30, the anomaly detection order estimating unit 40, the anomaly propagation path tracking unit 50, the anomaly factor estimating unit 60, and the anomaly factor estimation result output unit 70 may access the network storage device.

### <Modification>

In the first embodiment described above, in the anomaly factor estimating device 100, the anomaly detecting unit 30 performs the anomaly detection processing using the known univariate type anomaly detecting method on the sensor data D1 to detect the anomaly detection sensor among the sensors 300, but this is merely an example.

For example, the anomaly detecting unit 30 may detect the anomaly detection sensor using a known multivariate type anomaly detecting method. For example, as a known multivariate type anomaly detecting method, there is a method such as Graphical Lasso. For example, the anomaly detecting unit 30 may perform the anomaly detection processing using both the univariate type anomaly detecting method and the multivariate type anomaly detecting method.

As described above, the anomaly factor estimating device 100 detects the anomaly detection sensor by using the univariate type anomaly detecting method, the multivariate type anomaly detecting method, or both of the methods, so that the anomaly detection sensor in which occurrence of various types of anomaly has been detected can be appropriately detected even when how the anomaly appears in the sensor data differs depending on the type of anomaly occurring in the target facility, and estimation of the factor of the anomaly can be accurately performed.

### <Modification>

In the first embodiment described above, the anomaly factor estimating device 100 may include a related structure correcting unit 330 that corrects the related structure D2 stored in the data storage unit 20.

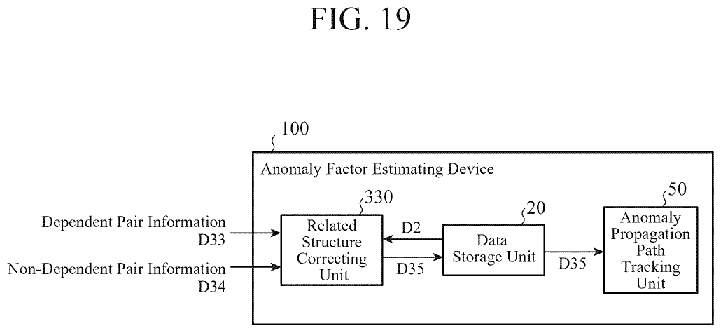

FIG. 19 is a diagram illustrating a configuration example of the anomaly factor estimating device 100 including the related structure correcting unit 330 in the first embodiment.

Further, although not illustrated in FIG. 19 for simplicity of description, the anomaly factor estimating device 100 includes the sensor data acquiring unit 10, the anomaly detecting unit 30, the anomaly detection order estimating unit 40, the anomaly factor estimating unit 60, the anomaly factor estimation result output unit 70, and the control unit, in addition to the related structure correcting unit 330, the data storage unit 20, and the anomaly propagation path tracking unit 50. In addition, the anomaly factor estimating device 100 does not necessarily include the anomaly factor estimation result output unit 70. Further, although not illustrated in FIG. 19 for simplicity of description, the anomaly factor estimating device 100 is connected to the learning device 200, the sensor 300, and the display device 400.

The related structure correcting unit 330 acquires information (hereinafter referred to as “dependent pair information”) D33 regarding a sensor pair having a dependence relationship and information (hereinafter referred to as “non-dependent pair information”) D34 regarding a sensor pair having no dependence relationship. The dependent pair information D33 and the non-dependent pair information D34, for example, may be manually generated by the operator on the basis of know-how of the operator, or may be generated from information indicating a physical connection relationship such as design information of the facility by the related structure correcting unit 330. For example, the dependent pair information D33 and the non-dependent pair information D34 may be generated by combining manual generation based on know-how of the operator and generation based on information indicating a physical connection relationship such as design information of facility by the related structure correcting unit 330.

The related structure correcting unit 330 acquires the related structure D2 from the data storage unit 20, corrects the dependence relationship among the pieces of sensor data for the related structure D2 on the basis of the dependent pair information D33 and the non-dependent pair information D34, and causes the corrected related structure D35 to be stored in the data storage unit 20. Further, the related structure D35 after the correction has the same data structure as the related structure D2.

In a case where the corrected related structure D35 is stored in the data storage unit 20, the anomaly propagation path tracking unit 50 performs the anomaly propagation order estimation processing using the related structure D35.

Details of the processing of correcting the related structure D2 by the related structure correcting unit 330 will be described with a specific example.

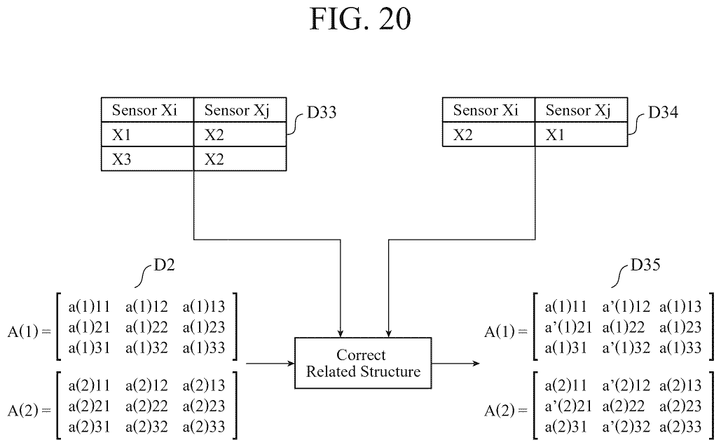

FIG. 20 is a diagram for describing a concept of an example of processing in which the related structure correcting unit 330 corrects the related structure D2 in the anomaly factor estimating device 100 including the related structure correcting unit 330 in the first embodiment.

Here, as an example, the quantity of sensors 300 is set to three, and the sensor 300 is represented by a sensor Xn (n=1, 2, 3). Further, the dependent pair information D33 defines that there is a dependence relationship from the i-th sensor Xi to the j-th sensor Xj among the sensors Xn, and the non-dependent pair information D34 defines that there is no dependence relationship from the i-th sensor Xi to the j-th sensor Xj among the sensors Xn. i and j are each 1, 2, or 3.

Now, for example, it is assumed that there is a dependence relationship between pieces of sensor data from the sensor X1 to the sensor X2 and from the sensor X3 to the sensor X2 among the sensors X1, X2, and X3, and there is no dependence relationship between sensor data from the sensor X2 to the sensor X1.

The related structure D2 is assumed to be a three-dimensional array in which the first dimension is a statistical index, the second dimension is the quantity of sensors Xn, and the third dimension is the quantity of sensors Xn. The number of types of statistical indexes is two.

The related structure correcting unit 330 corrects the statistic a(k)ij of the related structure D2 to a statistic a′(k)ij on the basis of the dependent pair information D33 and the non-dependent pair information D34. Here, the statistic a(k)ij and the statistic a′(k)ij are real numbers. For example, the related structure correcting unit 330 corrects the statistic a(k)ij of the related structure D2 corresponding to the pair of sensors Xi and Xj included in the dependent pair information D33 to a statistic a′(k)ij larger than an upper limit value of the statistic indicating that there is a dependence relationship for each statistical index. In addition, this is merely an example, and for example, the related structure correcting unit 330 may correct the statistic a(k)ij of the related structure D2 corresponding to the pair of sensors Xi and Xj included in the dependent pair information D33 to a statistic a′(k)ij larger than a threshold provided for selection of the dependence relationship.

In FIG. 20, the related structure correcting unit 330 corrects the statistics a(1)12 and a(2)12 corresponding to the sensor data from the sensor X1 to the sensor X2 having a dependence relationship to statistics a′(1)12 and a′(2)12 which are upper limit values of the statistical index, respectively, on the basis of the dependent pair information D33. Further, the related structure correcting unit 330 corrects the statistics a(1)32 and a(2)32 corresponding to the sensor data from the sensor X3 to the sensor X2 having a dependence relationship to statistics a′(1)32 and a′(2)32 which are upper limit values of the statistical index, respectively, on the basis of the dependent pair information D33.

Further, the related structure correcting unit 330 corrects the statistic a(k)ij of the related structure D2 corresponding to the pair of sensors Xi and Xj included in the non-dependent pair information D34 to the statistic a′(k)ij indicating that there is no dependence relationship for each statistical index.

In FIG. 20, the related structure correcting unit 330 corrects the statistics a(1)21 and a(2)21 corresponding to the sensor data from the sensor X2 to the sensor X1 having no dependence relationship to statistics a′(1)21 and a′(2)21 indicating that there is no dependence relationship on the basis of the non-dependent pair information D34.

As illustrated in FIG. 19, in a case where the anomaly factor estimating device 100 includes the related structure correcting unit 330, in the operation of the anomaly factor estimating device 100 described with reference to the flowchart of FIG. 13, the related structure correcting unit 330 corrects the dependence relationship among the pieces of sensor data for the related structure D2 on the basis of the dependent pair information D33 and the non-dependent pair information D34 and causes the corrected related structure D35 to be stored in the data storage unit 20 until the processing of step ST4 is performed. In step ST4, the anomaly propagation path tracking unit 50 estimates an anomaly propagation order on the basis of the anomaly detection sensor information D3, the facility operation state information D31, and the related structure D35 corrected by the related structure correcting unit 330.

As described above, the anomaly factor estimating device 100 includes the related structure correcting unit 330 that corrects the dependence relationship among the pieces of sensor data for the related structure D2 (estimated structure) on the basis of the dependent pair information D33 related to the pair of sensors 300 having a dependence relationship among the sensors 300 and the non-dependent pair information D34 related to the pair of sensors 300 having no dependence relationship, so that it is possible to improve the reliability of the related structure D2 and precisely estimate the factor of the anomaly.

### <Modification>

In the first embodiment described above, the anomaly factor estimating device 100 may include the relationship change estimating unit 340 that estimates a change in a relationship among the pieces of sensor data by comparing the learned related structure D2 with the related structure D36 at the time of occurrence of an anomaly. The change in a relationship among the pieces of sensor data assumes, for example, a collapse of the relationship among the pieces of sensor data. The relationship change estimating unit 340 estimates a point where there is a large collapse of the relationship among the pieces of sensor data in the element of the related structure D2 as a point where there has been a change in the relationship among the pieces of sensor data.

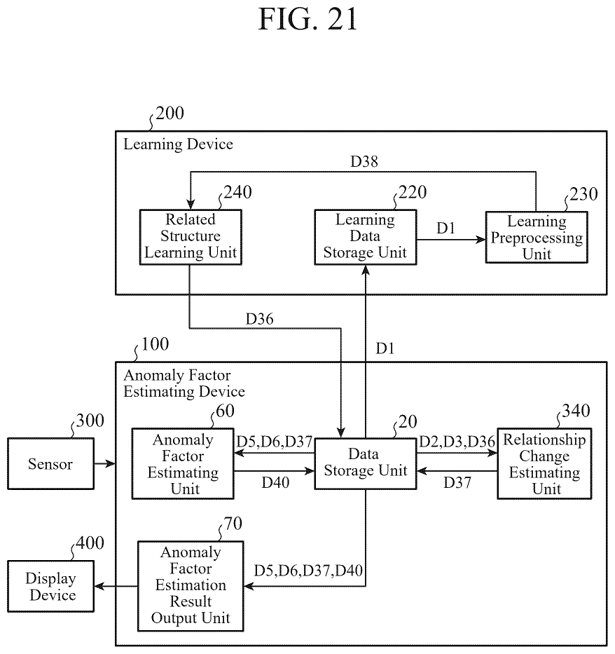

FIG. 21 is a diagram illustrating a configuration example of the anomaly factor estimating device 100 including the relationship change estimating unit 340 in the first embodiment.

Further, although not illustrated in FIG. 21 for simplicity of description, the anomaly factor estimating device 100 includes the sensor data acquiring unit 10, the anomaly detecting unit 30, the anomaly detection order estimating unit 40, the anomaly propagation path tracking unit 50, and the control unit in addition to the relationship change estimating unit 340, the data storage unit 20, the anomaly factor estimating unit 60, and the anomaly factor estimation result output unit 70. In addition, the anomaly factor estimating device 100 does not necessarily include the anomaly factor estimation result output unit 70. Further, although not illustrated in FIG. 21 for simplicity of description, the learning device 200 includes the learning sensor data acquiring unit 210 in addition to the learning data storage unit 220, the learning preprocessing unit 230, and the related structure learning unit 240.

The relationship change estimating unit 340 acquires the related structure D2, the related structure D36 at the time of an anomaly, and the anomaly detection sensor information D3 from the data storage unit 20. Then, the relationship change estimating unit 340 compares the related structure D2 and the related structure D36 on the basis of the related structure D2, the related structure D36, and the anomaly detection sensor information D3, and performs relationship change order estimation processing of estimating an order (hereinafter referred to as a “relationship change order”) of changes in the relationship among the pieces of sensor data.

The related structure D36 at the time of the anomaly is acquired through the following processing. In the learning device 200, the learning sensor data acquiring unit 210 acquires the sensor data D1 at the time of occurrence of the anomaly (including the period in which the anomaly is detected) from the data storage unit 20 of the anomaly factor estimating device 100, and causes the sensor data D1 to be stored in the learning data storage unit 220. The learning preprocessing unit 230 acquires the sensor data D1 at the time of occurrence of the anomaly from the learning data storage unit 220, performs preprocessing on the acquired sensor data D1 at the time of occurrence of the anomaly, and outputs the sensor data D38 at the time of occurrence of the anomaly after the preprocessing to the related structure learning unit 240. In addition, the learning preprocessing unit 230 may output the sensor data D38 at the time of occurrence of the anomaly after preprocessing to the related structure learning unit 240 via the learning data storage unit 220. The related structure learning unit 240 learns the related structure D36 at the time of the anomaly on the basis of the sensor data D38 at the time of occurrence of the anomaly after preprocessing output from the learning preprocessing unit 230. The related structure learning unit 240 only needs to learn the related structure D36 in a manner similar to that of learning the related structure D2. The related structure learning unit 240 learns the related structure D36 at the time of the anomaly for the sensor data D1 at the time of occurrence of the anomaly.

The related structure learning unit 240 causes the learned related structure D36 at the time of the anomaly to be stored in the data storage unit 20 of the anomaly factor estimating device 100.

Details of the relationship change order estimation processing by the relationship change estimating unit 340 will be described.

First, the relationship change estimating unit 340 acquires the related structure D2 and the related structure D36 at the time of the anomaly from the data storage unit 20, and acquires, from the related structure D2 and the related structure D36 at the time of the anomaly, a related structure (hereinafter referred to as a “relationship change estimation related structure”) and a related structure at the time of the anomaly (hereinafter referred to as a “relationship change estimation abnormal-time related structure”) which are related structures corresponding to one type of undirected statistical index selected for estimating a relationship change. Here, the relationship change estimation related structure and the relationship change estimation abnormal-time related structure are two-dimensional matrices A(k) and A′(k) obtained by extracting only a portion corresponding to the k-th statistical index from each of the related structure D2 and the related structure D36 at the time of the anomaly. The relationship change estimating unit 340 selects a statistical index meaningful to comparison of statistics as the statistical index to be extracted. For example, the relationship change estimating unit 340 determines that the statistical index calculated on the basis of the p value of hypothesis testing is not a statistical index meaningful to comparison of statistics, and selects other statistical indices as statistical indices meaningful to comparison of the statistics. The relationship change estimating unit 340 can estimate a relationship collapse, in other words, a relationship change, by comparing the statistic corresponding to the correlation, that is, the magnitude relationship of the correlation coefficient.

Subsequently, the relationship change estimating unit 340 calculates a change amount d(k)ij on the basis of the acquired element a(k)ij of the relationship change estimation related structure and element a′(k)ij of the relationship change estimation abnormal-time related structure. Then, the relationship change estimating unit 340 generates a related structure change amount which is information including the calculated change amount d(k)ij as an element and in which the change amount d(k)ij is indicated by a matrix.

Here, both the elements a(k)ij and a′(k)ij and the change amount d(k)ij are real numbers. The relationship change estimating unit 340 may calculate the change amount d(k)ij, which is an element of the related structure change amount, using, for example, an absolute value of a difference between an absolute value of the element a(k)ij of the relationship change estimation related structure and an absolute value of the element a′(k)ij of the relationship change estimation abnormal-time related structure, or may calculate the change amount d(k)ij using an absolute value of a difference between the element a(k)ij of the relationship change estimation related structure and the element a′(k)ij of the relationship change estimation abnormal-time related structure.

Next, the relationship change estimating unit 340 acquires the anomaly detection sensor information D3 from the data storage unit 20, and calculates a relationship change degree for each sensor 300, more specifically, each anomaly detection sensor, on the basis of the change amount d(k)ij, which is an element of the calculated related structure change amount, and the anomaly detection sensor information D3.

Here, both the change amount d(k)ij and the relationship change degree are real numbers. For example, the relationship change estimating unit 340 calculates the relationship change degree corresponding to the anomaly detection sensor Xi, which is the i-th sensor 300 among n sensors 300, by using an average of elements other than the i-th column and corresponding to the sensor 300 (that is, the anomaly detection sensor) included in the anomaly detection sensor information D3 in the i-th row of the related structure change amount. In addition, this is merely an example, and the relationship change estimating unit 340 may calculate, for example, the relationship change degree corresponding to the anomaly detection sensor Xi, which is the i-th sensor 300 among the n sensors 300, by using an average of elements other than the i-th column in the i-th row of the related structure change amount.

Subsequently, the relationship change estimating unit 340 assigns the relationship change order corresponding to the anomaly detection sensor on the basis of the calculated relationship change degree corresponding to the anomaly detection sensor. Here, both the relationship change degree and the relationship change order are real numbers. The relationship change estimating unit 340 assigns the relationship change order in such a manner that, for example, the corresponding relationship change order is in ascending order from the anomaly detection sensor with the largest value of the relationship change degree. In addition, when the relationship change degrees corresponding to the plurality of anomaly detection sensors are equal, the relationship change estimating unit 340 assigns the same relationship change order to the plurality of anomaly detection sensors.

After assigning the relationship change order, the relationship change estimating unit 340 generates a relationship change order estimation result D37. The relationship change order estimation result is information in which the information indicating the anomaly detection sensor, the relationship change degree, and the relationship change order are associated with each other.

The relationship change estimating unit 340 causes the relationship change order estimation result D37 to be stored in the data storage unit 20.

The relationship change order estimation processing by the relationship change estimating unit 340 as described above will be described with specific examples with reference to the drawings.

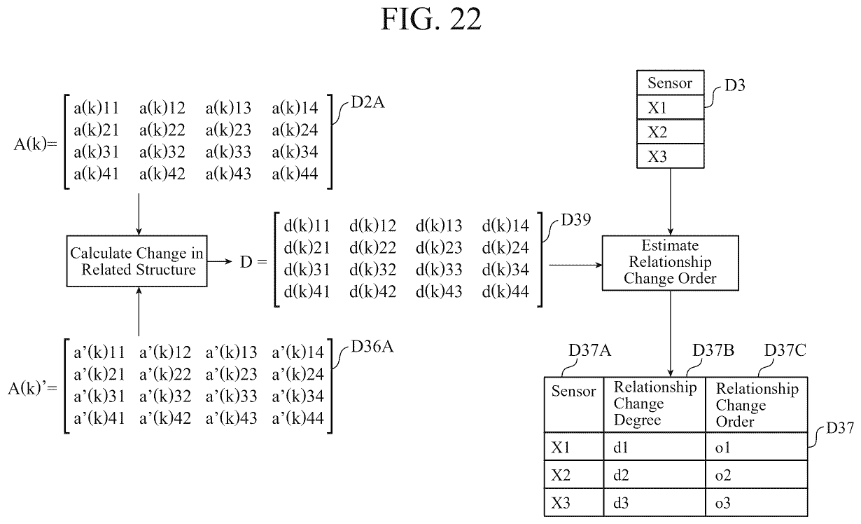

FIG. 22 is a diagram for describing a concept of an example of the relationship change order estimation processing performed by the relationship change estimating unit 340 on the basis of the learned related structure D2 and the related structure D36 at the time of an anomaly in a case where the anomaly factor estimating device 100 according to the first embodiment includes the relationship change estimating unit 340.

Here, as an example, the quantity of sensors 300 is set to four, and the sensor 300 is represented by a sensor Xn (n=1, 2, 3, 4). Further, as an example, it is assumed that the sensors X1, X2, and X3 among the sensors X1, X2, X3, and X4 are anomaly detection sensors.

First, the relationship change estimating unit 340 acquires the related structure D2 and the related structure D36 at the time of an anomaly from the data storage unit 20, and acquires a relationship change estimation related structure D2A and a relationship change estimation abnormal-time related structure D36A from the related structure D2 and the related structure D36 at the time of the anomaly. Note that, in FIG. 22, the related structure D2 and the related structure D36 at the time of the anomaly are not illustrated.

In FIG. 22, the relationship change estimation related structure D2A is illustrated as a two-dimensional matrix obtained by extracting only a portion corresponding to the k-th statistical index from the related structure D2. The relationship change estimation related structure D2A is represented by a two-dimensional matrix in which the first dimension is the quantity four of the sensors Xn and the second dimension is the quantity four of the sensors Xn. The statistical index is an undirected statistical index, and the type of the statistical index is a correlation. Further, as illustrated in FIG. 22, the relationship change estimation abnormal-time related structure D36A and the related structure change amount D39 have the same data structure as the relationship change estimation related structure D2A.

In FIG. 22, as an example, the change amount d(k)ij, which is an element of the related structure change amount D39, is an absolute value with respect to a difference between the absolute value of the element a(k)ij of the relationship change estimation related structure D2A and the absolute value of the element a′(k)ij of the relationship change estimation abnormal-time related structure D36A. For example, the relationship change estimating unit 340 calculates the change amount between the sensor X1 and the sensor X2 as ∥a(k)12|−|a′(k)12∥=d(k)12 on the basis of the element a(k)12 in the first row and the second column of the relationship change estimation related structure D2A and the element a′(k)12 in the first row and the second column of the relationship change estimation abnormal-time related structure D36A. Here, |⋅| represents an absolute value.

In addition, in FIG. 22, as an example, it is assumed that the relationship change estimating unit 340 calculates the relationship change degree dn corresponding to the anomaly detection sensor Xn by using the average of the elements other than the nth column and corresponding to the sensor 300 (that is, the anomaly detection sensor) included in the anomaly detection sensor information D3 in the nth row of the related structure change amount D39. Thus, for example, the relationship change estimating unit 340 sets the relationship change degree d1 corresponding to the anomaly detection sensor X1 as an average of the elements d(k)nn (where n=1, 2, 3) corresponding to the anomaly detection sensors X1, X2, and X3 and other than the first column in the first row of the related structure change amount D39. Specifically, the relationship change estimating unit 340 calculates the relationship change degree d1 of the anomaly detection sensor X1 as an average of the change amount d(k)12 that is an element in the first row and the second column and the change amount d(k)13 that is an element in the first row and the third column of the related structure change amount D39 corresponding to the anomaly detection sensors X2 and X3. Similarly, the relationship change estimating unit 340 calculates relationship change degrees d2 and d3 corresponding to the sensors X2 and X3, respectively. The relationship change estimating unit 340 assigns the corresponding relationship change orders o1, o2, and o3 to the sensors X1, X2, and X3 on the basis of the calculated relationship change degrees d1, d2, and d3, respectively.

Then, the relationship change estimating unit 340 causes the relationship change order estimation result D37 to be stored in the data storage unit 20.

The anomaly factor estimating unit 60 acquires the anomaly detection order estimation result D5, the anomaly propagation order estimation result D6, and the relationship change order estimation result D37 from the data storage unit 20, and performs the anomaly factor estimation processing in consideration of the relationship change order on the basis of the anomaly detection order estimation result D5, the anomaly propagation order estimation result D6, and the relationship change order estimation result D37. Specifically, performing the anomaly factor estimation processing in consideration of the relationship change order on the basis of the anomaly detection order estimation result D5, the anomaly propagation order estimation result D6, and the relationship change order estimation result D37 means that the anomaly factor estimating unit 60 calculates a corresponding anomaly factor score from the anomaly detection order included in the anomaly detection order estimation result D5, the anomaly propagation order included in the anomaly propagation order estimation result D6, and the relationship change order included in the relationship change order estimation result D37, and estimates the anomaly factor order on the basis of the calculated anomaly factor score.

In addition, the anomaly factor estimating unit 60 only needs to calculate the anomaly factor score from the anomaly detection order, the anomaly propagation order, and the relationship change order by a method similar to the method of calculating the anomaly factor score from the anomaly detection order and the anomaly propagation order.

The anomaly factor estimating unit 60 causes an anomaly factor order estimation result D40 in consideration of the relationship change order to be stored in the data storage unit 20.

The anomaly factor estimation result output unit 70 acquires the anomaly factor order estimation result D40, the anomaly detection order estimation result D5, the anomaly propagation order estimation result D6, and the relationship change order estimation result D37 from the data storage unit 20, and outputs information regarding the estimation result of the factor of the anomaly by the anomaly factor estimating unit 60. Specifically, on the basis of the anomaly factor order estimation result D40, the anomaly detection order estimation result D5, the anomaly propagation order estimation result D6, and the relationship change order estimation result D37, the anomaly factor estimation result output unit 70 outputs, to the display device 400, the anomaly factor estimation result display information for displaying the anomaly factor estimation result screen indicating information regarding the estimation result of the factor of the anomaly estimated by the anomaly factor estimating unit 60.

Further, in a case where the anomaly factor estimating device 100 includes the relationship change estimating unit 340 as illustrated in FIG. 21, in the operation of the anomaly factor estimating device 100 described with reference to the flowchart of FIG. 13, the relationship change estimating unit 340 estimates a change in a relationship among the pieces of sensor data until the processing of step ST5 is performed, and causes the relationship change order estimation result D37 to be stored in the data storage unit 20.

In step ST5, the anomaly factor estimating unit 60 acquires the anomaly detection order estimation result D5, the anomaly propagation order estimation result D6, and the relationship change order estimation result D37 from the data storage unit 20, and performs the anomaly factor estimation processing in consideration of the relationship change order on the basis of the anomaly detection order estimation result D5, the anomaly propagation order estimation result D6, and the relationship change order estimation result D37.

As described above, the anomaly factor estimating device 100 includes the relationship change estimating unit 340 that compares the related structure D2 (estimated structure) with the related structure D36 at the time of occurrence of the anomaly and estimates a change in a relationship among the pieces of sensor data on the basis of the related structure D2 (estimated structure), the related structure D36 at the time of occurrence of the anomaly, and the anomaly detection sensor information D3, and the anomaly factor estimating unit 60 is configured to estimate the factor of the anomaly in consideration of the change in the relationship among the pieces of sensor data estimated by the relationship change estimating unit 340 on the basis of the anomaly detection order estimated by the anomaly detection order estimating unit 40 and the anomaly propagation order estimated by the anomaly propagation path tracking unit 50, so that the reliability of the anomaly factor order estimation result D7 is improved and the anomaly factor can be estimated precisely. Since the anomaly factor estimating device 100 includes the relationship change estimating unit 340, a criterion for estimating an anomaly factor in the anomaly factor estimating device 100 is added.

### <Modification>

In the first embodiment described above, “to estimate the factor of the anomaly” by the anomaly factor estimating device 100 means that the anomaly factor score indicating the degree of likelihood of the generation source of the anomaly and the anomaly factor order based on the anomaly factor score are estimated in units of sensors 300, and the information regarding the anomaly factor score and the anomaly factor order is generated. Furthermore, “to estimate the factor of the anomaly” by the anomaly factor estimating device 100 may include estimating an anomaly factor score and an anomaly factor order based on the anomaly factor score in units of the device.

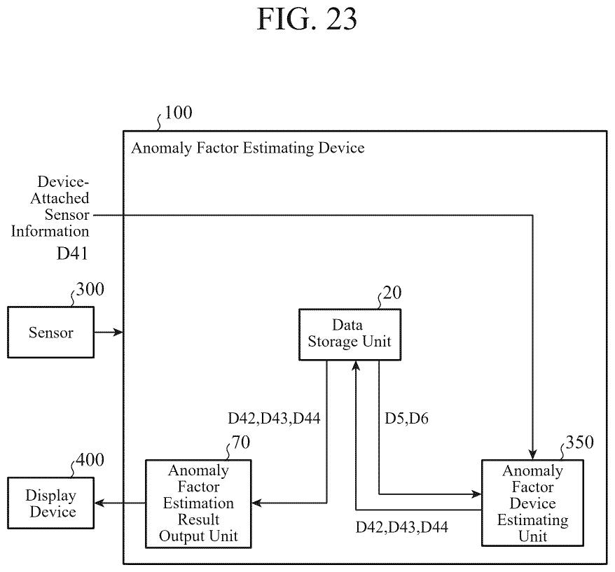

FIG. 23 is a diagram illustrating a configuration example of the anomaly factor estimating device 100 including an anomaly factor device estimating unit 350 and having a configuration for estimating an anomaly factor in units of the device in the first embodiment.

Further, although not illustrated in FIG. 23 for simplicity of description, the anomaly factor estimating device 100 includes the sensor data acquiring unit 10, the anomaly detecting unit 30, the anomaly detection order estimating unit 40, the anomaly propagation path tracking unit 50, the anomaly factor estimating unit 60, and the control unit, in addition to the anomaly factor device estimating unit 350, the data storage unit 20, and the anomaly factor estimation result output unit 70. In addition, the anomaly factor estimating device 100 does not necessarily include the anomaly factor estimation result output unit 70. Further, although not illustrated in FIG. 23 for simplicity of description, the anomaly factor estimating device 100 is connected to the learning device 200.

The anomaly factor device estimating unit 350 acquires a device-attached sensor information D41. Further, the anomaly factor device estimating unit 350 acquires the anomaly detection order estimation result D5 and the anomaly propagation order estimation result D6 from the data storage unit 20. The anomaly factor device estimating unit 350 performs device unit anomaly factor estimation processing of estimating a factor of an anomaly in units of the device on the basis of the device-attached sensor information D41, the anomaly detection order estimation result D5, and the anomaly propagation order estimation result D6.

The device-attached sensor information D41 is table data indicating in which device the sensor 300 is provided. The operator or the like operates the input device such as a mouse or a keyboard to input the device-attached sensor information D41, and the anomaly factor device estimating unit 350 acquires the device-attached sensor information D41 by receiving the input device-attached sensor information D41.

For example, in the device-attached sensor information D41, information indicating a device is associated with information indicating the sensor 300 provided in the device.

The device unit anomaly factor estimation processing by the anomaly factor device estimating unit 350 will be described in detail.

First, the anomaly factor device estimating unit 350 acquires the device-attached sensor information D41, the anomaly detection order estimation result D5, and the anomaly propagation order estimation result D6.

The anomaly factor device estimating unit 350 converts the anomaly detection order estimation result D5 into an anomaly detection order estimation result (hereinafter referred to as a “device anomaly detection order estimation result”) D42 in units of the device on the basis of the device-attached sensor information D41 and the anomaly detection order estimation result D5.

Specifically, the anomaly factor device estimating unit 350 matches information indicating the sensor 300 associated in the device-attached sensor information D41 with information indicating the sensor 300 included in the anomaly detection order estimation result D5 for a certain device U among U (U is an integer) devices. Then, the anomaly factor device estimating unit 350 acquires the anomaly detection order associated with the information indicating the matched sensor 300 in the anomaly detection order estimation result D5 and calculates an anomaly detection order aggregate value. Here, the anomaly detection order aggregate value is a real number. For example, the anomaly factor device estimating unit 350 sets a representative value as the anomaly detection order aggregate value by using a weighted average of the anomaly detection order associated with the information indicating the matched sensor 300. In addition, the anomaly factor device estimating unit 350 may set a representative value such as a minimum or a maximum of the anomaly detection order associated with the information indicating the matched sensor 300 as the anomaly detection order aggregate value.

Then, the anomaly factor device estimating unit 350 assigns the anomaly detection order (hereinafter referred to as “device anomaly detection order”) in units of the device to the device U on the basis of the calculated anomaly detection order aggregate value. Here, a device anomaly detection order ouU is a real number. For example, the anomaly factor device estimating unit 350 assigns the device anomaly detection order to the device u in such a manner that the corresponding device anomaly detection order is in ascending order from the anomaly detection order aggregate value having the smallest value. In addition, when the calculated anomaly detection order aggregate values are equal among the plurality of devices, the anomaly factor device estimating unit 350 assigns the same device anomaly detection order to the plurality of devices.

The anomaly factor device estimating unit 350 generates the device anomaly detection order estimation result D42, which is information in which the information indicating a device, the anomaly detection order aggregate value, and the device anomaly detection order are associated with each other in units of the device, and causes the device anomaly detection order estimation result D42 to be stored in the data storage unit 20.

Further, the anomaly factor device estimating unit 350 converts the anomaly propagation order estimation result D6 into an anomaly propagation order estimation result (hereinafter referred to as a “device anomaly propagation order estimation result”) D43 in units of the device on the basis of the device-attached sensor information D41 and the anomaly propagation order estimation result D6.

Specifically, assuming that U devices are represented by devices U (U=1, 2, . . . , U), the anomaly factor device estimating unit 350 matches information indicating the sensor 300 associated in the device-attached sensor information D41 with information indicating the sensor 300 included in the anomaly propagation order estimation result D6 for a certain device U. Then, the anomaly factor device estimating unit 350 acquires the anomaly propagation order associated with the information indicating the matched sensor 300 in the anomaly propagation order estimation result D6, and calculates an anomaly propagation order aggregate value. Here, the anomaly propagation order aggregate value is a real number. For example, the anomaly factor device estimating unit 350 sets a representative value as the anomaly propagation order aggregate value by using a weighted average of the anomaly propagation order associated with the information indicating the matched sensor 300. In addition, the anomaly factor device estimating unit 350 may use a representative value such as a minimum or a maximum of the anomaly propagation order associated with the information indicating the matched sensor 300 as the anomaly propagation order aggregate value.

Then, the anomaly factor device estimating unit 350 assigns the anomaly propagation order (hereinafter referred to as “device anomaly propagation order”) in units of the device to the device U on the basis of the calculated anomaly propagation order aggregate value. Here, the anomaly detection order is a real number. For example, the anomaly factor device estimating unit 350 assigns the device anomaly propagation order to the device U in such a manner that the corresponding device anomaly propagation order is in ascending order from the anomaly propagation order aggregate value having the smallest value. In addition, when the calculated anomaly propagation order aggregate values are equal in a plurality of devices, the anomaly factor device estimating unit 350 assigns the same device anomaly propagation order to the plurality of devices.

The anomaly factor device estimating unit 350 generates the device anomaly propagation order estimation result D43, which is information in which information indicating a device, an anomaly detection device flag, the anomaly propagation order aggregate value, and the device anomaly propagation order are associated in units of the device, and causes the device anomaly propagation order estimation result D43 to be stored in the data storage unit 20. The anomaly detection device flag indicates whether or not there is an anomaly detection sensor among the sensors 300 provided in the device in units of the device. The anomaly detection device flag is a Boolean value.

In addition, as described above, in the first embodiment described above, the device may be provided with the plurality of sensors 300. For example, when there is at least one anomaly detection sensor among the plurality of sensors 300 provided in a certain device U, the anomaly factor device estimating unit 350 sets (True) to the anomaly detection device flag corresponding to the certain device U in the device anomaly propagation order estimation result D43. That is, for example, in a case where a plurality of sensors 300 is provided in a certain device U and there is one or more anomaly detection sensors among the plurality of sensors 300, the anomaly factor device estimating unit 350 sets (True) to the anomaly detection device flag corresponding to the certain device U. On the other hand, for example, when a plurality of sensors 300 is provided in a certain device U and there is no anomaly detection sensor among the plurality of sensors 300, the anomaly factor device estimating unit 350 sets (False) to the anomaly detection device flag.

Furthermore, the anomaly factor device estimating unit 350 estimates the factor of the anomaly in units of the device on the basis of the generated device anomaly detection order estimation result D42 and device anomaly propagation order estimation result D43.

Specifically, the anomaly factor device estimating unit 350 calculates the device anomaly factor score for each device from the device anomaly detection order set in the device anomaly detection order estimation result D42 and the device anomaly propagation order set in the device anomaly propagation order estimation result D43. Here, the device anomaly factor score is a real number.

For example, the anomaly factor device estimating unit 350 sets a representative value as the device anomaly factor score by using the weighted average of the device anomaly detection order and the device anomaly propagation order for each device. In addition, for example, the anomaly factor device estimating unit 350 may set a representative value such as a maximum or a minimum of the device anomaly detection order and the device anomaly propagation order as the device anomaly factor score for each device. In addition, when only one of the device anomaly detection order and the device anomaly propagation order is set, the anomaly factor device estimating unit 350 only needs to set the set value as the device anomaly factor score as it is. In this case, the anomaly factor device estimating unit 350 may weight the device anomaly factor score in consideration of the fact that only one order is set.

Then, the anomaly factor device estimating unit 350 assigns an anomaly factor order (hereinafter referred to as “device anomaly factor order”) for each device on the basis of the calculated device anomaly factor score for each device. Here, the device anomaly factor order is a real number. For example, the anomaly factor device estimating unit 350 assigns the device anomaly factor order to the device U in such a manner that the corresponding device anomaly factor order is in ascending order from the device having the smallest value of the corresponding device anomaly factor score. In addition, when the calculated device anomaly factor scores are equal among a plurality of devices U, the anomaly factor device estimating unit 350 assigns the same device anomaly factor order to the plurality of devices U.

The anomaly factor device estimating unit 350 generates the device anomaly factor order estimation result D44, which is information in which information indicating a device, an anomaly detection device flag, a device anomaly factor score, and a device anomaly factor order are associated with each other in units of the device, and causes the device anomaly factor order estimation result D44 to be stored in the data storage unit 20. In addition, for the device U, the anomaly factor device estimating unit 350 only needs to set the value of the anomaly detection device flag set in association with the information indicating the device U in the device anomaly propagation order estimation result D43 in the anomaly detection device flag associated in the device anomaly factor order estimation result D44.

The device unit anomaly factor estimation processing by the anomaly factor device estimating unit 350 as described above will be described with reference to the drawings as a specific example.

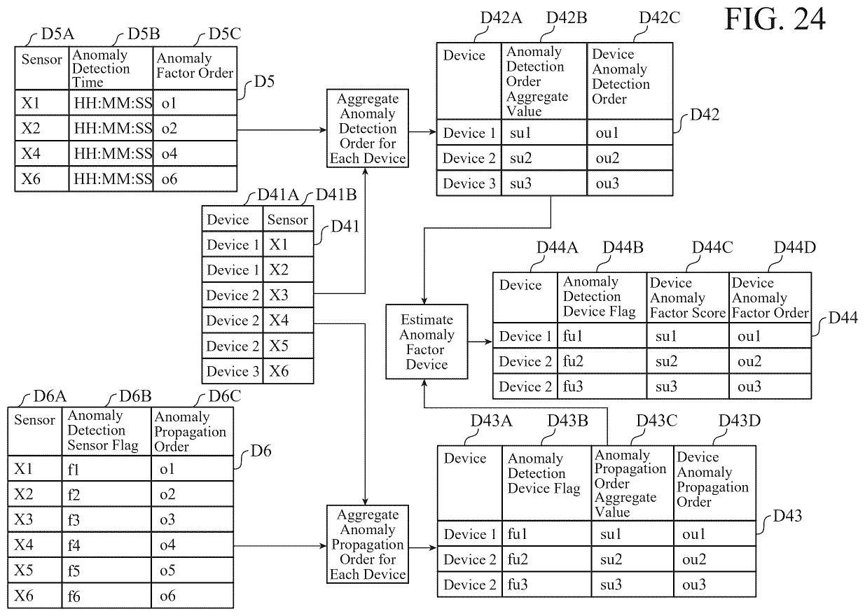

FIG. 24 is a diagram for describing a concept of an example of device unit anomaly factor estimation processing of estimating a factor of an anomaly in units of the device, the process being performed by the anomaly factor device estimating unit 350 on the basis of the device-attached sensor information D41, the anomaly detection order estimation result D5, and the anomaly propagation order estimation result D6 in a case where the anomaly factor estimating device 100 according to the first embodiment includes the anomaly factor device estimating unit 350.

Here, as an example, the quantity of sensors 300 is set to six, and the sensor 300 is represented by a sensor Xn (n=1 to 6). Further, as an example, the quantity of devices is three, and the devices are represented by devices U (U=1, 2, 3). In addition, it is assumed that the device 1 is provided with a sensor X1 and a sensor X2, the device 2 is provided with a sensor X3, a sensor X4, and a sensor X5, and the device 3 is provided with a sensor X6.

On the basis of the anomaly detection order on (indicated by D5C in FIG. 24) set in the anomaly detection order estimation result D5 and the device-attached sensor information D41, the anomaly factor device estimating unit 350 calculates an anomaly detection order aggregate value suU (indicated by D42B in FIG. 24) for each device U by using, for example, an average. For example, in the device 1, since the sensors Xn added to the device 1 are the sensor X1 and the sensor X2, the anomaly factor device estimating unit 350 sets an anomaly detection order aggregate value su1 corresponding to the device 1 as the mean of the anomaly detection order o1 and the anomaly detection order o2. Furthermore, for example, in the device 2, the sensors Xn added to the device 2 are the sensor X3, the sensor X4, and the sensor X5. However, among the sensor X3, the sensor X4, and the sensor X5, only the sensor X4 is the anomaly detection sensor, in other words, the sensor Xn included in the anomaly detection order estimation result D5. Thus, the anomaly factor device estimating unit 350 sets the anomaly detection order o4 corresponding to the sensor X4 as an anomaly detection order aggregate value su2 corresponding to the device 2 as it is. Similarly, the anomaly factor device estimating unit 350 sets the anomaly detection order o6 corresponding to the sensor X6 as an anomaly detection order aggregate value su6 corresponding to the device 3 as it is.

Subsequently, the anomaly factor device estimating unit 350 assigns the device anomaly detection order ouU for each device on the basis of the anomaly detection order aggregate value suU calculated for each device. Specifically, the anomaly factor device estimating unit 350 assigns device anomaly detection orders ou1, ou2, and ou3 corresponding to the devices 1, 2, and 3, respectively, on the basis of the calculated anomaly detection order aggregate values su1, su2, and su3.

Then, the anomaly factor device estimating unit 350 generates the device anomaly detection order estimation result D42 in which information indicating the devices 1, 2, and 3 (indicated by D42A in FIG. 24), the anomaly detection order aggregate values su1, su2, and su3 (indicated by D42B in FIG. 24), and the device anomaly detection orders ou1, ou2, and ou3 (indicated by D42C in FIG. 24) are associated with each other, and causes the device anomaly detection order estimation result D42 to be stored in the data storage unit 20.

Further, the anomaly factor device estimating unit 350 calculates an anomaly propagation order aggregate value suU (indicated by D43C in FIG. 24) for each device using, for example, an average on the basis of the anomaly propagation order on (indicated by D6C in FIG. 24) set in the anomaly propagation order estimation result D6 and the device-attached sensor information D41. For example, in the device 1, since the sensors Xn added to the device 1 are the sensor X1 and the sensor X2, the anomaly factor device estimating unit 350 sets the anomaly propagation order aggregate value su1 corresponding to the device 1 as the mean of the anomaly propagation order o1 and the anomaly propagation order o2. In addition, for example, in the device 2, since the sensors Xi added to the device 2 are the sensor X3, the sensor X4, and the sensor X5, the anomaly factor device estimating unit 350 sets the anomaly propagation order aggregate value su2 corresponding to the device 2 as the mean of the anomaly propagation order o3, the anomaly propagation order o4, and the anomaly propagation order o5. Similarly, the anomaly factor device estimating unit 350 sets the anomaly propagation order o6 corresponding to the sensor X6 as the anomaly propagation order aggregate value su6 corresponding to the device 3 as it is.

Subsequently, the anomaly factor device estimating unit 350 assigns the device anomaly propagation order ouU on the basis of the anomaly propagation order aggregate value suU calculated for each device. Specifically, the anomaly factor device estimating unit 350 assigns the device anomaly propagation orders ou1, ou2, and ou3 corresponding to the devices 1, 2, and 3, respectively, on the basis of the calculated anomaly propagation order aggregate values su1, su2, and su3.

Then, the anomaly factor device estimating unit 350 generates the device anomaly propagation order estimation result D43 in which the information indicating the devices 1, 2, and 3 (indicated by D43A in FIG. 24), the anomaly detection device flag (indicated by D43B in FIG. 24), the anomaly propagation order aggregate values su1, su2, and su3 (indicated by D43C in FIG. 24), and the device anomaly propagation orders ou1, ou2, and ou3 (indicated by D43D in FIG. 24) are associated, and causes the device anomaly propagation order estimation result D43 to be stored in the data storage unit 20.

Furthermore, the anomaly factor device estimating unit 350 calculates the device anomaly factor score suU using the average for each device on the basis of the device anomaly detection order ouU set in the device anomaly detection order estimation result D42 and the device anomaly propagation order ouU set in the device anomaly propagation order estimation result D43. For example, the anomaly factor device estimating unit 350 calculates, for the device 1, a mean of the device anomaly detection order ou1 and the device anomaly propagation order ou1 of the device 1 as the device anomaly factor score su1.

Then, the anomaly factor device estimating unit 350 assigns the device anomaly factor order ouU for each device on the basis of the device anomaly factor score suU. For example, the anomaly factor device estimating unit 350 assigns the corresponding device anomaly factor orders ou1, ou2, and ou3 to the devices 1, 2, and 3, respectively, on the basis of the calculated device anomaly factor scores su1, su2, and su3.

The anomaly factor device estimating unit 350 generates the device anomaly factor order estimation result D44, which is information in which the information indicating the devices 1, 2, and 3 (indicated by D44A in FIG. 24), the anomaly detection device flag (indicated by D44B in FIG. 24), the device anomaly factor scores su1, su2, and su3 (indicated by D44C in FIG. 24), and the device anomaly factor orders ou1, ou2, and ou3 (indicated by D44D in FIG. 24) are associated with each other, and causes the device anomaly factor order estimation result D44 to be stored in the data storage unit 20.

As described above, when the anomaly factor device estimating unit 350 causes the device anomaly detection order estimation result D42, the device anomaly propagation order estimation result D43, and the device anomaly factor order estimation result D44 to be stored in the data storage unit 20, the anomaly factor estimation result output unit 70 acquires the device anomaly detection order estimation result D42, the device anomaly propagation order estimation result D43, and the device anomaly factor order estimation result D44 output by the anomaly factor device estimating unit 350 via the data storage unit 20, and outputs information regarding the estimation result of the factor of the anomaly in units of the device on the basis of the device anomaly detection order estimation result D42, the device anomaly propagation order estimation result D43, and the device anomaly factor order estimation result D44.

Specifically, on the basis of the device anomaly detection order estimation result D42, the device anomaly propagation order estimation result D43, and the device anomaly factor order estimation result D44, the anomaly factor estimation result output unit 70 outputs, to the display device 400, information (hereinafter referred to as “anomaly factor device estimation result display information”) for displaying a screen (hereinafter referred to as an “anomaly factor device estimation result screen”) indicating the information regarding the estimation result of the factor of the anomaly for each device by the anomaly factor device estimating unit 350.

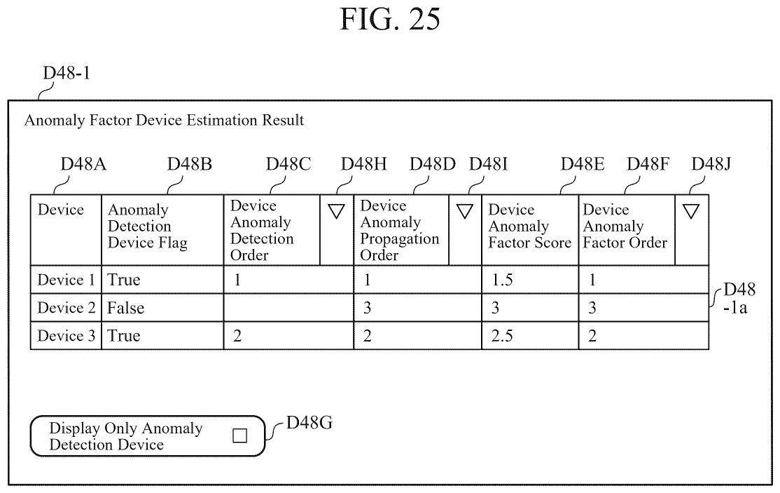

FIG. 25 is a diagram illustrating a screen example of an anomaly factor device estimation result screen displayed on the display device 400 by the anomaly factor estimation result output unit 70 in the first embodiment.

FIG. 25 illustrates an example of the anomaly factor device estimation result screen when the quantity of devices is 3 (devices U. U=1 to 3) as an example.

In FIG. 25, the anomaly factor device estimation result screen is indicated by “D48-1”.

For example, as illustrated in FIG. 25, the anomaly factor device estimation result screen includes ten display frames of a display frame D48A, a display frame D48B, a display frame D48C, a display frame D48D, a display frame D48E, a display frame D48F, a display frame D48G, a display frame D48H, a display frame D48I, and a display frame D48J.

For example, the anomaly factor estimation result output unit 70 causes an anomaly factor device estimation result list in which the information regarding the estimation result of the factor of the anomaly is listed in units of the device to be displayed on the anomaly factor device estimation result screen. For example, the anomaly factor device estimation result list is a list in which the information indicating the device U, information indicating the anomaly detection device flag, the device anomaly detection order, the device anomaly propagation order, the device anomaly factor score, and the device anomaly factor order are displayed in association with each other for each device U. In the anomaly factor device estimation result screen illustrated in FIG. 25, the anomaly factor device estimation result list is indicated by “D48-1a”.

The anomaly factor estimation result output unit 70 outputs, to the display device 400, an anomaly factor device estimation result display information that causes the information indicating the device U of the device anomaly factor order estimation result D44 to be displayed in the display frame D48A, causes the information indicating the anomaly detection device flag of the device anomaly propagation order estimation result D43 to be displayed in the display frame D48B, causes the device anomaly detection order of the device anomaly detection order estimation result D42 in the display frame D48C, causes the device anomaly propagation order of the device anomaly propagation order estimation result D43 to be displayed in the display frame D48D, causes the device anomaly factor score of the device anomaly factor order estimation result D44 to be displayed in the display frame D48E, causes the device anomaly factor order of the device anomaly factor order estimation result D44 to be displayed in the display frame D48F, causes sort buttons for rearranging, in ascending order, the arrangement order of the anomaly factor device estimation result list based on the device anomaly detection order of the device anomaly detection order estimation result D42, the device anomaly propagation order of the device anomaly propagation order estimation result D43, and the device anomaly factor order of the device anomaly factor order estimation result D44 to be displayed in the display frames D48H, D48I, and D48J, respectively, and causes a check box for receiving an instruction to display only an anomaly detection device to be displayed in the display frame D48G. As a result, the display device 400 displays an anomaly factor device estimation result screen as illustrated in FIG. 25.

The anomaly factor device estimation result screen as illustrated in FIG. 25 is obtained by displaying the anomaly factor estimation result screen already described with reference to FIG. 8 in units of the device, and the functions of the sort button and the check box are similar to the functions of the sort button and the check box already described with reference to FIG. 8, and thus duplicate description will be omitted.

Further, in this case, in the operation of the anomaly factor estimating device 100 described with reference to the flowchart of FIG. 13, the anomaly factor device estimating unit 350 performs the device unit anomaly factor estimation processing of estimating the factor of the anomaly in units of the device on the basis of the device-attached sensor information D41, the anomaly detection order estimation result D5, and the anomaly propagation order estimation result D6 before the process of step ST5 or after the process of step ST5.

In addition, for example, the anomaly factor estimation result output unit 70 may be able to select whether to output the information regarding the estimation result of the factor of the anomaly on a sensor-by-sensor basis or the information regarding the estimation result of the factor of the anomaly in units of the device as described in the first embodiment.

As described above, the anomaly factor estimating device 100 can include the anomaly factor device estimating unit 350 that estimates the factor of the anomaly in units of the device on the basis of the device-attached sensor information, the anomaly detection order estimated by the anomaly detection order estimating unit 40, and the anomaly propagation order estimated by the anomaly propagation path tracking unit 50. Thus, the anomaly factor estimating device 100 can enable the operator to efficiently specify the device that has caused the anomaly. In addition, the anomaly factor estimating device 100 can enable the operator to efficiently grasp the order of inspection to be performed on the devices in which the anomaly has occurred.

### <Modification>

In the first embodiment described above, the anomaly factor estimating device 100 may include a related structure graph output unit 360 that outputs information (hereinafter referred to as “related structure graph display information”) for displaying the graph related to the related structure D2 stored in the data storage unit 20 to the display device 400.

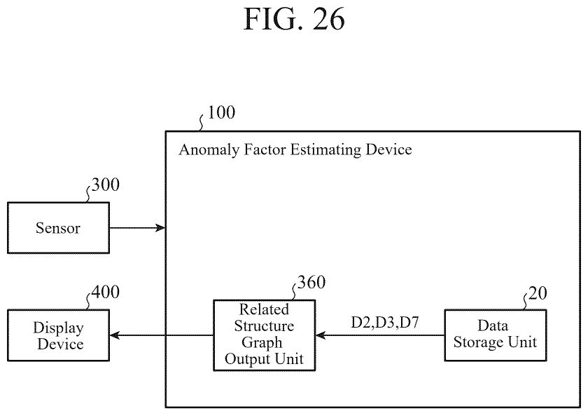

FIG. 26 is a diagram illustrating a configuration example of the anomaly factor estimating device 100 including the related structure graph output unit 360 and configured to output the related structure graph display information to a display device 400 in the first embodiment.

Further, although not illustrated in FIG. 26 for simplicity of description, the anomaly factor estimating device 100 includes the sensor data acquiring unit 10, the anomaly detecting unit 30, the anomaly detection order estimating unit 40, the anomaly propagation path tracking unit 50, the anomaly factor estimating unit 60, the anomaly factor estimation result output unit 70, and the control unit, in addition to the related structure graph output unit 360 and the data storage unit 20. In addition, the anomaly factor estimating device 100 does not necessarily include the anomaly factor estimation result output unit 70. Further, although not illustrated in FIG. 26 for simplicity of description, the anomaly factor estimating device 100 is connected to the learning device 200.

On the basis of the related structure D2, the anomaly detection sensor information D3, and the anomaly factor order estimation result D7 stored in the data storage unit 20, the related structure graph output unit 360 outputs, to the display device 400, the related structure graph display information for displaying a graph related to the related structure D2. The graph related to the related structure D2 is, for example, a graph in which the related structure D2, the anomaly detection sensor, and the estimation result of the factor of the anomaly are associated with each other.

The display device 400 displays a screen (hereinafter referred to as a “graph screen”) on which a graph related to the related structure D2 is displayed on the basis of the related structure graph display information output from the related structure graph output unit 360.

In addition, the related structure graph output unit 360 may be provided in a device connected to the anomaly factor estimating device 100 via a wired or wireless signal line outside the anomaly factor estimating device 100, such as the display device 400.

An example of a graph screen to be displayed on the display device 400 by the related structure graph output unit 360 outputting the related structure graph display information in a case where the anomaly factor estimating device 100 includes the related structure graph output unit 360 will be described with reference to the drawings.

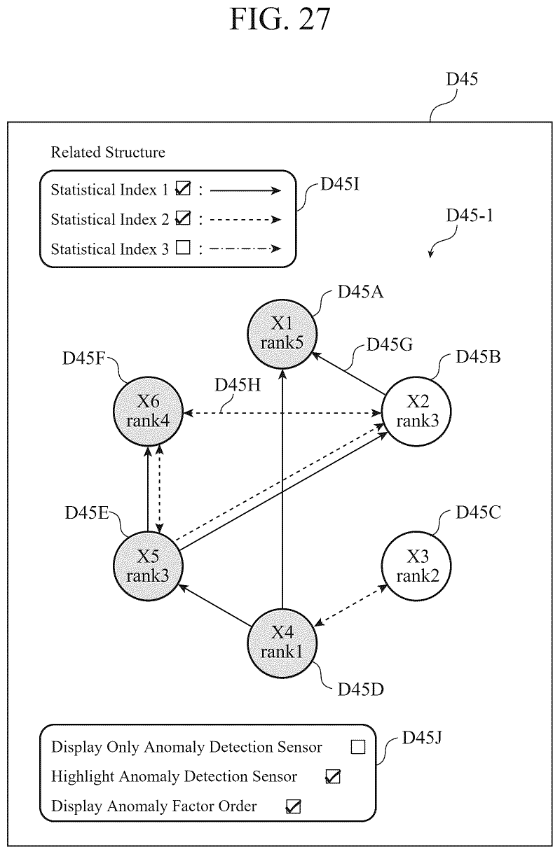

FIG. 27 is a diagram for describing an example of a graph screen to be displayed on the display device 400 by the related structure graph output unit 360 outputting the related structure graph display information in a case where the anomaly factor estimating device 100 includes the related structure graph output unit 360 in the first embodiment.

Here, as an example, the quantity of sensors 300 is set to six, and the sensor 300 is represented by a sensor Xn (n=1 to 6).

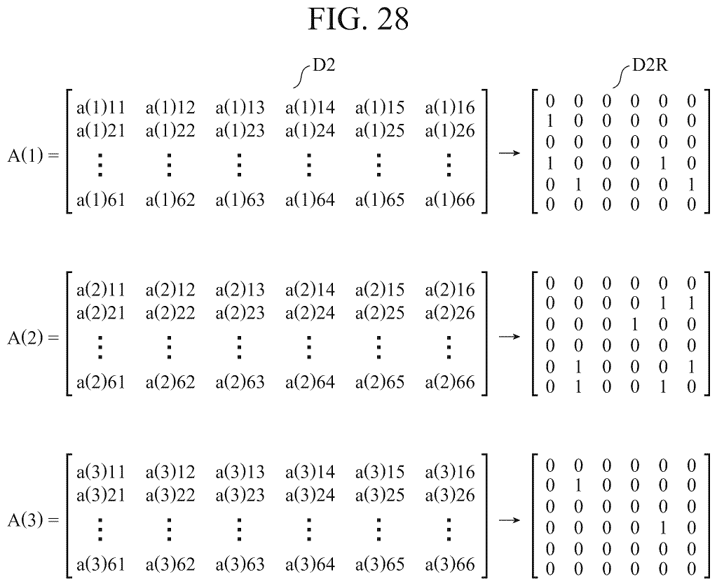

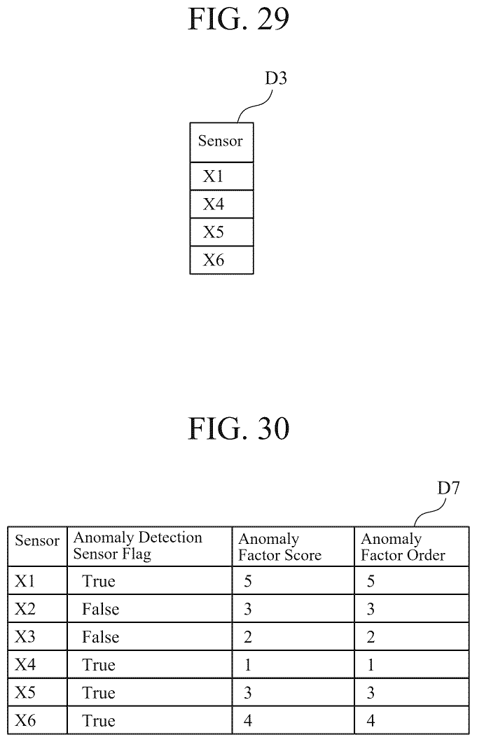

In addition, an example of the graph screen illustrated in FIG. 27 is an example of a graph screen to be displayed on the basis of the related structure graph display information output by the related structure graph output unit 360 in a case where content of the related structure D2 stored in the data storage unit 20 is content as illustrated in FIG. 28, content of the anomaly detection sensor information D3 is content as illustrated in FIG. 29, and the anomaly factor order estimation result D7 has content as illustrated in FIG. 30.

Further, when outputting the related structure graph display information, the related structure graph output unit 360 determines whether each element of the related structure D2 is an element having a dependence relationship or an element having no dependence relationship for each statistical index, and converts the related structure D2 into a related structure (hereinafter referred to as a “related structure after dependence relationship determination”) using information indicating presence or absence of a dependence relationship as an element.

For example, for each statistical index, the related structure graph output unit 360 determines that each element of the related structure D2 is an element having a dependence relationship when each element is equal to or more than a preset threshold for dependency selection, and determines that each element is an element having no dependence relationship when each element is less than the threshold for dependency selection. Then, the related structure graph output unit 360 generates, for example, the related structure after dependence relationship determination indicated by a matrix in which an element having a dependence relationship is “1” and an element having no dependence relationship is “0”.

In FIG. 28, a dependence relationship determination degree related structure (indicated by D2R in FIG. 28) for each statistical index is illustrated together with the related structure D2.

In FIG. 27, the graph screen is indicated by D45. On the graph screen, for example, a related structure graph (indicated by D45-1 in FIG. 27) which is a directed graph in which the related structure D2 is represented by the sensor Xn as a node and the dependence relationship between the sensors Xn is represented by an edge is displayed.

On the graph screen, in addition to the related structure graph, a screen (hereinafter referred to as an “index designation screen”) (indicated by D45I in FIG. 27) for displaying a check box (hereinafter referred to as an “index designation check box”) for receiving designation of a type of a statistical index as a target for displaying a corresponding element in the related structure graph is displayed. Here, since there are three types of statistical indexes, an index designation check box corresponding to “statistical index 1” for receiving designation of a first type of statistical index, an index designation check box corresponding to “statistical index 2” for receiving designation of a second type of statistical index, and an index designation check box corresponding to “statistical index 3” for receiving designation of a third type of statistical index are displayed on the index designation screen illustrated in FIG. 27. For example, the operator designates a statistical index for which the correlation (edge) between the corresponding sensors Xn is to be displayed by checking the index designation check box. FIG. 27 illustrates a state where the index designation check box corresponding to “statistical index 1” and the index designation check box corresponding to “statistical index 2” are checked on the index designation screen, in other words, a state where the first statistical index and the second statistical index are designated. Thus, only the edges corresponding to the first type of statistical index and the second type of statistical index, which are the statistical indexes with the index designation check box checked, are displayed on the related structure graph.

For example, as illustrated in FIG. 27, the edges corresponding to the respective statistical indexes are displayed with different line types in such a manner that which statistical index the edge corresponds to can be recognized. In the related structure graph illustrated in FIG. 27, the edge corresponding to the first type of statistical index is displayed by a solid arrow (for example, see D45G), and the edge corresponding to the second type of statistical index is displayed by a dotted arrow (for example, see D45H). In addition, this is merely an example, and for example, the edge corresponding to each statistical index may be displayed in a different arrow color.

Further, a screen (hereinafter referred to as a “node condition designation screen”) (indicated by D45J in FIG. 27) for displaying a check box (hereinafter referred to as a “node condition designation check box”) for designating a display condition (hereinafter referred to as a “node display condition”) related to a node is displayed on the graph screen. The node display condition is preset. In the node condition designation screen illustrated in FIG. 27, three conditions of “display only anomaly detection sensor”, “highlight anomaly detection sensor”, and “display anomaly factor order” are set as the node display condition. For example, the operator designates a node display condition by checking a node condition designation check box. FIG. 27 illustrates a state where the node condition designation check box corresponding to “highlight anomaly detection sensor” and the node condition designation check box corresponding to “display anomaly factor order” are checked on the node condition designation screen.

Thus, in the related structure graph, nodes (illustrated in FIG. 27 as D45A, D45D, D45E, and D45F) corresponding to the sensors X1, X4, X5, and X6, which are anomaly detection sensors, are filled and displayed. In addition, here, it is assumed that the anomaly detection sensor is highlighted by filling and displaying the node corresponding to the anomaly detection sensor, but the method of highlighting the anomaly detection sensor is not limited thereto, and the node corresponding to the anomaly detection sensor may be highlighted by another method.

Further, in the related structure graph, the anomaly factor order is displayed on the node corresponding to the sensor Xn. In the related structure graph illustrated in FIG. 27, the anomaly factor order is displayed as “rank 1”, “rank 2”, “rank 3”, “rank 4”, or “rank 5”. In addition, here, the anomaly factor order is displayed as “rank A”, but the display method of the anomaly factor order is not limited thereto, and it is only necessary to be displayed in such a manner that the anomaly factor order can be understood.

In addition, here, three conditions of “display only anomaly detection sensor”, “highlight anomaly detection sensor”, and “display anomaly factor order” are set as the node display condition, but this is merely an example, and other conditions may be set as the node display condition.

In the related structure graph, for example, a sensor name for identifying the sensor Xn by the operator who has checked the graph screen is displayed on each node. In FIG. 27, sensor names “X1”, “X2”, “X3”, “X4”, “X5”, and “X6” are displayed.

For example, the edge is displayed when the statistic, which is an element of the related structure D2, is larger than the threshold for dependency selection provided for each statistical index. The statistic being larger than the threshold means that there is a dependence relationship between the sensors Xn. In addition, the related structure graph output unit 360 can determine the dependence relationship between the sensors Xn from the related structure after dependence relationship determination.

In a case where the dependence relationship between the sensors Xn is in one direction, an edge of a one side arrow is displayed in the directed graph, and in a case where the dependence relationship between the sensors Xn is in two directions, an edge of a both side arrow is displayed in the directed graph. For example, here, since there is a dependence relationship in one direction from the sensor X2 to the sensor X1, as illustrated in FIG. 27, an edge (indicated by D45G in FIG. 27) of a one side arrow from the node indicating the sensor X2 (indicated by D45B in FIG. 27) to the node indicating the sensor X1 (indicated by D45A in FIG. 27) is displayed in the directed graph. In addition, here, for example, since the sensor X2 and the sensor X6 have a bidirectional dependence relationship, as illustrated in FIG. 27, an edge (indicated by D45H in FIG. 27) of a both side arrow is displayed between the node indicating the sensor X2 and the node indicating the sensor X6 (indicated by D45F in FIG. 27) in the directed graph.

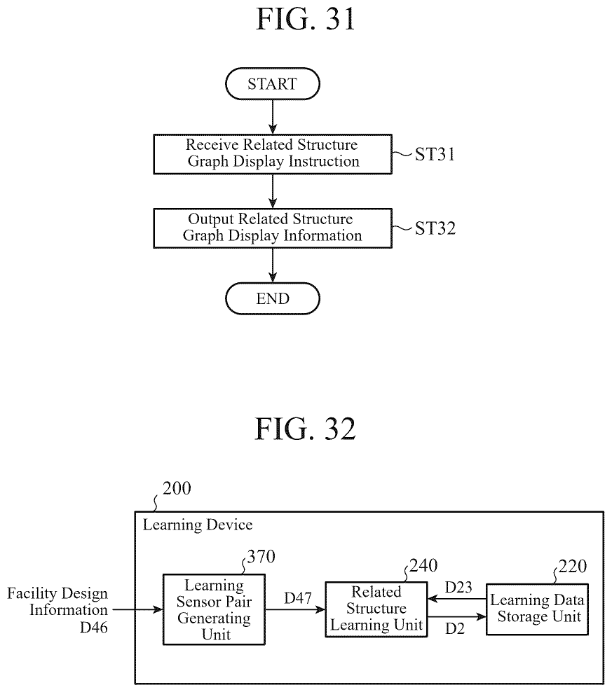

FIG. 31 is a flowchart for describing an example of the operation of the anomaly factor estimating device 100 in a case where the anomaly factor estimating device 100 includes the related structure graph output unit 360 in the first embodiment.

The anomaly factor estimating device 100 performs the operation illustrated in the flowchart of FIG. 31 in addition to the operation described with reference to the flowchart of FIG. 13. Further, it is assumed that the operation illustrated in the flowchart of FIG. 31 is performed at least once after the processing of steps ST1 to ST5 of FIG. 13 is performed. The operation as illustrated in the flowchart of FIG. 31 may be performed, for example, after the processing of step ST5 of FIG. 13, before the processing of step ST6 is performed, after the processing of step ST6 is performed, or in parallel with the processing of step ST6.

The related structure graph output unit 360 receives a display instruction of the related structure graph (step ST31).

For example, the operator operates the input device such as a mouse or a keyboard to call an input screen of a display instruction of the related structure graph on the display device 400. The operator inputs a display instruction of the related structure graph from the input screen of the display instruction of the related structure graph. The related structure graph output unit 360 receives a display instruction of the related structure graph input by the operator.

On the basis of the related structure D2 stored in the data storage unit 20, the anomaly detection sensor information D3, and the anomaly factor order estimation result D7, the related structure graph output unit 360 outputs, to the display device 400, the related structure graph display information for displaying a graph related to the related structure D2 (step ST32). Thus, for example, a graph screen as illustrated in FIG. 27 is displayed on the display device 400.

As described above, the anomaly factor estimating device 100 includes the related structure graph output unit 360, whereby the anomaly factor estimating device 100 can improve explainability of information regarding the estimation result of the factor of the anomaly.

### <Modification>

In the first embodiment described above, the learning device 200 may include a learning sensor pair generating unit 370 that generates a pair of sensors 300 from among the plurality of sensors 300 on the basis of the connection relationship among the plurality of devices constituting the target facility and information (hereinafter referred to as “facility design information”) defining the plurality of sensors 300 provided in the plurality of devices. In this case, the related structure learning unit 240 acquires the learning sensor data for each pair of sensors 300 generated by the learning sensor pair generating unit 370 and learns the related structure D2. Further, the operator or the like generates the facility design information on the basis of a design drawing and inputs the facility design information generated by operating the input device such as a mouse or a keyboard, and the learning device 200 acquires the facility design information by receiving the input facility design information.

FIG. 32 is a diagram illustrating a configuration example of the learning device 200 including the learning sensor pair generating unit 370 in the first embodiment.

Further, although not illustrated in FIG. 32 for simplicity of description, the learning device 200 includes the learning sensor data acquiring unit 210 and the learning preprocessing unit 230 in addition to the learning sensor pair generating unit 370, the related structure learning unit 240, and the learning data storage unit 220. Further, although not illustrated in FIG. 32 for simplicity of description, the learning device 200 is connected to the anomaly factor estimating device 100.

The learning sensor pair generating unit 370 acquires the facility design information, and generates a pair of sensors 300 used when the related structure learning unit 240 learns the related structure D2 from the plurality of sensors 300 on the basis of the acquired facility design information.

Specifically, the learning sensor pair generating unit 370 determines a combination of the two sensors 300 on the basis of the facility design information, and generates information (hereinafter referred to as “sensor pair information”) D47 in which the combinations are listed.

The learning sensor pair generating unit 370 outputs the generated sensor pair information D47 to the related structure learning unit 240.

When the sensor pair information D47 is output from the learning sensor pair generating unit 370, the related structure learning unit 240 calculates a statistic indicating a relationship between two different pieces of sensor data for a plurality of pieces of sensor data included in the learning data D23 on the basis of the pair of sensors 300 set in the sensor pair information D47, and learns the related structure D2 on the basis of the calculated statistic.

Processing in which the learning sensor pair generating unit 370 generates the sensor pair information D47 will be described with reference to the drawings with a specific example.

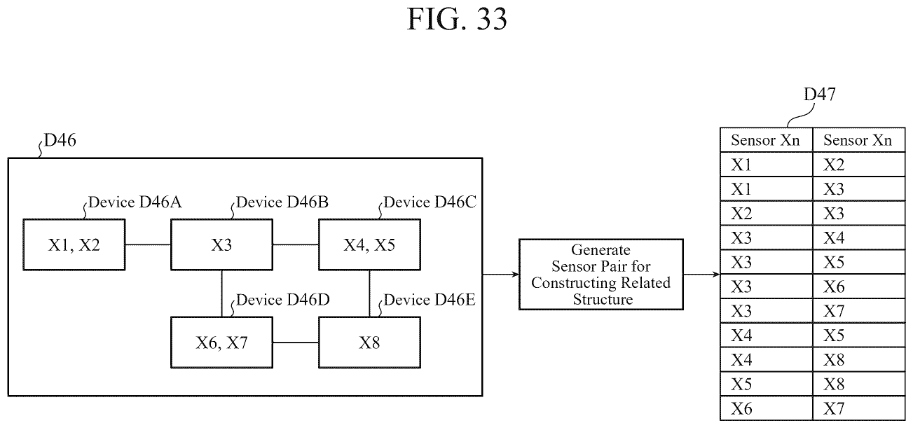

FIG. 33 is a diagram for describing a concept of an example of a method for generating the sensor pair information D47 on the basis of facility design information D46 by the learning sensor pair generating unit 370 in a case where the learning device 200 includes the learning sensor pair generating unit 370 in the first embodiment.

Here, as an example, the quantity of sensors 300 is set to eight, and the sensor 300 is represented by a sensor Xn (n=1 to 8).

Further, here, as an example, it is assumed that the target facility includes five devices (a device D46A, a device D46B, a device D46C, a device D46D, and a device D46E).

In addition, it is assumed that the device D46A is provided with the sensor X1 and the sensor X2, the device D46B is provided with the sensor X3, the device D46C is provided with the sensor X4 and the sensor X5, the device D46D is provided with the sensor X6 and the sensor X7, and the device D46E is provided with the sensor X8.

Furthermore, it is assumed that the device D46A is in a connection relationship with the device D46B, the device D46B is in a connection relationship with the devices D46A, D46C, and D46D, the device D46C is in a connection relationship with the devices D46B and D46E, the device D46D is in a connection relationship with the device D46B, and the device D46E is in a connection relationship with the device D46C. Further, devices having a connection relationship in design are connected by an undirected line. In this case, the facility design information D46 has contents as illustrated in FIG. 33. Note that, in FIG. 33, as an example, the facility design information D46 is illustrated in a block diagram, but this is merely an example. The facility design information D46 may be any information as long as a connection relationship between a plurality of devices constituting the target facility and a plurality of sensors Xn provided in the plurality of devices are known.

The learning sensor pair generating unit 370 generates a pair including two different sensors Xn on the basis of the facility design information D46. Specifically, the learning sensor pair generating unit 370 generates a pair including a sensor Xn added to a certain device and a sensor Xn added to a device having a connection relationship with the device.

For example, in the example illustrated in FIG. 33, according to the facility design information D46, the device D46A and the device D46B are in a connection relationship. In this case, the sensor X1 and the sensor X2 provided in the device D46A and the sensor X3 provided in the device D46B are also in a connection relationship. Therefore, the learning sensor pair generating unit 370 generates a pair of the sensor X1 and the sensor X3 and a pair of the sensor X2 and the sensor X3.

Furthermore, in a case where two or more sensors Xn are provided in one device, the learning sensor pair generating unit 370 generates a pair of different sensors Xn among the two or more sensors Xn provided in the same device.

For example, in the example illustrated in FIG. 33, according to the facility design information D46, the device D46A is provided with the sensor X1 and the sensor X2. Therefore, the learning sensor pair generating unit 370 generates a pair of the sensor X1 and the sensor X2.

As described above, the learning sensor pair generating unit 370 generates, for example, a pair including two sensors provided in different devices, which are in a connection relationship with each other, and a pair including two different sensors provided in one device as a pair of sensors.

In addition, the pair of sensors generated by the learning sensor pair generating unit 370 as described above is merely an example, and the learning sensor pair generating unit 370 may generate, for example, only a pair including two sensors provided in different devices, which are in a connection relationship with each other, or may generate only a pair including two different sensors provided in one device.

As described above, in a case where the learning device 200 includes the learning sensor pair generating unit 370, in the operation of the learning device 200 described with reference to the flowchart of FIG. 14, the learning sensor pair generating unit 370 generates the sensor pair information D47 and outputs the sensor pair information D47 to the related structure learning unit 240 before the processing of step ST231 is performed, and in step ST231, the related structure learning unit 240 acquires two different pairs of sensor data on the basis of the learning data D23 and the sensor pair information D47. Note that the related structure learning unit 240 sets all combinations of the plurality of pieces of sensor data included in the learning data D23 as sensor data pairs on the basis of the sensor pair information D47.

As described above, the learning device 200 includes the learning sensor pair generating unit 370 that generates a pair of sensors 300 from among the plurality of sensors 300 on the basis of the facility design information, and the related structure learning unit 240 is configured to acquire the learning sensor data for each pair of sensors 300 generated by the learning sensor pair generating unit 370 and learn the related structure D2, so that the learning device 200 can suppress the possibility of detecting the dependence relationship among the sensors 300 having low relevance in design, and can learn the related structure D2 with improved reliability. As a result, the learning device 200 can provide the related structure D2 capable of precisely estimating the anomaly factor to the anomaly factor estimating device 100.

As described above, the anomaly factor estimating device 100 according to the first embodiment includes the sensor data acquiring unit 10 to acquire a plurality of pieces of time-series sensor data collected by a plurality of sensors 300 provided in a plurality of facility components constituting a target facility, the anomaly detecting unit 30 to detect a plurality of anomaly detection sensors in which an anomaly has occurred among a plurality of the sensors 300 on the basis of a plurality of pieces of the sensor data acquired by the sensor data acquiring unit 10, the anomaly detection order estimating unit 40 to estimate an anomaly detection order in which occurrence of the anomaly is detected for a plurality of the anomaly detection sensors on the basis of a detection time at which the anomaly detecting unit 30 has detected a plurality of the anomaly detection sensors, the anomaly propagation path tracking unit 50 to estimate an anomaly propagation order in which the anomaly has propagated on the basis of anomaly detection sensor information D3 regarding a plurality of the anomaly detection sensors detected by the anomaly detecting unit 30 and an estimated structure (related structure D2) indicating a dependence relationship between the facility components, and the anomaly factor estimating unit 60 to estimate a factor of the anomaly on the basis of the anomaly detection order estimated by the anomaly detection order estimating unit 40 and the anomaly propagation order estimated by the anomaly propagation path tracking unit 50.

Therefore, the anomaly factor estimating device 100 can estimate the factor of the anomaly that has occurred in the facility regardless of the complexity of the facility or the scale of the facility.

Further, the anomaly factor estimating device 100 includes the anomaly factor estimation result output unit 70 to output information regarding an estimation result of the factor of the anomaly by the anomaly factor estimating unit 60.

Therefore, the anomaly factor estimating device 100 improves interpretability and explainability of the estimation result of the factor of the anomaly for the operator. The anomaly factor estimating device 100 can reduce unnecessary inspection work by the operator and reduce the load on the operator. In addition, the anomaly factor estimating device 100 can estimate the factor of the anomaly with a quantitative index that does not depend on human subjectivity, and present grounds of estimation. The operator can determine an inspection order of the facility with less effort.

In addition, the anomaly factor estimating device 100 can be configured to detect the anomaly detection sensor using the univariate type anomaly detecting method.

Therefore, the anomaly factor estimating device 100 can more appropriately detect an anomaly in which one piece of sensor data D1 changes alone.

In addition, the anomaly factor estimating device 100 can be configured to detect the anomaly detection sensor using a multivariate type anomaly detecting method.

Therefore, the anomaly factor estimating device 100 can more appropriately detect an anomaly in which the relationship among the plurality of pieces of sensor data D1 changes.

In addition, the anomaly factor estimating device 100 can be configured to detect the anomaly detection sensor using the univariate type anomaly detecting method and the multivariate type anomaly detecting method.

Therefore, the anomaly factor estimating device 100 can more appropriately detect an anomaly in which one piece of sensor data D1 changes alone or an anomaly in which the relationship among the plurality of pieces of sensor data D1 changes.

Further, in the anomaly factor estimating device 100, the anomaly propagation path tracking unit 50 can be configured to estimate the anomaly propagation order on the basis of the anomaly detection sensor information D3, the facility operation state information D31 indicating the operation state of the target facility, and the estimated structure (related structure D32) indicating the dependence relationship between the facility components depending on the operation state of the target facility.

Therefore, the anomaly factor estimating device 100 can cope with a change in the dependence relationship between the sensors 300 due to the operation state change in the target facility, and can precisely estimate the factor of the anomaly on the basis of the related structure D32 with improved reliability.

In addition, the anomaly factor estimating device 100 can include the related structure correcting unit 330 that corrects the dependence relationship among the pieces of sensor data for the estimated structure (related structure D2) on the basis of the dependent pair information D33 related to the pair of sensors having a dependence relationship among the plurality of sensors 300 and the non-dependent pair information D34 related to the pair of sensors 300 having no dependence relationship.

Therefore, the anomaly factor estimating device 100 can improve the reliability of the estimated structure and precisely estimate the factor of the anomaly.

In addition, the anomaly factor estimating device 100 can include the relationship change estimating unit 340 to compare the estimated structure with the estimated structure at the time of occurrence of the anomaly on the basis of the estimated structure (related structure D2), the estimated structure at the time of occurrence of the anomaly (related structure D36), and the anomaly detection sensor information D3 and estimate a change in the relationship among the pieces of sensor data, and the anomaly factor estimating unit 60 can be configured to estimate a factor of the anomaly in consideration of the change in the relationship among the pieces of sensor data estimated by the relationship change estimating unit 340 on the basis of the anomaly detection order estimated by the anomaly detection order estimating unit 40 and the anomaly propagation order estimated by the anomaly propagation path tracking unit 50.

Therefore, the anomaly factor estimating device 100 improves the reliability of the anomaly factor order estimation result D7, and can accurately estimate the anomaly factor.

In addition, the anomaly factor estimating device 100 can include an anomaly factor device estimating unit 350 to estimate, on the basis of the device-attached sensor information D41 in which a device provided in target facility and the sensor 300 provided in the device are associated with each other, the anomaly detection order estimated by the anomaly detection order estimating unit 40, and the anomaly propagation order estimated by the anomaly propagation path tracking unit 50, a factor of the anomaly in units of the device.

Therefore, the anomaly factor estimating device 100 can cause the operator to efficiently specify the device that has caused the anomaly. In addition, the anomaly factor estimating device 100 can enable the operator to efficiently grasp the order of inspection to be performed on the devices in which the anomaly has occurred.

In addition, the anomaly factor estimating device 100 can include the related structure graph output unit 360 to output the related structure graph display information for displaying a graph in which the estimated structure, the anomaly detection sensor, and an estimation result of the factor of the anomaly are associated with each other on the basis of the estimated structure (related structure D2), the anomaly detection sensor information D3, and information regarding the estimation result of the factor of the anomaly estimated by the anomaly factor estimating unit 60.

Therefore, the anomaly factor estimating device 100 can improve the explainability of the information regarding the estimation result of the factor of the anomaly.

As described above, the learning device 200 according to the first embodiment includes the learning sensor data acquiring unit 210 that acquires, as learning data candidates, a plurality of pieces of time-series sensor data collected by the plurality of sensors 300 provided in the target facility during the time of normal operation of the target facility, and the related structure learning unit 240 that calculates, using the plurality of learning data candidates acquired by the learning sensor data acquiring unit 210 as a plurality of pieces of learning data, at least one statistic between the plurality of pieces of learning data on the basis of the learning data and learns, on the basis of the calculated statistic, an estimated structure (related structure D2) indicating a dependence relationship between facility components.

Therefore, the learning device 200 can comprehensively extract the relevance between the pieces of sensor data D1, and as a result, it is possible to provide the related structure D2 in which overlooking of the connection relationship of the sensor 300 is suppressed. The learning device 200 can cause the anomaly factor estimating device 100 to more appropriately track the sensor 300 that is the generation source of the anomaly and improve the estimation accuracy of the factor of the anomaly by providing the estimated structure (related structure D2) when tracking the sensor 300 that is the generation source of the anomaly to the anomaly factor estimating device 100.

Furthermore, the learning device 200 includes the learning preprocessing unit 230 to acquire a plurality of the pieces of learning data to be used for learning on the basis of a plurality of the learning data candidates acquired by the learning sensor data acquiring unit 210, and the related structure learning unit 240 can be configured to calculate at least one of the statistics among a plurality of the pieces of learning data on the basis of the learning data acquired by the learning preprocessing unit 230 and learn the estimated structure (related structure D2) on the basis of the statistics calculated.

Therefore, the learning device 200 can comprehensively extract the relevance between the pieces of sensor data D1, and as a result, it is possible to provide the related structure D2 in which overlooking of the connection relationship of the sensor 300 is suppressed. The learning device 200 can cause the anomaly factor estimating device 100 to more appropriately track the sensor 300 that is the generation source of the anomaly and improve the estimation accuracy of the factor of the anomaly by providing the estimated structure (related structure D2) when tracking the sensor 300 that is the generation source of the anomaly to the anomaly factor estimating device 100.

Furthermore, in the learning device 200, the learning preprocessing unit 230 can be configured to select a plurality of learning data candidates whose variance is less than the selection threshold among the plurality of learning data candidates acquired by the learning sensor data acquiring unit 210 and acquire the plurality of selected learning data candidates as a plurality of pieces of learning data.

Therefore, the learning device 200 can comprehensively extract the relevance between the pieces of sensor data D1, and as a result, it is possible to provide the related structure D2 in which overlooking of the connection relationship of the sensor 300 is suppressed. The learning device 200 can cause the anomaly factor estimating device 100 to more appropriately track the sensor 300 that is the generation source of the anomaly and improve the estimation accuracy of the factor of the anomaly by providing the estimated structure (related structure) when tracking the sensor 300 that is the generation source of the anomaly to the anomaly factor estimating device 100.

Furthermore, in the learning device 200, the related structure learning unit 240 can be configured to calculate the statistic using the waveform-based statistical index.

Therefore, the learning device 200 can track the anomaly propagation based on the dependence relationship of being similar in waveform, and can provide the estimated structure (related structure D2) that can more appropriately estimate the factor of the anomaly.

Furthermore, the learning device 200 can be configured to calculate the statistic using the distribution-based statistical index.

Therefore, the learning device 200 can track the anomaly propagation based on the dependence relationship of being similar in distribution, and can provide the estimated structure (related structure D2) that can more appropriately estimate the anomaly factor.

Furthermore, the learning device 200 can be configured to calculate the statistic using the waveform based statistical index and the distribution based statistical index.

Therefore, the learning device 200 can track the anomaly propagation based on the dependence relationship of being similar in waveform or distribution, and can provide the estimated structure (related structure D2) that can more appropriately estimate the anomaly factor.

In addition, the learning device 200 includes the learning sensor pair generating unit 370 to generate a pair of the sensors 300 from among a plurality of the sensors 300 on the basis of a connection relationship among a plurality of devices constituting the target facility and the facility design information D46 in which a plurality of the sensors 300 provided in a plurality of the devices is defined, and the related structure learning unit 240 can be configured to acquire the learning data on the basis of the pair of the sensors 300 generated by the learning sensor pair generating unit 370 and learn the estimated structure (related structure D2).

Therefore, the learning device 200 can suppress the possibility of detecting the dependence relationship between the sensors 300 having low relevance in design, and can learn the related structure D2 with improved reliability. As a result, the learning device 200 can provide the related structure D2 capable of precisely estimating the anomaly factor to the anomaly factor estimating device 100.

Note that, in the present disclosure, any component of the embodiment can be modified, or any component of the embodiment can be omitted.

### INDUSTRIAL APPLICABILITY

In an anomaly factor estimating device according to the present disclosure, an anomaly factor estimating device can estimate a factor of an anomaly that has occurred in a facility regardless of complexity of the facility or a scale of the facility.

### REFERENCE SIGNS LIST

1000: precise diagnostic system, 100: anomaly factor estimating device, 10, 310: sensor data acquiring unit, 20, 320: data storage unit, 30: anomaly detecting unit, 40: anomaly detection order estimating unit, 50: anomaly propagation path tracking unit, 60: anomaly factor estimating unit, 70: anomaly factor estimation result output unit, 330: related structure correcting unit, 340: relationship change estimating unit, 350: anomaly factor device estimating unit, 360: related structure graph output unit, 200: learning device, 210: learning sensor data acquiring unit, 220: learning data storage unit, 230: learning preprocessing unit, 240: related structure learning unit, 370: learning sensor pair generating unit, 300: sensor, 400: display device, 1601: processing circuit, 1602: input interface device, 1603: output interface device, 1604: processor, 1605: memory

1. An anomaly factor estimating device comprising:
a processor; and
a memory storing a program, upon executed by the processor, to perform a process:
to acquire a plurality of pieces of time-series sensor data collected by a plurality of sensors provided in a plurality of facility components constituting a target facility;
to detect a plurality of anomaly detection sensors in which an anomaly has occurred among the plurality of the sensors on a basis of a plurality of the pieces of sensor data acquired;
to estimate an anomaly detection order in which occurrence of the anomaly is detected for the plurality of the anomaly detection sensors on a basis of a detection time at which the process has detected the plurality of the anomaly detection sensors;
to estimate an anomaly propagation order in which the anomaly has propagated on a basis of anomaly detection sensor information regarding the plurality of the anomaly detection sensors detected and an estimated structure indicating a dependence relationship between the facility components; and
to estimate a factor of the anomaly on a basis of the anomaly detection order estimated and the anomaly propagation order estimated.

2. The anomaly factor estimating device according to claim 1, wherein
the estimated structure is represented by a matrix.

3. The anomaly factor estimating device according to claim 1, the process comprising:
to output information regarding an estimation result of the factor of the anomaly.

4. The anomaly factor estimating device according to claim 1, wherein
the process detects the anomaly detection sensors using a univariate type anomaly detecting method.

5. The anomaly factor estimating device according to claim 1, wherein
the process detects the anomaly detection sensor using a multivariate type anomaly detecting method.

6. The anomaly factor estimating device according to claim 1, wherein
the process detects the anomaly detection sensor using a univariate type anomaly detecting method and a multivariate type anomaly detecting method.

7. The anomaly factor estimating device according to claim 1, wherein
the process estimates the anomaly propagation order on a basis of the anomaly detection sensor information, facility operation state information indicating an operation state of the target facility, and the estimated structure indicating a dependence relationship between the facility components depending on the operation state of the target facility.

8. The anomaly factor estimating device according to claim 1, the process comprising:
to correct a dependence relationship among the pieces of sensor data for the estimated structure on a basis of dependent pair information related to a pair of the sensors having a dependence relationship among the plurality of the sensors and non-dependent pair information related to a pair of the sensors having no dependence relationship.

9. The anomaly factor estimating device according to claim 1, the process comprising:
to compare the estimated structure with the estimated structure at a time of occurrence of the anomaly on a basis of the estimated structure, the estimated structure at a time of occurrence of the anomaly, and the anomaly detection sensor information and estimate a change in a relationship among the pieces of sensor data, wherein
the process estimates a factor of the anomaly in consideration of a change in a relationship among the pieces of sensor data estimated on a basis of the anomaly detection order estimated and the anomaly propagation order estimated.

10. The anomaly factor estimating device according to claim 1, the process comprising:
to estimate, on a basis of device-attached sensor information in which a device provided in the target facility and the sensor provided in the device are associated with each other, the anomaly detection order estimated, and the anomaly propagation order estimated, a factor of the anomaly in units of the device.

11. The anomaly factor estimating device according to claim 1, the process comprising:
to output related structure graph display information for displaying a graph in which the estimated structure, the anomaly detection sensor, and an estimation result of a factor of the anomaly are associated with each other on a basis of the estimated structure, the anomaly detection sensor information, and information regarding the estimation result of the factor of the anomaly estimated.

12. A learning device comprising:
a processor; and
a memory storing a program, upon executed by the processor, to perform a process:
to acquire, as learning data candidates, a plurality of pieces of time-series sensor data collected by a plurality of sensors provided in a target facility during a time of normal operation of the target facility; and
to calculate, using a plurality of pieces of the learning data candidates acquired as a plurality of pieces of learning data, at least one of statistics of the plurality of the pieces of learning data on a basis of the plurality of the pieces of learning data, and learn an estimated structure indicating a dependence relationship between the facility components on a basis of the statistics calculated.

13. The learning device according to claim 12, the process comprising:
to acquire the plurality of the pieces of learning data to be used for learning on a basis of the plurality of the learning data candidates acquired, wherein
the process calculates at least one of the statistics among the plurality of the pieces of learning data on a basis of the learning data acquired, and learns the estimated structure on a basis of the statistics calculated.

14. The learning device according to claim 13, wherein
the process selects the plurality of the learning data candidates whose variance is less than a selection threshold among the plurality of the learning data candidates acquired, and acquires a plurality of the selected learning data candidates as the plurality of the pieces of learning data.

15. The learning device according to claim 12, wherein
the process calculates the statistics using a waveform based statistical index.

16. The learning device according to claim 12, wherein
the process calculates the statistics using a distribution-based statistical index.

17. The learning device according to claim 12, wherein
the process calculates the statistics using a waveform based statistical index and a distribution-based statistical index.

18. The learning device according to claim 12, the process comprising:
to generate a pair of the sensors from among the plurality of the sensors on a basis of a connection relationship among a plurality of devices constituting the target facility and facility design information in which the plurality of the sensors provided in a plurality of the devices is defined, wherein
the process acquires the learning data on a basis of the pair of the sensors generated and learns the estimated structure.

19. A precise diagnostic system comprising:
the anomaly factor estimating device according to claim 1; and
a learning device comprising:
a processor; and
a memory storing a program, upon executed by the processor, to perform a process:
to acquire, as learning data candidates, a plurality of pieces of time-series sensor data collected by a plurality of sensors provided in a target facility during a time of normal operation of the target facility; and
to calculate, using a plurality of pieces of the learning data candidates acquired as a plurality of pieces of learning data, at least one of statistics of the plurality of the pieces of learning data on a basis of the plurality of the pieces of learning data, and learn an estimated structure indicating a dependence relationship between the facility components on a basis of the statistics calculated.

20. An anomaly factor estimating method comprising:
acquiring a plurality of pieces of time-series sensor data collected by a plurality of sensors provided in a plurality of facility components constituting a target facility;
detecting a plurality of anomaly detection sensors in which an anomaly has occurred among the plurality of the sensors on a basis of the plurality of the pieces of sensor data acquired;
estimating an anomaly detection order in which occurrence of the anomaly is detected for the plurality of the anomaly detection sensors on a basis of a detection time at which the method has detected the plurality of the anomaly detection sensors;
estimating an anomaly propagation order in which the anomaly has propagated on a basis of anomaly detection sensor information regarding the plurality of the anomaly detection sensors detected and an estimated structure indicating a dependence relationship between the facility components; and
estimating a factor of the anomaly on a basis of the anomaly detection order estimated and the anomaly propagation order estimated.
